(19) United States
(12) Patent Application Publication
(10) Pub. No.: US 2024/0316391 A1
(43) Pub. Date: Sep. 26, 2024

(54) Electronically Controlled Resistance Device

(71) Applicant: Narek Pezeshkian, Glendale, CA (US)

(72) Inventor: Narek Pezeshkian, Glendale, CA (US)

(21) Appl. No.: 18/611,437

(22) Filed: Mar. 20, 2024

Related U.S. Application Data
(60) Provisional application No. 63/491,105, filed on Mar. 20, 2023.

(51) Int. Cl. A63B 21/00; A63B 24/00; H02K 1/12; H02K 1/2798; H02K 3/26; H02K 16/02

(52) U.S. Cl. CPC A63B 21/153; A63B 21/00069; A63B 24/0087; H02K 1/12; H02K 1/2798; H02K 3/26; H02K 16/02; A63B 2225/20; H02K 2203/03

(57) ABSTRACT

An apparatus for resistance-based exercise allowing the user maximum control over the exercise. The apparatus comprises a motor, ropes, and a user interface that work in combination to provide personalized, safe, and effective exercise. The apparatus can be controlled through an app or its internal controller board and user interface, and the apparatus has various safety features to protect both the user and the apparatus.

### FIELD OF THE INVENTION

The present invention relates generally to an apparatus for exercise. More specifically, the present invention is an apparatus for exercise, it is a platform that provides controlled and adjustable resistance to the user for the purposes of strength training, physical therapy, and the like.

### BACKGROUND OF THE INVENTION

There exist many methods and systems for resistance training and exercise. The present invention seeks to improve upon the prior art by providing an exercise system with easily controllable and adjustable resistance as well as safety features to protect both the user and the invention. The present invention further seeks to provide a low-profile portable device that can be easily carried, mounted, and stored. The present invention allows the user to perform a variety of versatile exercises. The present invention seeks to drive down production and unit costs and provide a user experience that is pleasant and informative.

### BRIEF DESCRIPTION OF THE DRAWINGS

FIG. 1 is a simplified diagram of a slotted radial-flux brushless motor.

FIG. 2 is a simplified diagram of a slotted axial-flux brushless motor.

FIG. 3 is an alternative axial-flux configuration.

FIG. 4 is a right-hand rule indicating the direction of force-production F on a wire carrying current I that is immersed in magnetic field B.

FIG. 5 is a simplified diagram of the ECORD motor design, using magnets on both sides of the PCB stator.

FIG. 6 is an illustration of two adjacent traces of a winding.

FIG. 7 is a magnet specification used in the ECORD motor.

FIG. 8 is a partial illustration of the PCB stator used for the ECORD motor.

FIG. 9 is an additional segment added under each magnet to increase the value of N.

FIG. 10 is a detail of a winding segment.

FIG. 11 is a meandering pattern of several winding turns emphasizing the need for the use of “extended” segments.

FIG. 12 is an additional turn added (a), with loop-back (b).

FIG. 13 is a winding example having two full revolutions per layer.

FIG. 14 is a partial illustration of a fully routed PCB stator, indicating salient features.

FIG. 15 is a star formation (a) and delta formation (b) of the three motor phases.

FIG. 16 is a single PCB stator showing simplified solder pads (a), and multiple PCB stators showing hidden and exposed pads (b)

FIG. 17 is an equivalent schematic of two series-connected PCB stators.

FIG. 18 is an equivalent schematic of two parallel-connected PCB stators.

FIG. 19 is a PCB stackup used for the ECORD motor prototype (a) and example stacking of two PCBs (b).

FIG. 20 is stack of PCB stators between rotor magnets.

FIG. 21 is an equivalent schematic of two groups connected in series, with each group comprising two parallel-connected stators, together forming a combo-connected stack.

FIG. 22 is a PCB stator stack alignment apparatus (a). Two PCB stators shown are added on top of each other (b).

FIG. 23 is an example stackup of a 6-layer series-connected PCB stator.

FIG. 24 is an example stackup of a 6-layer parallel-connected PCB stator.

FIG. 25 is an example stackup of an 8-layer combo-connected PCB stator.

FIG. 26 is a backiron design example with cutouts used in a computer simulation.

FIG. 27 is a backiron design of ECORD (a) that the ring of magnets (b) are adhered to, which forms the rotor (c).

FIG. 28 is a bottom (a), side (b), and top (c) view of the ECORD shaft, and a partial view of the ECORD motor assembly (d).

FIG. 29 is a typical radial motor without (a) and with an encoder (b).

FIG. 30 is a magnetic wheel shown on shaft with the encoder circuit board sitting just below.

FIG. 31 is a low-profile spooler design.

FIG. 32 is a comparison of effective radius due to the amount of paid out rope.

FIG. 33 shows mounting variations of a spooler.

FIG. 34 is a simplified spooler assembly concept.

FIG. 35 is a spooler used in the ECORD prototype following the simplified spooler concept.

FIG. 36 is a spooler mounted to the bottom backiron.

FIG. 37 is an ECORD motor mounting method.

FIG. 38 is a feedback hardware concept.

FIG. 39 is a diagram of forces acting upon the center roller of the feedback mechanism.

FIG. 40 shows various perspective views of the feedback roller.

FIG. 41 shows various perspective views of the parallel roller.

FIG. 42 shows various perspective views of the egress roller.

FIG. 43 shows perspective views of the rope egress mechanism.

FIG. 44 is a center roller detailed assembly.

FIG. 45 is an example of output data of the LDC IC as a function of gₛₑₙₛₒᵣ measured in mm.

FIG. 46 is an external assembly of ECORD.

FIG. 47 shows the outer dimensions of the ECORD.

FIG. 48 shows the internal placement of various components of the ECORD.

FIG. 49 is a cross section of the top bearing headroom without any compressive load (a) and with a compressive load (b).

FIG. 50 is a top-down view of an example of the motor and rope management systems.

FIG. 51 shows alternative orientations of the rope management system.

FIG. 52 is an illustration showing the necessity for both rollers of the inner parallel rollers.

FIG. 53 is an ECORD electronics system diagram.

FIG. 54 shows generated power mitigation methods.

FIG. 55 is a simplified flowchart of the operation code.

FIG. 56 is a remote control mounting and interface concept.

FIG. 57 shows remote control mounting and button-press methods.

FIG. 58 shows examples of arm exercises that can be performed with the ECORD.

FIG. 59 shows examples of chest and back exercises that can be performed with the ECORD.

FIG. 60 shows examples of calf and shoulder exercises that can be performed with the ECORD.

FIG. 61 shows examples of leg exercises that can be performed with the ECORD.

FIG. 62 shows examples of additional mounting methods.

### DETAILED DESCRIPTION OF THE INVENTION

All illustrations of the drawings are for the purpose of describing selected versions of the present invention and are not intended to limit the scope of the present invention.

### 1 INTRODUCTION

The Electronically Controlled Resistance Device (ECORD) is an exercise platform that provides controlled and adjustable resistance to the user for the purposes of strength training, physical therapy, and the like. The platform provides a cabled connection to a brushless motor that spools the rope in and out as the user exercises through a range of motion. The motor-control electronics and tension-sensor work to maintain the resistance that is set by the user. A simple user-interface (UI) on the platform allows the user to adjust the rope tension based on an equivalent weight. A separate wireless remote can be attached to the handle to allow the user to adjust the weight during an exercise. A wireless connection to a smartphone running the associated app presents the user with additional settings, control, rich exercise-related information as well as various resistance profiles. The platform is powered with an onboard AC/DC converter that is plugged into a wall socket.

The primary objectives for the development of the ECORD are as follows:
Produce a very low-profile portable device that can be easily carried, mounted, and stored.
Allow the user to perform as many versatile exercises as possible.
Drive down production and unit cost as much as possible.
Provide a user-experience (UX) that is pleasant and informative.

The following sections provide detailed information about the ECORD.

### 2 MOTOR

The heart of the ECORD is the motor. There are many different types of rotational motors in commercial use today, such as DC brush motors, brushless motors, and induction motors to name just a few, with some branching into sub types. There are advantages and disadvantages for each, therefore the motor type that is the best fit for the intended application is selected for use.

Common to all motors are the stator and rotor. The stator (13) is fixed relative to the device the motor is embedded in and the rotor is the part that rotates. Because the ECORD makes use of a brushless motor, the remainder of the motor discussion will focus on this type.

### 2.1 Configurations:

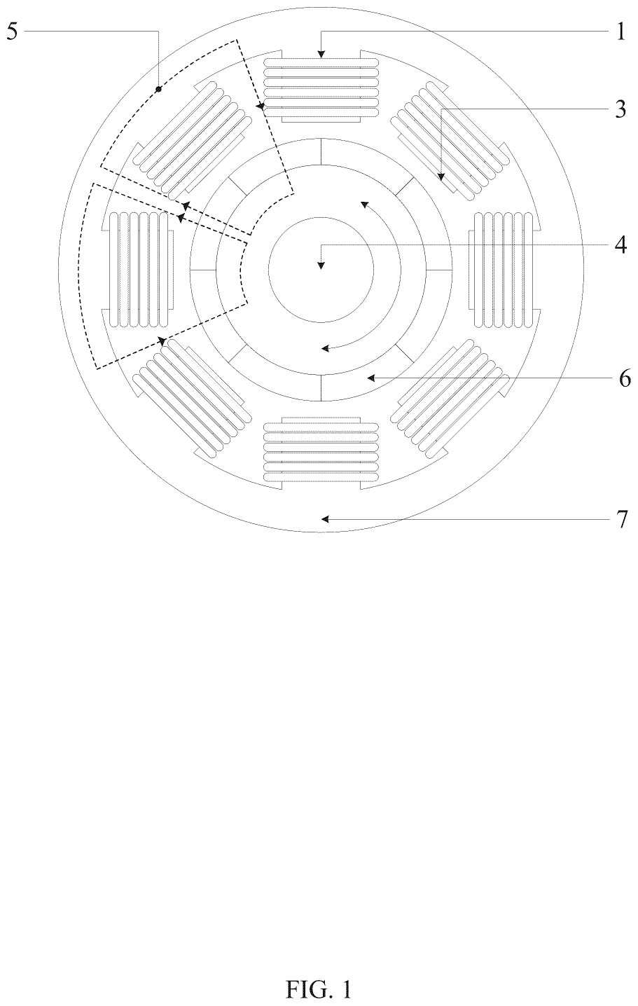

There are two general configurations for brushless motors: Radial-flux type and axial-flux type. By far, the radial-flux is the most common. In this configuration, the magnets are fixed to the rotor such that the magnetic field lines (5) flow in the radial direction. A highly simplified diagram of a radial-flux brushless motor is shown in FIG. 1.

The stator windings (1) are copper coils wrapped around stator teeth (3). These “slotted” motors are by far the most common type in use. The magnets are fixed to the rotor. There are many different approaches to affixing the magnets to the rotor, but generally they are mounted to the surface or embedded inside the rotor. This arrangement causes the magnetic field produced by the magnets to flow in the general direction shown by the dashed lines. Brushless motors require the winding to be electronically commutated in order to produce torque and cause the rotor to rotate in the desired direction. The torque of a radial-flux motor is proportional to the square of the radius. The axial dimension (into the page) of the motor also affects the torque, but linearly.

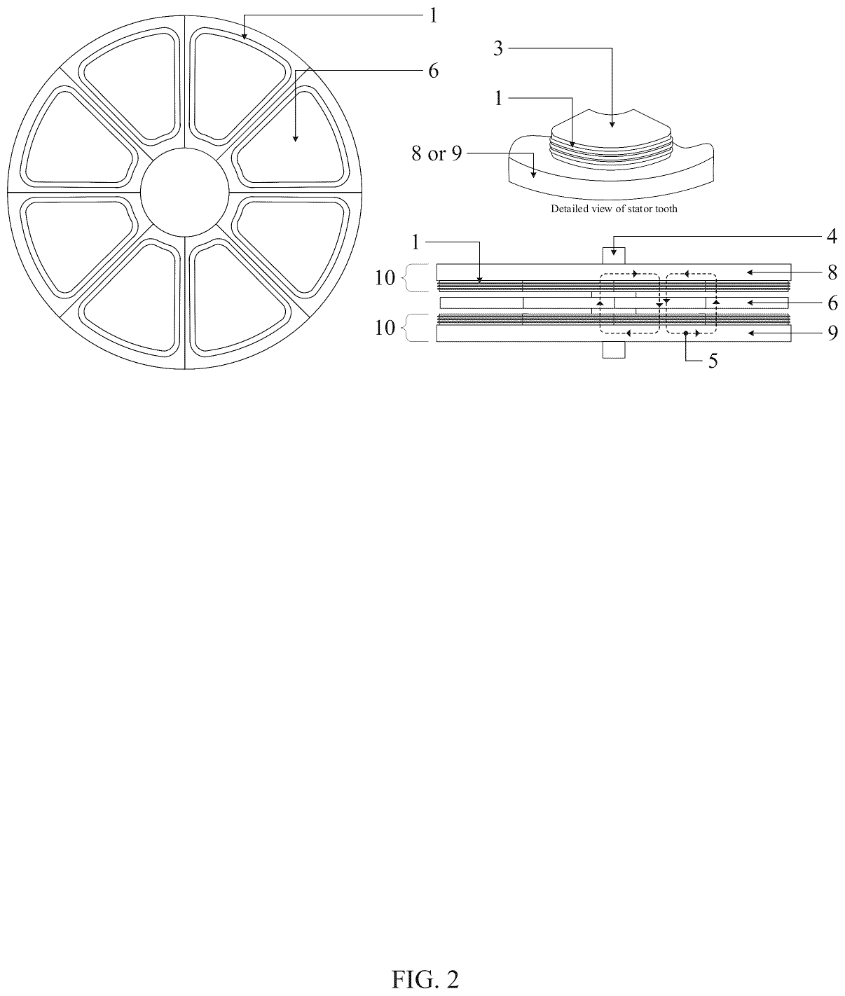

In contrast, axial-flux motors are arranged in such a way that the magnetic field flows in the axial direction. A highly simplified diagram is shown in FIG. 2. As shown, the magnets are placed in a circular fashion on the rotor such that the field flows in the axial direction (into the page). The coils are wound around stator teeth (3), similar to radial-flux motors. One arrangement is also shown (as viewed from the side of the motor) where the magnets (6), which are attached to the shaft (4), are sandwiched between two stationary stators (10). The flow of the magnetic field lines (5) is shown by the dashed line.

Axial flux motors follow the same square law where the torque produced is proportional to the square of the radius. The axial dimension is mostly dictated by the thickness of the magnets, coils, and yoke (8 and 9); therefore, it is much more restrictive than radial-flux motors. However, additional stages of a stator-rotor combination can be added to increase the length (in the axial direction), which will increase the torque linearly.

2. 2 Yoke Vs. Yokeless Design:

The yoke (7) of the motor is an important part of the stator design. As shown by the dashed lines in FIG. 1 and FIG. 2, the magnetic field lines (5) are guided by the yoke (7) in forming the loops. The yoke (7) is usually made of iron to provide very low reluctance (low resistance) to the magnetic fields. Without the yoke (7) the magnetic field lines (5) will take a larger reluctance path and have significant reduction in field strength, which will have a detrimental impact on torque production.

The magnetic field lines (5)—produced by the magnets (see section 2.1)—rotate with the magnets when the motor spins, producing a time-varying magnetic field at any given point in the yoke (7). When a piece of metal is subjected to a time-varying magnetic field, eddy currents are produced that work to counter that field. Also, the non-zero resistance of the metal causes it to heat up due to this current.

If the yoke (7) of the radial-flux motor is constructed with a continuous piece of iron, the motor will experience significant power loss with increasing motor speed. As the motor spins faster, the rate of change of the magnetic field, as experienced by the yoke (7), will increase, which in turn will produce greater eddy currents that counter the magnetic field of the magnets, working to reduce the torque while heating up the yoke (7). This is undesirable. Therefore, the yokes (7) are never constructed with continuous pieces of iron, but rather with laminated stacks of iron that when stacked together form the complete yoke (7). Since these laminated stacks break up the continuity of the metal of the yoke (7), significant reduction in eddy-current production takes place.

The yoke (8 and 9) of the radial-flux motor will similarly experience eddy-current losses if it is made with a continuous piece of iron. Therefore, it also utilizes lamination to introduce interruptions in the metal structure, but instead of stamped stacks it may be constructed with a thin, insulated “ribbon” that is wound around in a spiral fashion to form the yoke (8 and 9).

An alternative approach that can be applied to both types of motors is to produce a yoke made from soft magnetic composite (SMC) material. SMC material uses iron powder particles that are insulated from each other, which significantly reduces eddy-current losses.

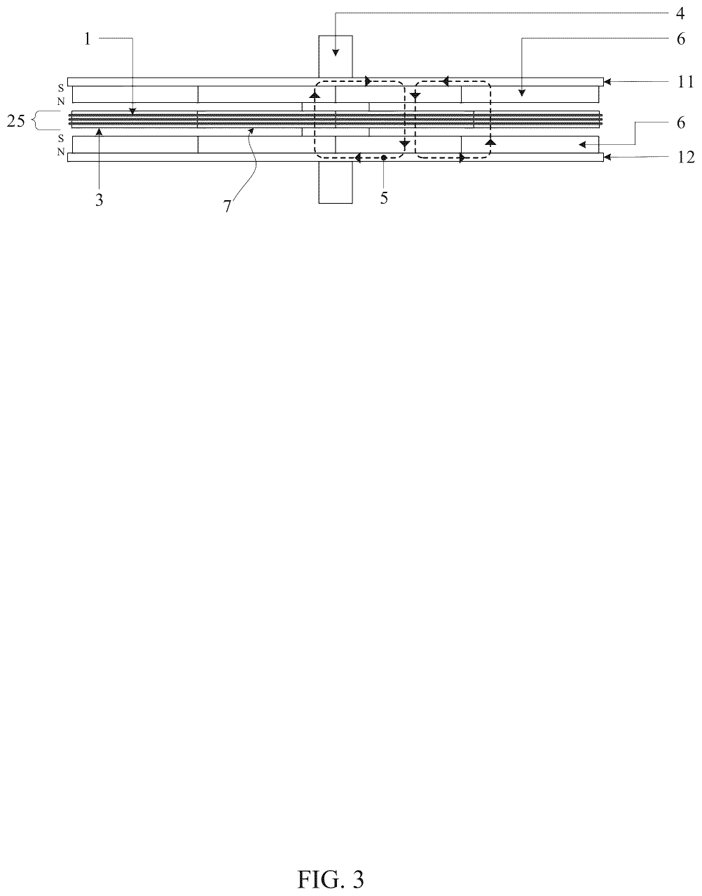

The axial-flux configuration shown in FIG. 2 is not the only possible approach. There are several ways to arrange the stators (13) and magnets. One alternative is shown in FIG. 3.

In this arrangement, the rotor supports two sets of magnets, one above and another below the stator (25), which comprises copper windings (1) coiled around individual teeth (3) comprising the yoke (7). The stator (25) is sandwiched between the two sets of magnets. The magnetic field lines (5) still flow in the same fashion as before, but the number of magnets has doubled. Notice that the magnets need to be arranged such that the north pole (“N”) of the top magnet (6) faces the south pole (“S”) of the bottom magnet (6) to allow the magnetic field to flow in the loop shown by the dashed lines.

With this arrangement, the top and bottom magnets are adhered to their respective backirons (11 and 12) and the backirons (11 and 12) mechanically coupled so that they rotate together, while the stator (25) is fixed in place (much like the previously mentioned motor structures). As a result, the magnetic field lines (5) rotate with the magnets as the motor spins, therefore the metallic yoke (7) of the stators (25) must be manufactured in a way that breaks up the metal continuity, using the ribbon method or SMC.

The configuration shown in FIG. 3, however, lends itself nicely to a yokeless design where eddy currents in the yoke (7) are completely eliminated. In this case, the winding (1) are fabricated such that they are supported by a non-metallic material. For the ECORD design, the stator winding (27) are produced on a printed circuit board (PCB), where the PCB is fabricated from standard laminate materials.

2. 3 Slotted Vs. Slotless Stator:

As mentioned previously, slotted stators allow the winding (1) to coil around the stator teeth (3). This is a widely common form of winding the coils. The advantage is that the stator teeth (3) can be very close to the magnets, which helps to increase the output torque. The disadvantage is that they produce a varying magnetic field reluctance as experienced by the magnets, that is, the rotor has preferential positions as it is spun around. This “cogging” torque is easily felt by the pulsations produced when manually rotating the shaft (4) of an unpowered motor. During normal operation, this cogging torque exists, which may be undesirable for certain applications.

To eliminate the cogging torque produced by the stator slots, some motors are designed without stator teeth (3). These slotless motors experience no cogging torque and produce a smoother motion, which is required by some applications, such as those requiring precision positioning. Slotless motors, on the other hand, generally have less torque output than their slotted counterparts and are significantly more expensive.

### 2.4 ECORD Motor Design:

One of the primary objectives of the ECORD is to provide a pleasant user experience (UX). Part of the UX includes what the user physically feels when pulling on the rope. In the presence of cogging torque, the user will experience vibrations as the rope is pulled. This is not desirable, therefore cogging torque must be eliminated, which points to the use of a slotless motor.

Another primary objective is to produce a very low-profile device. As discussed previously, axial-flux motors are much lower in profile than radial-flux types, although larger in diameter. For the ECORD, the height of the motor is a far more critical dimension to minimize rather than its diameter, therefore the ECORD makes use of an axial-flux type motor.

In order to produce a low-cost motor, the configuration shown in FIG. 3 is selected. Although this arrangement requires twice as many magnets as that shown in FIG. 2, the cost of the additional magnets is far less than the cost of the yoke (8 and 9).

This is because the yoke (8 and 9) required for the configuration of FIG. 2 must be developed with the insulated ribbon method or with the use of SMC materials, both of which are expensive. Therefore, the ECORD motor uses the yokeless design approach.

### 2.4.1 Stator Design:

To maintain a low production cost for the motor, the stator (13) of the ECORD motor is designed using PCB technology. Given the proliferation of electronics in today's modern life, there are countless PCB fabrication and assembly facilities throughout the US and around the world. PCB manufacturing and assembly is a highly mature industry capable of producing exceedingly reliable PCBs.

Unlike the coil examples shown in FIG. 1 and FIG. 2, which make use of concentrated winding (1) using wires, the coils are fabricated using copper etching, distributed across the PCB in a meandering manner, which will be discussed in detail later. But first, the principle of torque production will be discussed.

### 2.4.1.1 Torque Production:

In a motor that makes use of magnets (unlike induction motors that have none), torque is produced with the interaction of current flowing in the stator winding and the magnets. The direction of current flow and the magnetic field determine the direction of torque production.

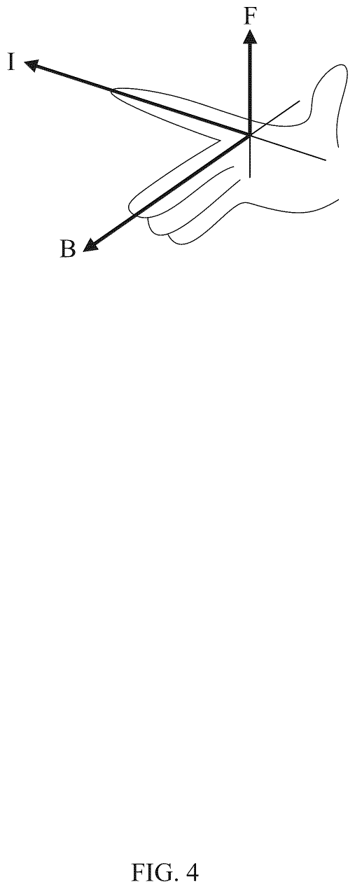

To help visualize the direction of torque, consider the diagram of the “right-hand-rule,” shown in FIG. 4. A wire carrying current I, immersed in magnetic field B, will result in a force F acting upon the wire. To help remember the directions, the index finger of the right-hand points towards the direction of current flow, with the remaining fingers curled towards the direction of the magnetic field, and the thumb pointing in the direction of the force produced on the wire.

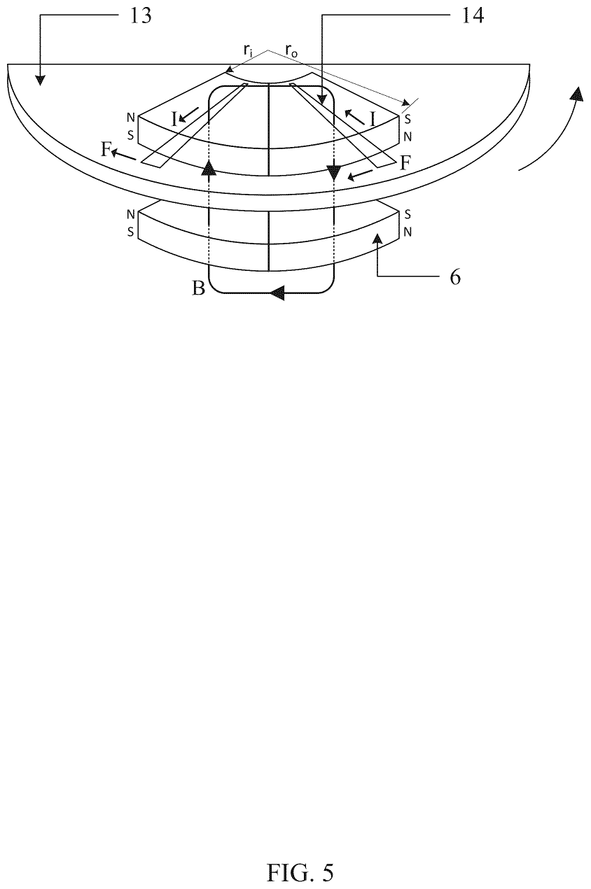

With the general principle of force-production in mind, consider the illustration shown in FIG. 5. For simplicity only two magnets are shown for both the top and bottom sets. Part of the PCB is shown with only two traces (14) to simplify the discussion. PCB traces (14) are made from copper etchings. Notice the polarity of the magnets; they are arranged so that the north pole of the top-right magnet (6) faces the south pole of the bottom-right magnet. The left-side magnets are arranged in opposing polarity. This alternating pattern continues all the way around, necessitating an even number of magnets to be used for each backiron (11 and 12). With the magnet arrangement shown, the magnetic field will flow as indicated by the black loop. Starting from the bottom-left magnet, the field travels away from the north pole, through the PCB stator (13), and into the south pole of the top-left magnet. Since the magnets are adhered to the top backiron (11) (not shown), the field remains within the top backiron (11) as it flows towards the top-right magnet's south pole. It continues its flow through the PCB stator (13) and down into the south pole of the bottom-right magnet. The field then encounters the bottom backiron (12) (not shown) and stays within the bottom backiron (12) as it enters the south pole of the bottom-left magnet. This completes the magnetic field loop. The two strips represent copper traces (14) with current I flowing in each one, although in opposing directions. Using the right-hand rule, the direction of force F produced on each trace is shown. Notice the force acting on both traces (14) is in the tangential direction with respect to the circular PCB stator. This is because when the field flows in the opposite direction, so does the current, which results in a force produced by both traces (14) that are in the same tangential direction. This suggests that the forces from all individual traces (14) are in the same tangential direction, the sum of which is the total force produced by the stator (13).

Since the stator (13) is fixed in position and the magnets are allowed to spin, the overall force produced by the stator (13) acts to spin the magnets. Since the magnets are adhered to their respective backiron (11 and 12), and the backirons (11 and 12) are coupled to the shaft (4), the torque applied to the shaft (4) is in the opposite direction as that of the force (as indicated by the black arrow).

The torque τ produced by a group of traces (14) can be approximated as:

$$τ = \frac{1}{2} INB ( {r}_{o}^{2} - {r}_{i}^{2} ) \qquad Eq . 1$$

Here, rᵢ and rₒ represent the inner and outer radii of the magnets, respectively, as shown in FIG. 5. The quantities I, N, and B are the current through a trace, the number of total traces (14), and the strength of the magnetic field produced by the magnets, respectively. The above equation indicates that the torque is linearly proportional to the current, number of traces (14) and the magnetic field strength, while proportional to the square of the radii, as indicated in previous sections. It should also be noted that any trace the extends beyond the boundaries of the magnets will not contribute to the torque production since little to no magnetic field exists away from the magnets.

### 2.4.1.2 Design Optimization:

As shown by Eq. 1, there are a plurality of levers that can be adjusted in order to maximize torque, however, there is a tradeoff for each.

Starting with the current, the greater it is, the greater will be the output torque. However, current cannot be injected into the motor without limit. The traces (14) forming the winding have a non-zero resistance that generate heat in the presence of current. This is a form of power loss, with its instantaneous value quantified as:

$${P}_{L} = {I}^{2} R \qquad Eq . 1$$

As can be seen, the power loss is a function of the square of the current I, but linearly proportional to the total winding resistance R. So, if the current is doubled, the torque is doubled, but the power loss is quadrupled. If this heat is not dissipated properly it can lead to critical damage of the traces (14) on the PCB. Therefore, the goal is to keep the resistance low and also to dissipate the heat so that the motor can operate safely. There are a number of ways to achieve this:
Use of fans to actively dissipate heat.
Use of high thermally conductive PCB laminates carries heat away more efficiently.
Minimize resistance of traces (14) by making them wider and/or taller (thicker).

There are of course, tradeoffs to all the above:
Fans add cost and require volume within the device, which will limit their use since the device is to have a very low profile.
Higher thermally conductive laminates are more expensive than standard laminates like FR4, increasing the development cost. For example, in the ECORD prototype the PCB stator (13) is made from Shengyi S 1150G with 0.77 W/mK of thermal conductivity, as compared to the standard FR4 material's thermal conductivity of 0.2 W/mK. The S 1150G is relatively cost effective, but not as thermally conductive as, say, the Rogers 92ML material with a thermal conductivity of 1.7 W/mK. Of course, the 92ML is much more expensive. There are other laminates that have similar thermal conductivity to the 92ML, but they are also expensive.
Wider traces (14) will take up more space on the PCB, thereby decreasing the value N (see Eq. 1), thereby decreasing torque.
Wider traces (14) will also produce greater eddy currents, thereby leading to additional torque and power loss.
Thicker traces (14) are more expensive than standard traces (14). Also, thicker traces (14) require more spacing between adjacent traces (14) due to fabrication limits, again working to reduce N.

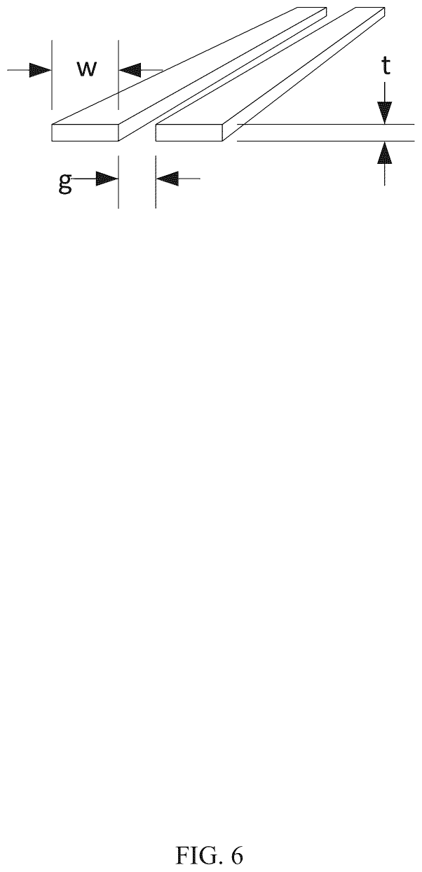

The next factor that can be adjusted in Eq. 1 is N. The greater the number of traces (14) the greater the torque. However, as discussed above, there are manufacturing limitations. Consider the parallel traces (14) illustrated in FIG. 6. The width and thickness of each trace is w and t, respectively, while the gap between the traces (14) is indicated as g.

In order to increase N, either or both w and g must be minimized. From a manufacturing standpoint, there is a limit to how small w and g can become. From a thermal-design point of view, the smaller w gets the greater the temperature-rise due to the current flow. Temperature rises exponentially as w is decreased. As for the gap, g, there is no reason to increase this value beyond the minimum that is manufacturable. The gap, however, is a function of the trace thickness. The greater the thickness the greater must be the gap, again due to manufacturing limits.

The next lever that can be adjusted in Eq. 1 is the magnetic field strength, which is entirely dependent upon the magnet (6) used. Neodymium Iron-Boron (NdFeB) magnets are the strongest rear-Earth magnets available, and they come in several grades. The higher the grade value the stronger the magnet. The magnetic field strength also increases with increasing magnet thickness. The tradeoffs are as follows:
NdFeB magnets are the most expensive compared to other, weaker-composition magnets.
The cost increases with higher-grade NdFeB magnets.
The cost increases with thickness.
The weight increases with thickness.

The last parameters that can be adjusted in Eq. 1 are the inner and outer radii of the magnets. In order to increase the torque, the difference between the squares of these values must be increased. At first glance, it appears that reducing the inner radius and increasing the outer radius are good ways to go, but of course, there are tradeoffs. They are as follows:
Increasing the outer radius is indeed a good way to increase the torque, however, this requires a larger magnet, which increases cost. It also adds to the weight, and most importantly to the rotational inertia. A higher rotational inertia will cause the motor to accelerate slower, which may be undesirable depending on the application.
Decreasing the inner radius is not necessarily a good way to increase torque. This is because the winding traces (14) running under the magnet (6) are laid down radially requiring them to bunch up and decrease their width as they get closer to the inner radius. As discussed above, the narrower the trace the greater the power loss and hence, heat production, which if left unchecked can cause catastrophic failure.

There is a delicate dance in optimizing the various parameters of Eq. 1 given their tradeoffs, and it is up to the designer to determine which parameters are more important to prioritize over others based on the requirements of the application.

### 2.4.1.3 Printed Stator Design:

The ECORD rotors (26) are designed using NdFeB magnets with the following specifications:
Inner radius, rᵢ=2″
Outer radius, rₒ=4″
Thickness, t=0.1875″
Angle, α=22.5°
N52 grade

The purpose for selecting these parameters was market availability at a reasonable price and estimated torque-production that met the design requirements. The size of the magnets then drove most of the design of the stator (13).

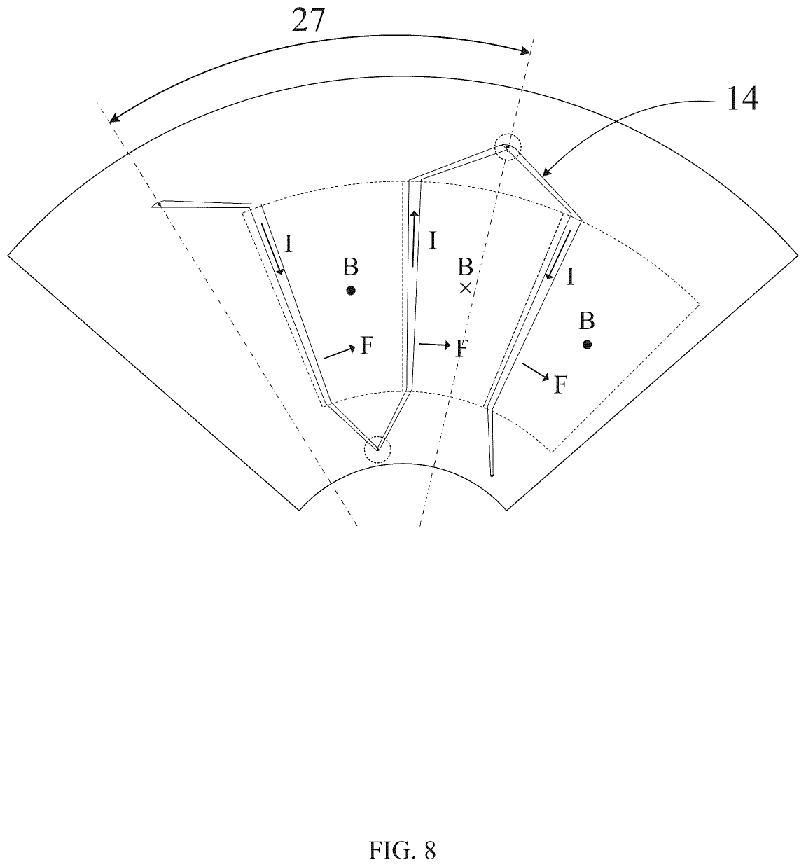

Let N_{MAG} be the number of magnets used on each backiron (11 and 12). Given the design choices discussed in section 2.4 and the size of the magnets, the ECORD motor makes use of two sets of N_{MAG}=16 magnets, one set for the top-backiron (11) and the other for the bottom-backiron (12). The illustration of FIG. 8 shows the interaction of the winding traces (14) and the magnets.

The stator (13) is designed on a circular 2-sided PCB (part of which is shown). There is also a circular cutout (partially visible in the illustration) at the center of the PCB to allow the shaft (4) of the motor to pass through. A double-sided PCB allows copper traces (14) to be etched on the top and bottom sides of the board. The dashed outlines represent the magnets (only 3 shown for clarity). Keep in mind that there are magnets above and below the PCB stator (13) and that they are lined up with one another (see FIG. 5).

Starting from the trace on the far left, the trace approaches the left magnet (6) at an angle, then travels down radially towards the center of the PCB, but just after passing the inner radius of the left magnet, it makes another slight turn and travels down at an angle. Before reaching the inner circular cutout of the PCB the trace transitions layers with the use of a via (outlined with a circle). A via is a plated hole that allows a trace to transition from one layer to another. The trace now continues on the bottom layer of the PCB. Once on the bottom layer, the segment travels back up towards the middle magnet (6) at an angle (same angle as the top trace), then when it reaches the inner radius of the middle magnet, it travels radially upward until it reaches its outer radius. It then makes another slight turn and travels further out, until it makes another layer transition back onto the top layer. The trace segment on the bottom of the PCB is a mirror image of the trace segment on the top layer. The segment of the trace starting from the left and ending at the second via constitutes one turn of the winding (27) of a phase for the stator (13). This pattern continues all the way around the PCB.

The direction of the flow of current I and magnetic field B is shown, as well as the direction of the force F applied to the traces (14). The · represents a magnetic field that points into the page, whereas the x represents a field that points out of the page. Using the right-hand-rule, it is clear that the force F is in the same direction for all trace segments, therefore the forces add up to produce the desired torque. As the magnets rotate over the stator (13), the control electronics varies the current magnitude and direction to keep the motor spinning in the design direction with the desired torque.

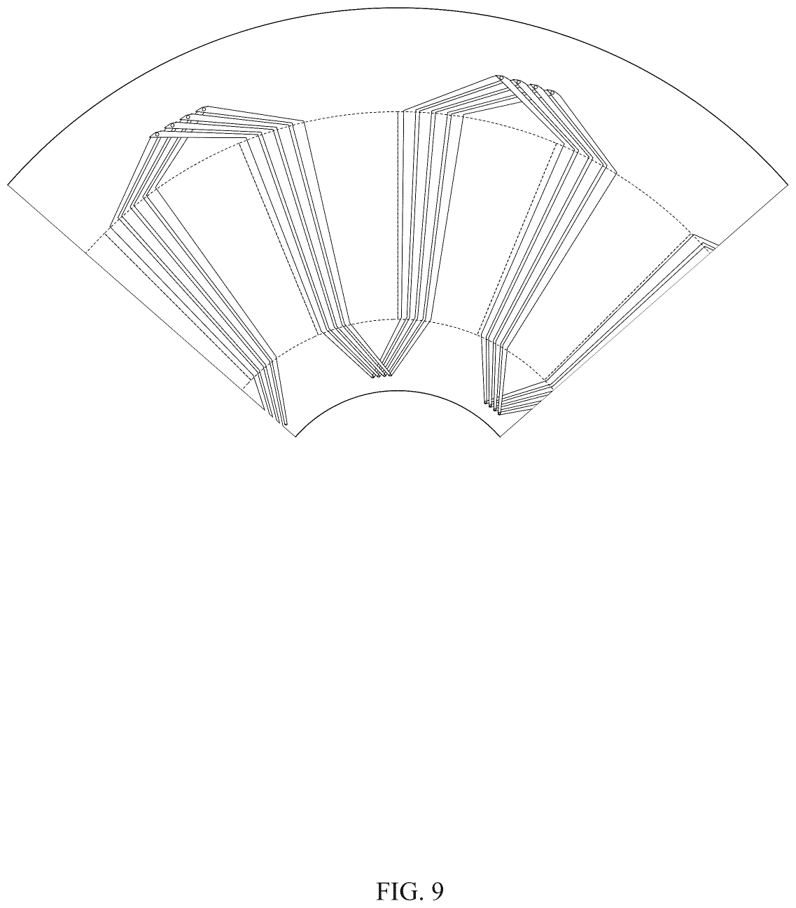

According to the illustration of FIG. 8, there is only a single segment under each magnet, therefore the value of N of Eq. 1 will be equal to the number of magnets, in this case 16. Since the magnets are much wider than the segment width, more segments can fit under the magnets, increasing N, and hence the torque. To allow for more turns, the geometry of an individual segment was designed such that it allows it to meander around the PCB several times, each time adding one more trace under the magnet. An example illustration is shown in FIG. 9. As can be seen, there are now 4 segments under each magnet, increasing N to 64, a four-fold increase in torque.

The number of segments under each magnet, N_{SEG_PER_MAG} is a design parameter. The larger N_{SEG_PER_MAG} is the narrower the segments must be, which according to the discussion of section 2.4.1.2, results in increased power loss. Therefore, a balance must be struck between N_{SEG_PER_MAG} and power loss. There are also practical manufacturing matters to consider since the traces (14) cannot be too narrow given the trace thickness.

Once N_{SEG_PER_MAG} is selected, the trace geometry can be optimized to achieve a maximum width given a minimum trace-to-trace separation, or gap (see section 2.4.1.2). Maximizing width while minimizing the gap is desirable to reduce the resistance of a segment. Lower resistance equals lower power loss.

### 2.4.1.4 Anatomy of a Standard Segment:

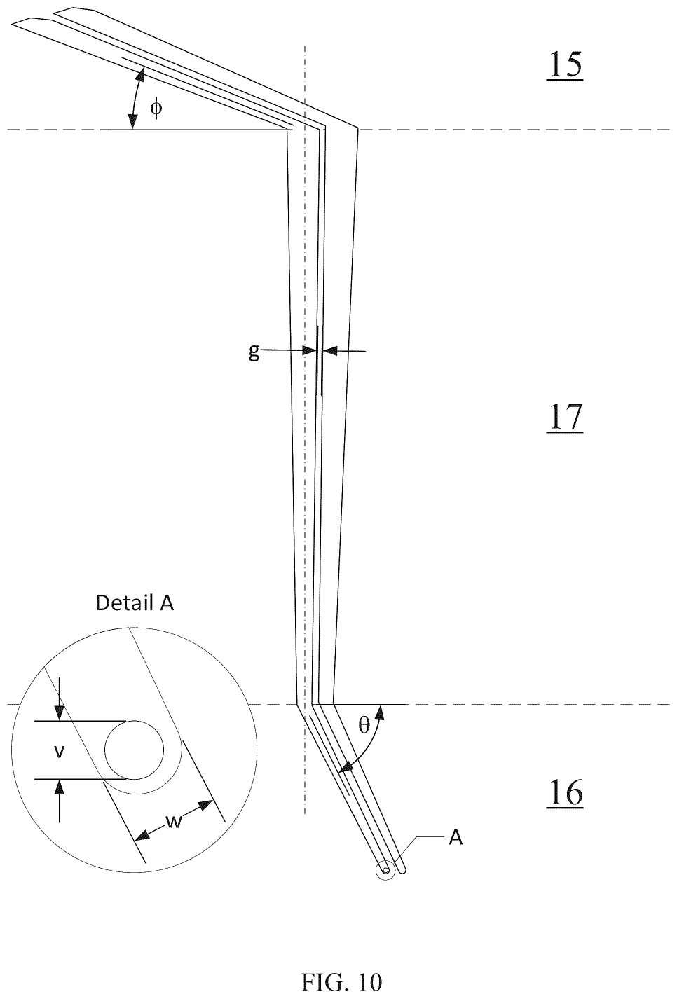

The details of a “standard” segment geometry are shown in FIG. 10, comprising three main regions: the inner end-turns (16), outer end-turns (15) and the active conductor (17). The active conductor (17) of each segment is the portion that is involved in torque production. The end-turns are required to connect the segments on the top layer to those on the bottom layer to produce the chain of segments that meander around the PCB. The end-turns do not contribute to torque production; therefore, they should be minimized where appropriate in order to reduce the overall resistance of the segment.

Two angles, ϕ and θ, are shown with respect to a line that is orthogonal with the segment's centerline (vertical dashed line). Detail A shows the dimensions of the transitioning via, with the hole diameter indicated as v. The width of the trace, w, is indicated, which is the dimension that is to be maximized. The gap, g, between two adjacent segments is also indicated, which is the dimension that is to be minimized. The minimum gap, g, between two adjacent copper features on a PCB is determined by the copper thickness (t in FIG. 6) and the capability of the manufacturing facility. Usually there is not a great deal of difference in this capability between PCB manufacturers, but it is possible to search and find one or a few that can offer the smallest gap for the selected thickness.

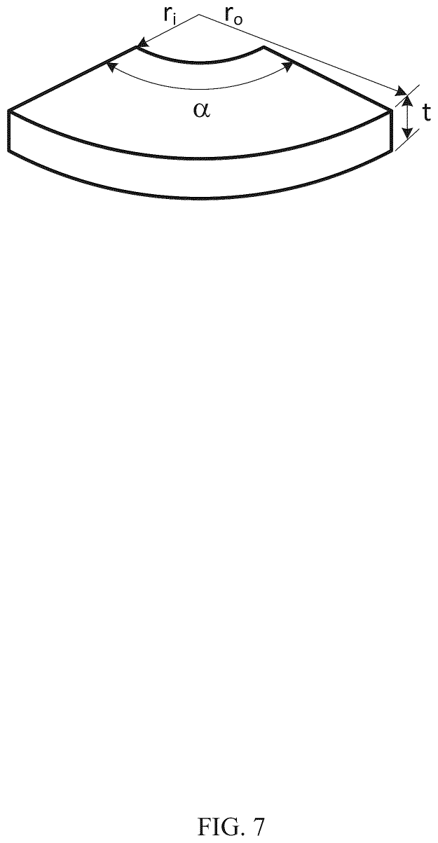

The dimension w is a function of rᵢ, α, g, N_{SEG_PER_MAG} and θ. The parameters rᵢ and α are determined by the selected magnets (see FIG. 7). The value of g is determined by the selected copper thickness t and the manufacturer's capability (see FIG. 6). The value of N_{SEG_PER_MAG} is determined by the tradeoff between torque and power loss. Given these variables, the value of 0 is determined which maximizes w. Note that as θ increases, say from a very shallow angle, so does w, but at some point, w starts to decrease with increasing θ. There is an optimal angle θ where w is at its maximum. As mentioned earlier, end-turns should be minimized where appropriate to reduce the overall resistance of the segment, therefore it may make sense to use an angle smaller than the optimum. However, in this case this may not necessarily be appropriate, since the inner end-turn (16) is much smaller than the outer end-turn (15), using a shallower angle may not substantially reduce the overall resistance of the segment. In fact, the shallower angle produces a smaller w, which works to increase resistance. There may be a different θ that minimizes the overall resistance of the segment, which can be determined with electromagnetic simulation tools. For the initial design of the ECORD motor, however, the selected θ is that which maximizes w.

Notice that w is specified as the width of the segment right at the via. Travelling radially upward allows w to increase, this is because the separation between adjacent traces (14) is maintained at a constant, determined by the parameter g. This widening of the segment helps to reduce its overall resistance.

As for the outer end-turn (15), the angle 4 must be minimized. The angle 4 is a function of N_{SEG_PER_MAG}, w, α, rₒ, and g. The angle 4 is selected as the minimum angle that ensures the gap, g, is at its minimum.

### 2.4.1.5 Extended Segment:

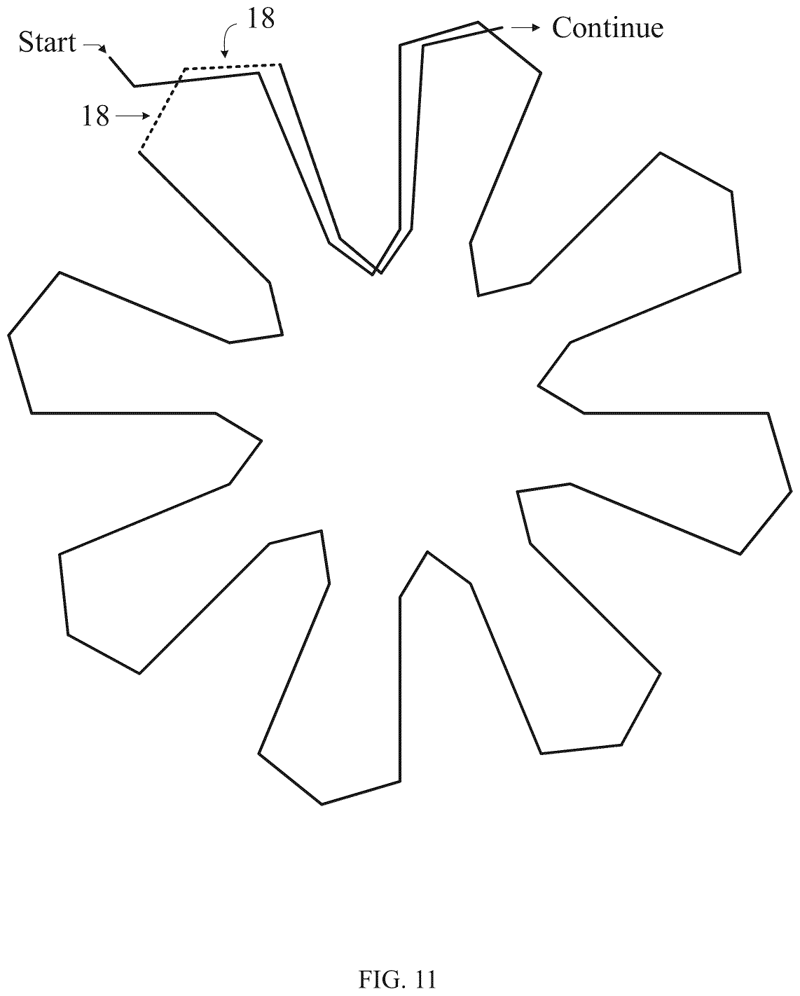

In order to add additional segments under each magnet (6) (to increase N), the stator design requires a variety of segment geometries other than the standard segment. Consider the simplified illustration of FIG. 11.

Beginning at “start,” the pattern travels radially inward then transitions to the bottom layer. There, it travels radially upward, where it transitions again to the top layer. This pattern repeats all the way around until it reaches the starting point. If the pattern only uses standard segments, then the pattern will essentially terminate where it started from, preventing additional turns from being added. Therefore, the last segment of the pattern changes its geometry to the “extended” variant (shown as small-dash lines). Prior to transitioning to the top layer, this extended variant extends its upper end-turn (18) beyond the upper end-turn of the trace of top-layer starting-segment. At this point, the pattern has made one full revolution around the PCB, therefore N=1. This constitutes one full revolution of a winding of a phase, comprising 8 winding (27) turns.

Once at the top layer, the next segment must also be of the extended variant, where it travels inward radially until it transitions to the bottom layer. From this point forward, standard segments are once again used and the pattern repeats. When the pattern makes another full revolution, extended segments are required to allow for additional turns. With each full revolution, the value of N for the overall winding of the phase increases by 1.

### 2.4.1.6 Additional Segment Geometries:

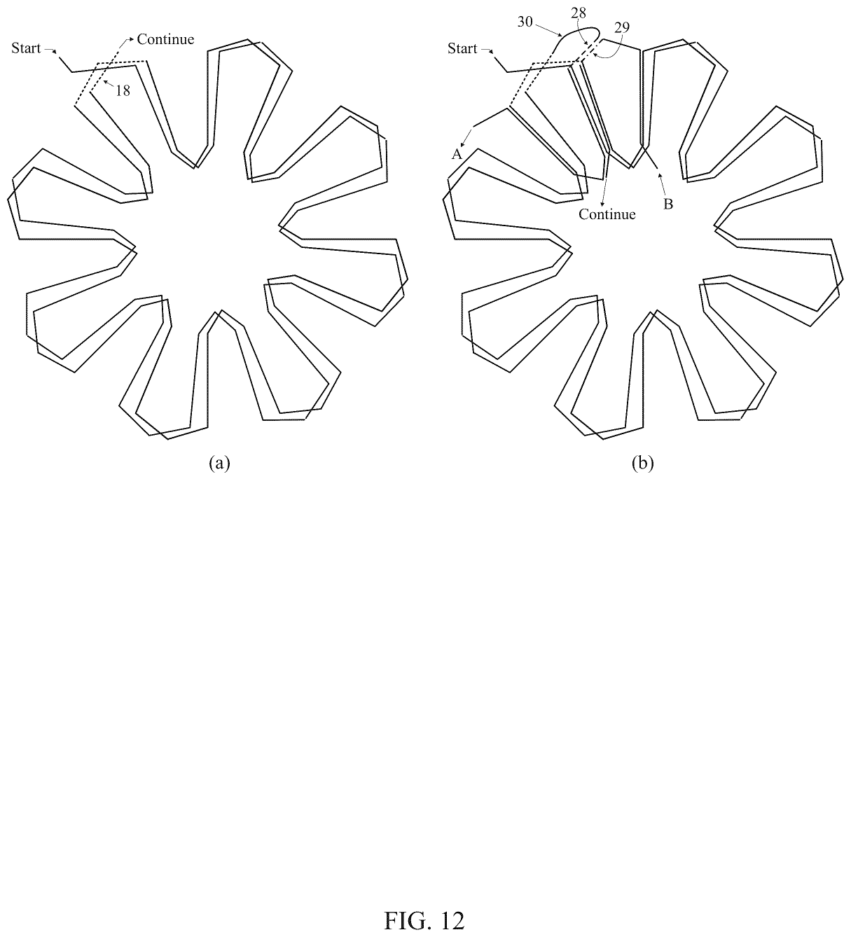

As discussed in the previous section, additional turns can be added to increase N. Consider the illustration shown in FIG. 12.

As can be seen in FIG. 12 (a), one more revolution has been added. As required, there is an additional extended segment (18) as compared to that shown in FIG. 11. Depending on design requirements and parameters, more revolutions can be added to the overall winding, but N cannot increase without limit and the revolutions must stop. Notice, however, that the PCB real-estate has not quite been used to its full capacity. So far, the segments have alternated between the top and bottom layers, but in a staggered, clockwise fashion, leaving the layer directly opposite to each segment unused. This unused space can be utilized to double the value of N by routing the segments in the opposite direction and on the layers opposite of the already laid-down segments.

Consider FIG. 12 (b). Where the extended segment was labeled as “continue” in FIG. 12 (a), there is now a loop-back (30) connection. This loop-back (30) connection may itself transition layers as needed, but for clarity it is not shown. A transition, however, does take place such that the loop-back connects to the “transition” (28) segment (shown as the medium-dash line). This segment travels exactly underneath the very first segment of the winding, marked as “start.” Its shape is similar to all other segments as it travels radially down and eventually makes a layer transition. At this point, a standard segment is used on the top layer directly above the very first extended segment that is on the bottom layer. From the point marked “A,” standard segments are used to travel around the PCB, but they travel in an anti-clockwise fashion and on layers directly opposite the standard segments that were already in place. Eventually, the pattern reaches the point marked “B.” Here another standard segment is used on the top layer, however, when a layer transition occurs at its outer end-turn (15), the segment that follows (on the bottom layer), has a “stop-short” (29) geometry (shown as the dash-dot line). This geometry allows the stop-short (29) segment to be placed directly underneath the top-layer extended segment. When the pattern makes a layer transition at the inner end-turn (16) of the stop-short segment, it continues around the PCB using standard segments.

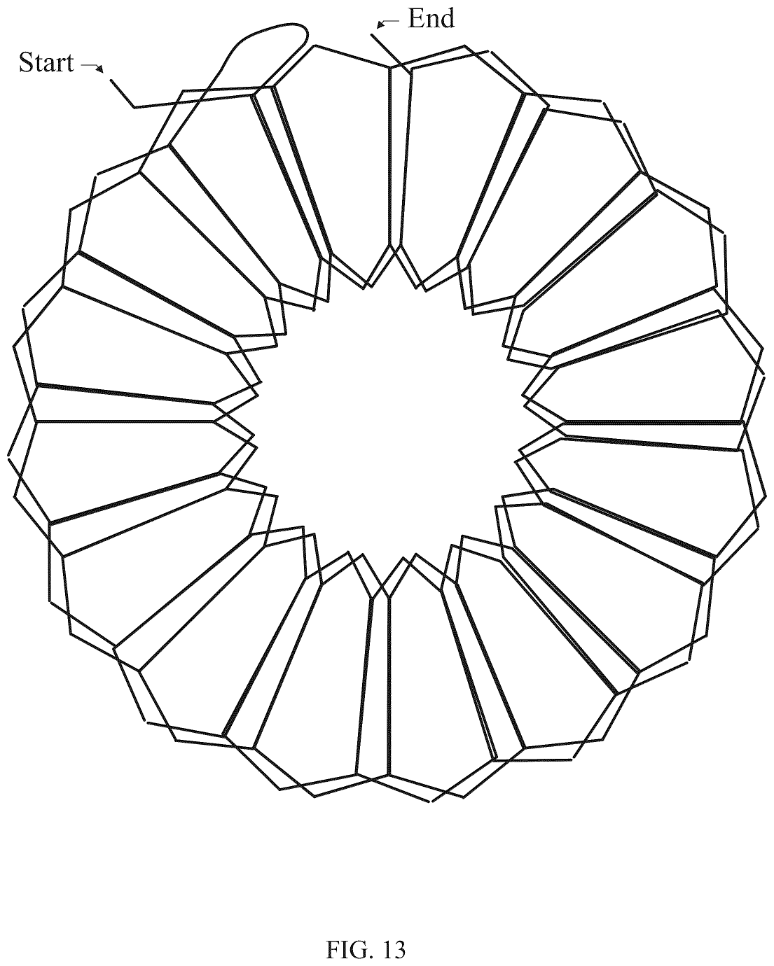

The illustration of FIG. 13 shows four full revolutions of a phase winding with start and end connections. The value of N_{SEG_PER_MAG} is 2 since there are two segments under each magnet (6) per layer. The value of N (see Eq. 1) is 2N_{MAG}N_{SEG_PER_MAG}, which in this example case is equal to 64.

The example phase winding discussed so far and illustrated in FIG. 13, constitutes the winding for one phase of a three-phase motor. The other phases are laid out in a similar fashion, except offset by 120 electrical degrees.

A pole-pair pitch is the mechanical angle that spans the angle covered by a pair of North-South magnets. As an example, the number of pole-pairs (N_{PP}) of the ECORD motor is N_{PP}=N_{MAG}/2=8, where N_{MAG} is the total number of magnets used per rotor. As a result, a pole-pair pitch spans 360/N_{PP}=360/8=45 mechanical degrees. A pole-pair pitch, however, is equivalent to 360 electrical degrees. Therefore, the requirement to separate the phases by 120 electrical degrees translates to separating them by 15 mechanical degrees, which is the offset by which the other phases are laid out.

There are a few additional segment geometries that are used to construct the full three-phase winding on the PCB stator (13). Their shape is very similar to the other shapes discussed so far, except tailored to fit between adjacent segments as necessary in order to allow all three phases to be wound on the board.

This approach produces a very high fill ratio, that is, the ratio of the total copper area to that of the PCB area underneath the magnets. Only the area underneath the magnets is considered since this is the only active area responsible for torque production, therefore it must be used maximally for greater efficiency. For example, the ECORD prototype stator (13) has a fill ratio is 85.74%. This means 14.26% of the total area is taken up by the area between adjacent segments, as defined by the gap, g.

### 2.4.1.7 PCB Stator:

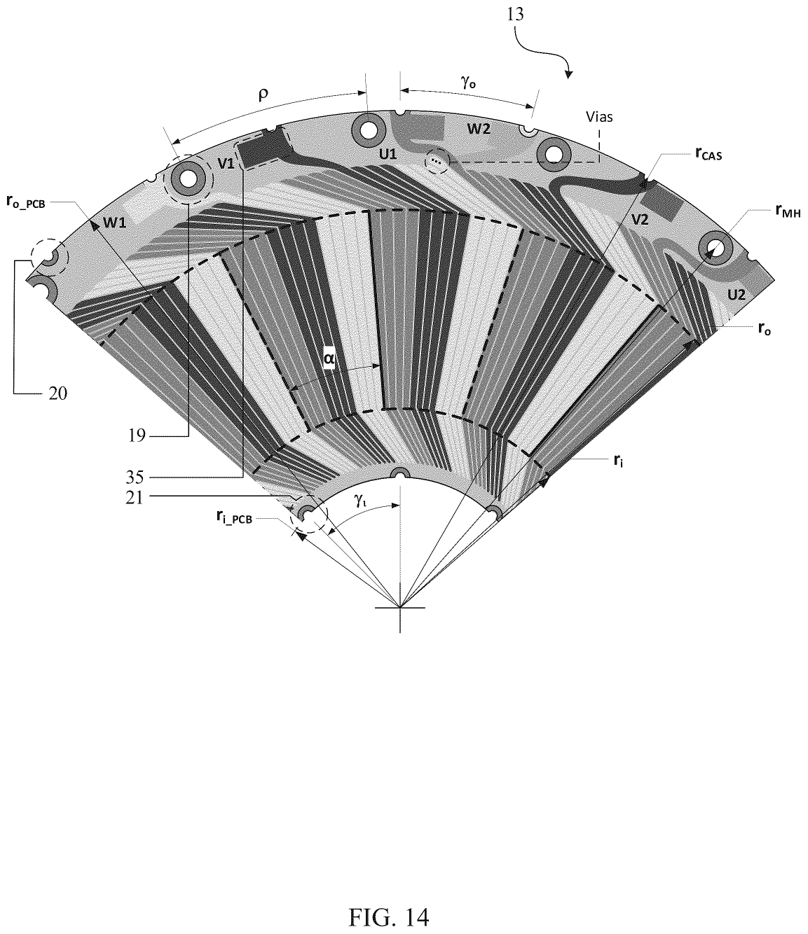

A partial view of the top layer of a fully routed PCB stator (13) is shown in FIG. 14. The black dashed lines represent the outline of the magnets, which are both above and below the PCB stator (13). As in FIG. 7, the inner and outer radii are indicated as rᵢ and rₒ, respectively. The traces (14) of the phases are color-coded for clarity. Phase W is light gray, phase V is dark gray, and phase U is gray. In the example shown below, N_{SEG_PER_MAG}=12 since there are 12 segments under each magnet. Furthermore, all three phases fit equally under each magnet, requiring that N_{SEG_PER_MAG} be divisible by 3, therefore the number of segments per magnet (6) per phase is N_{SEG_PER_PHASE} N_{SEG_PER_MAG}/3=4.

The start and end of a phase (as illustrated in FIG. 13) is indicated as X1 and X2, respectively, where X=W, V or U. The start- and endpoints are connected to castellations (20) around the circuit board. A castellation is a semi-circular plated hole along the edge of a circuit board (see FIG. 14). It is typically used to solder a castellated PCB onto another larger host PCB. For example, many wireless radio modules are available in a castellated PCB form-factor that can be soldered onto a larger host board, providing the host with wireless capabilities. The use of the outer castellations (20) of the PCB stator (13) is twofold: 1) They provide access to the start and end of the phases so that they can be easily soldered to additional PCB stators (13) when they are stacked together, and 2) they provide rigidity when multiple PCB stators (13) are soldered onto each other. The inner castellations (21) of the PCB stator (13) simply add additional rigidity to the soldered stack.

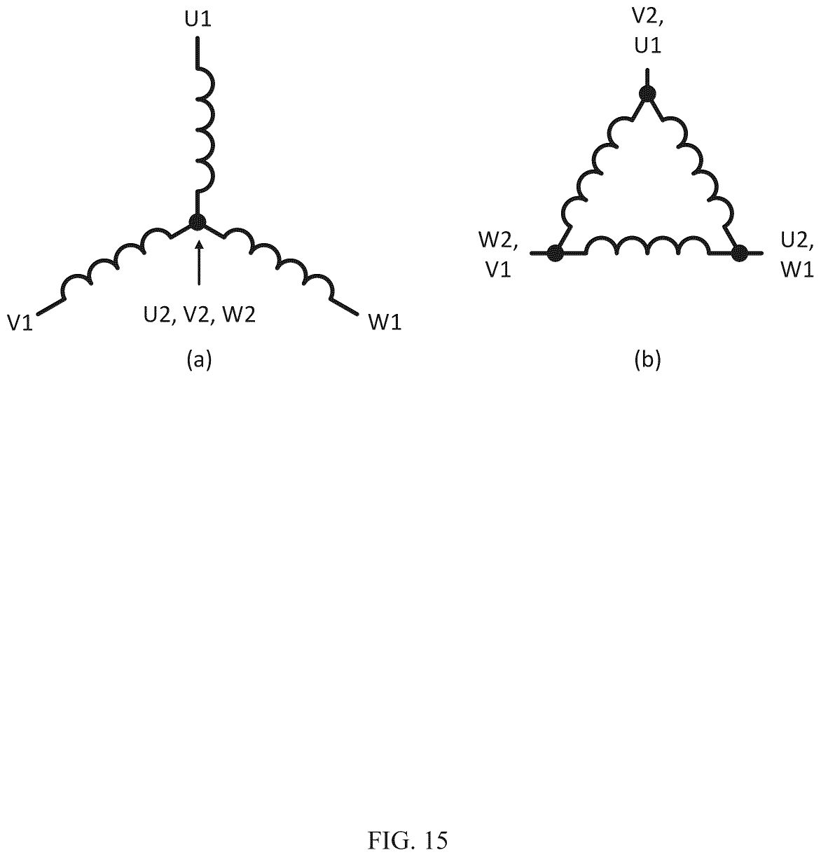

Notice that there are rectangular solder pads (35) emerging from the traces (14) that lead to the start and end castellations. The purpose of these pads is to allow the motor phase wires to be soldered directly to the PCB stator (13). Since both ends of a phase are exposed, the motor phases can be configured in one of two ways; star or delta formation, as shown in FIG. 15.

In the star formation, the end points X2 are soldered together, and the start points X1 are driven by the motor-driver electronics. In the delta configuration, U1-V2 are soldered, W1-U2 are soldered, and V1-W2 are soldered through wires, and then from each of the three points additional wires are soldered and fed into the motor-driver electronics. By far, the star formation is the most popular, and it is the configuration used in the ECORD.

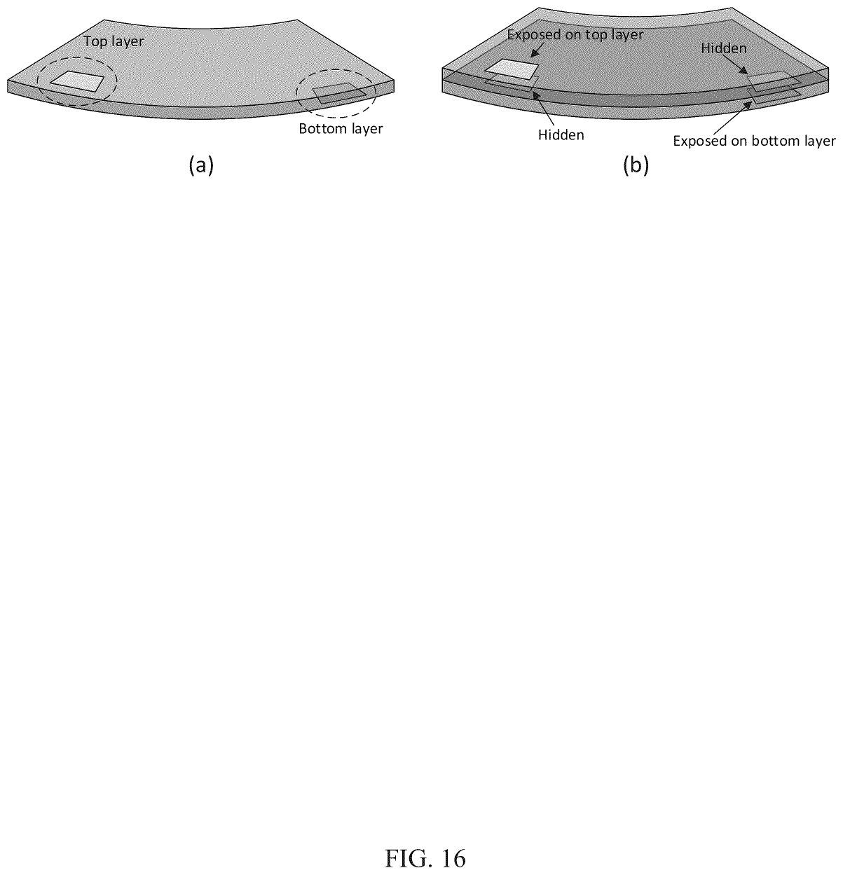

Notice that in FIG. 14 the traces (14) leading to the X2 castellations are shaded slightly different from those leading from the X1 castellation, which highlights the fact that these traces (14) and their accompanying solder pads (35) are on the bottom layer. This allows accessibility to the pads when multiple PCB stators (13) are stacked on top of each other. This is illustrated in FIG. 16.

### 2.4.1.7.1 Series-Connected

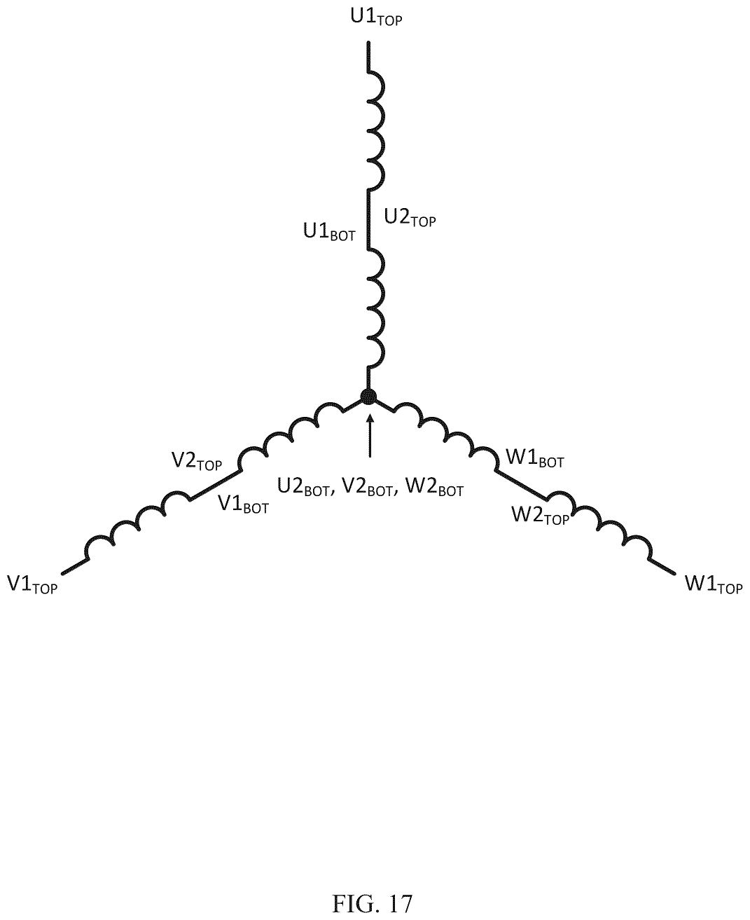

As mentioned previously, one way to increase torque is to increase N. With the 2-layer stator (13) design, it is not possible to add any more segments; the PCB is maximally filled. However, N can still increase by using additional PCB stators (13). As an example, suppose a second PCB stator (13) is added to the bottom side of a first PCB stator (13) (like that shown in FIG. 16 (b)), but rotated such that W2 of the top stator (13) lines up with W1 of the bottom stator (13). Similarly, V2 and U2 of the top stator (13) will line up with V1 and U1 of the bottom stator (13), respectively. This doubles N, with its equivalent schematic shown in FIG. 17.

Adding additional PCB stators (13) to the bottom of the stack and rotating them accordingly will continue to increase N. There is a limit, however, to the number of stators (13) that can be added in this “series-connected” fashion. That number is N_{SERIES_MAX_STATORS}=N_{PP}−1. Anything greater than this value will ultimately result in shorting all phases together.

The key to connecting additional PCB stators (13) in series is the placement of the outer castellations (20), which are driven by the symmetry of the stator winding design that in turn are driven by the inherent symmetry of the magnets. As discussed previously, the magnets are arranged around the backiron (11 and 12) in alternating magnetic-field polarities. From the perspective of the PCB stator (13) the magnetic field repeats itself every λ=360/N_{PP} °M, where °M indicates mechanical degrees around the motor. For the ECORD, N_{PP}=8, therefore λ=45 °M. Since λ spans a pair of magnets and each magnet (6) spans α degrees, then by definition λ=2α. For the ECORD, α=22.5° (see FIG. 7), therefore λ=45 °M, as calculated previously.

Like the magnet pole-pairs, a single turn of the winding (27) for any phase also repeats itself every λ °M. Therefore, the magnitude and phase of the currents within a single turn of a winding (27) also repeat themselves under each pole pair. As a result, there are 360 °E under each pole pair, where ° E is degrees electrical. This is equivalent to λ=45 °M=360 °E, or more generally, λ=2α=360 °E. This implies that rotating one PCB stator (13) by 45 °M with respect to another will result in rotating that same PCB stator (13) by 360 °E. In other words, mechanically and electrically all phase windings between the two PCB stators (13) will be perfectly lined up.

To solder two or more PCB stators (13) together in order to form a series-connected PCB stack, their respective castellations must also line up when the PCBs are rotated by λ=2α with respect to each other. The easiest way to do this is to space them according to the following equation.

$${γ}_{o} = \frac{2 α}{3 n} \qquad Eq . 2$$

The angle γₒ is shown in FIG. 14 and it possesses the units of ° M. The value of 3 in the denominator represents the number of phases. This is most typically 3, but there are motors that use more phases and so the value of 3 would change to match the number of phases in such a motor. The value of n is an integer starting from 1 and may be higher. The higher the value the smaller the angle γₒ, resulting in a larger number of castellations around the outer perimeter, which may be beneficial if greater rigidity is required. However, n cannot increase without limit because the castellations will begin to bunch up together and eventually touch. For the ECORD n=1 and γₒ=15 °M. It is clear from FIG. 14 that if one PCB stator is rotated by 45 °M with respect to another in the clockwise direction, that the castellations marked as W1, V1, and U1 will line up with the castellations marked as W2, V2, and U2 of the other PCB stator (13), respectively, thereby connecting the two PCB stators (13) in series when the castellations are soldered together. It is important to note that it does not matter which way the PCB stators (13) are rotated with respect to each other, so long as that rotation direction remains consistent from one PCB stator (13) to another in the total stack.

The purpose of the inner castellations (21) is strictly for adding rigidity to the PCB stator (13) stack. They must also line up when individual PCB stators (13) are rotated, however, their spacing does not depend on the number of motor phases. For the inner castellations (21), γᵢ=2α/n (see FIG. 14). Again, n is an integer value starting from 1 and determines the number of inner castellations (21). The larger it is the more castellations are added, but once again there is a limit to how many there can be. For the ECORD, the value of n is 1.

The mounting holes (19) of the PCB stator (13) shown in FIG. 14 must similarly line up when two or more PCB stators (13) are rotated to be connected in series. The angle between adjacent mounting holes (19) follows the same formula as that for γᵢ, that is, ρ=2α/n. Once again, n is an integer starting from 1. In the example shown in FIG. 14, n=2 such that there is a mounting hole (19) every α °M. The castellations are offset such that they never touch or overlap with any mounting hole (19). Of course, if the mounting holes (19) are sufficiently far from the edge of the PCB stator (13), the castellations will never touch or overlap with them.

### 2.4.1.7.2 Parallel-Connected

As discussed previously, torque may also be increased by increasing the current I (see Eq. 1). However, this comes with increasing power loss P_{L} (see Eq. 2). To reduce P_{L} the winding resistance R must be reduced. This can be achieved by parallel connecting the PCB stators (13). The total resistance R_{T} for resistors connected in parallel is given by the following:

$$\frac{1}{{R}_{T}} = {\sum }_{i = 1}^{K} \frac{1}{{R}_{i}} \qquad Eq . 3$$

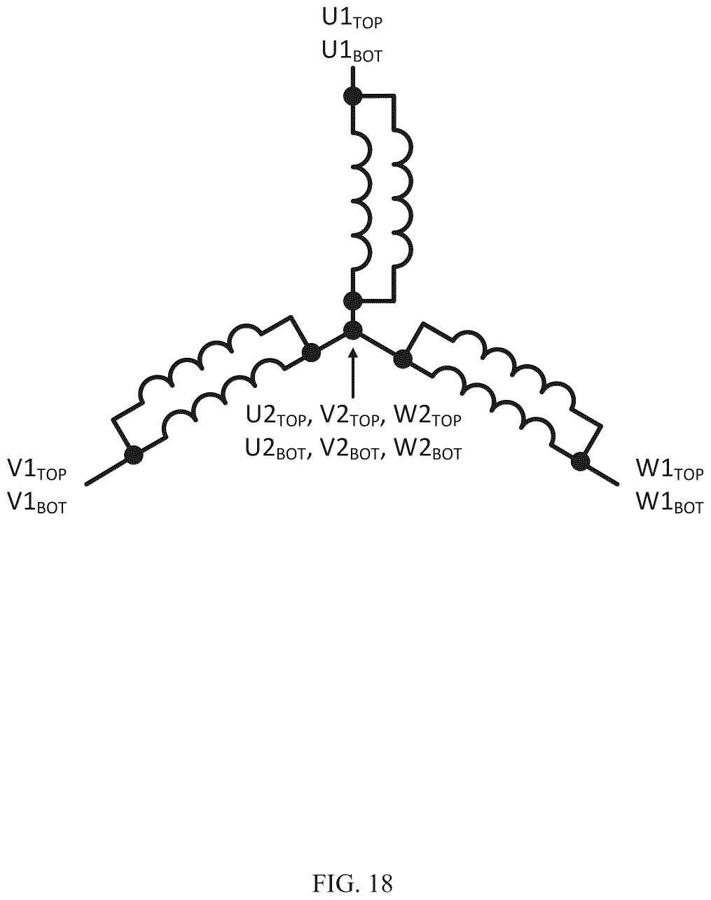

If there are 4 resistors of equal value, that is R₁=R₂= . . . =R₄=R then R_{T}=R/4. The same goes for the phase winding of the PCB stator (13). Parallel connecting them reduces the overall resistance of the phases. In order to connect the PCB stators (13) in parallel, they are simply stacked without any rotation (i.e., all W1's, V1's, etc. are in line) and soldered along the castellations. The equivalent schematic representation for two parallel-connected stators (13) is shown in FIG. 18.

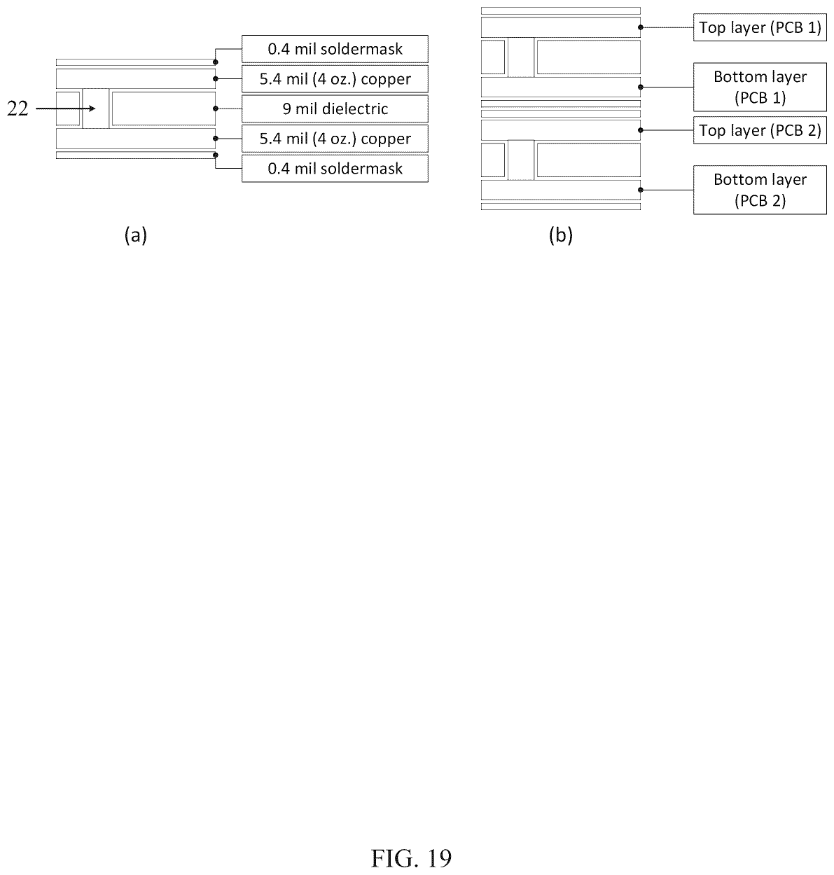

Unlike its series-connected counterpart, there is no limit similar to N_{SERIES_MAX_STATORS} with the parallel-connected scheme. There is, however, a diminishing return in continuing to add stators (13). This is because each PCB stator (13) has a thickness associated to it. For example, in the ECORD prototype, the PCB stator (13) is fabricated using 4 oz. copper with dielectric material between the two layers. The PCB stackup is shown in FIG. 19 (a), including the through-hole via (22) that connects the top and bottom layers (see section 2.4.1.3). An example stacking of two PCBs is shown in FIG. 19 (b).

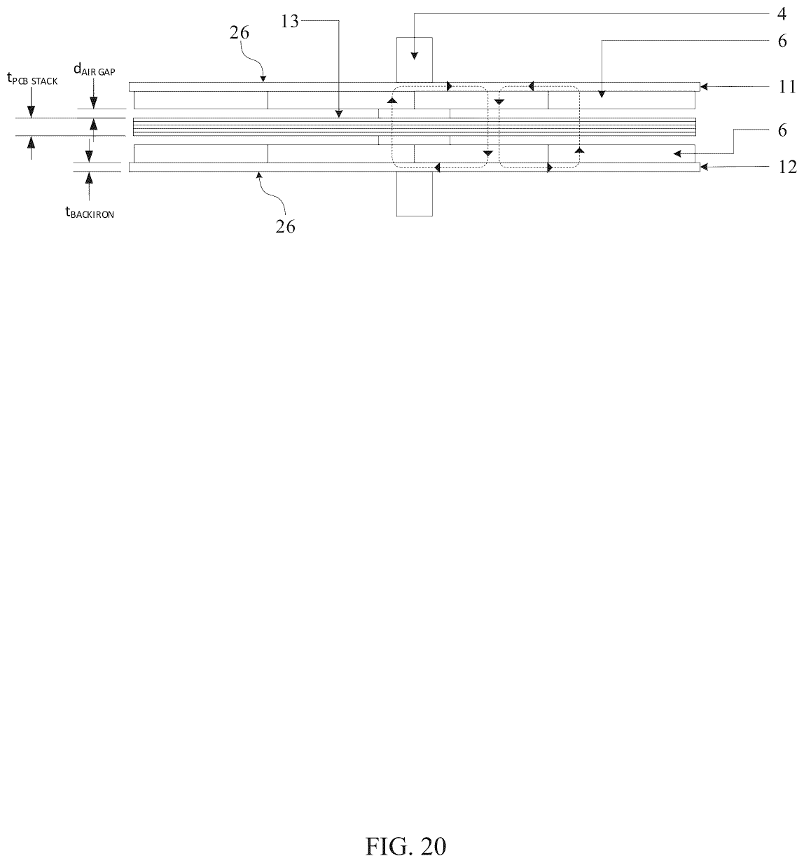

With each additional stator (13), the total thickness of the stack grows, and as the stack grows, the rotor magnets (6) must be moved farther apart. The distance between the magnets (6) of the top and bottom rotors is d_{MAGNETS}=2d_{AIR_GAP}+t_{PCB_STACK} (see FIG. 20). As the magnets (6) are moved farther apart to accommodate a thicker stator stack, the magnetic field weakens; B (in Eq. 1) decreases with increasing d_{MAGNETS}. Therefore, there is a tradeoff between stack thickness and magnetic-field strength.

With greater mechanical precision, d_{AIR_GAP} can be reduced in order to decrease d_{MAGNETS}, however, with increasing precision comes increasing fabrication cost for the mechanical components. Also, d_{AIR_GAP} is already a fraction of t_{PCB_STACK}, therefore minimizing it as much as possible does not offer significant increases in the magnetic field strength.

It is important to note that the diminishing return in adding more stators (13) also holds true for the series-connected scheme. With each addition, N increases, but so does d_{MAGNETS}, therefore a careful analysis is required to justify the added stators (13).

### 2.4.1.7.3 Combo-Connected

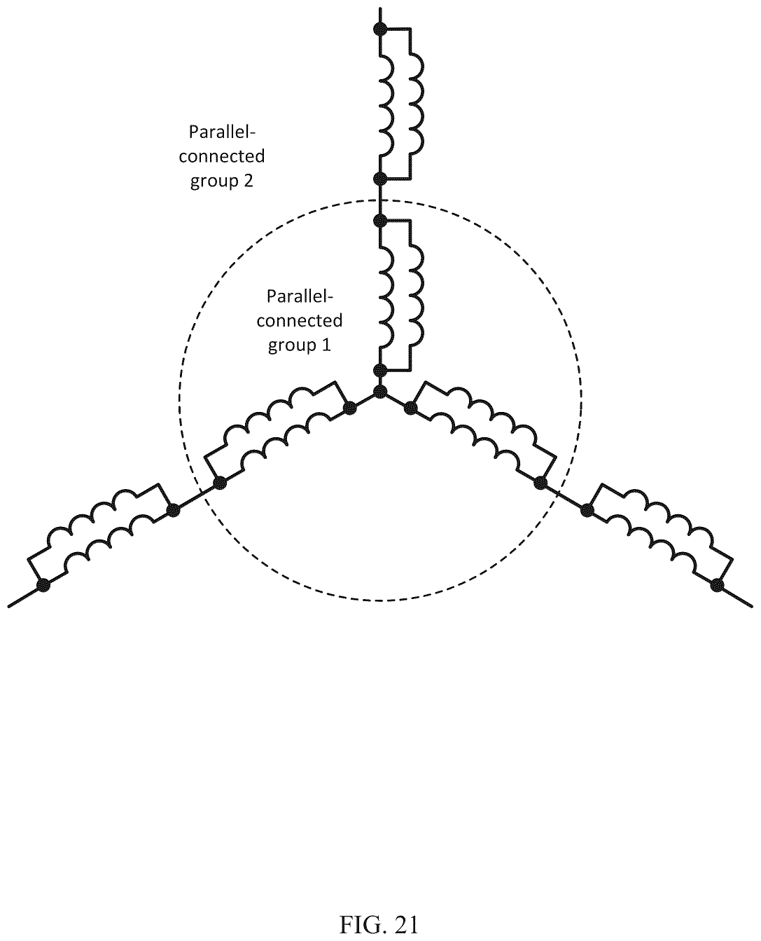

An additional way of configuring the stators (13) is through a combination of series- and parallel-connected schemes. In a combo-connected scheme, several stators (13) would be connected in parallel. A second group of parallel-connected stators (13) would then be rotated and soldered to the first group of parallel-connector stators (13), forming a combination of two parallel-connected groups connected in series. The schematic of this connection is shown in FIG. 21. Note that each parallel-connected group may have more than two stators (13) and that more than two groups may be connected in series.

The same N_{PP}−1 limit that applies to the series-connected scheme applies to the combo-connected scheme. Similarly, the number of parallel-connected groups cannot increase without limit, since they work to grow the stack thickness, necessitating the magnets (6) to be placed farther apart, weakening the magnetic field between them.

The decision to use series-, parallel-, or combo-connected stators (13) is highly application dependent, part of which is the design of the motor driving electronics. A three-phase motor is typically driven by the motor-driver electronics, which is powered by the bus voltage V_{BUS}. Depending on the application, at any given point in time the motor is driven in either velocity mode (where the velocity is controlled irrespective of the torque) or in torque mode (where the torque is controlled irrespective of the velocity). In either case, when the motor spins, it generates a back electromotive force (back EMF). The back EMF works in opposition to V_{BUS} and is proportional to velocity. In other words, the faster the motor spins, the greater the magnitude of the back EMF, and the lower the difference between V_{BUS} and back EMF. Since the phase windings have resistance, the amount of current that can be drawn from V_{BUS} decreases with increasing back EMF, therefore the amount of torque that the motor is capable of generating, decreases with increasing velocity. At the point where the back EMF is approximately equal to V_{BUS}, the motor has almost zero torque. With this in mind, the following table compares properties of motors using all three stator combinations.

TABLE 1
Comparison of the various connection schemes for the 2-layer PCB stator.

| Property | Series-connected | Parallel-connected | Combo-connected |
|---|---|---|---|
| Winding resistance, | Highest | Lowest | In-between |
| R | | | |
| Back EMF | Highest | Lowest | In-between |
| V_{BUS} requirement | High due to high | Low, due to low back- | Depends on back- |
| | back-EMF | EMF | EMF |
| Rated current | Low, due to higher | High, due to lower | Depends on back- |
| | back-EMF and higher | back-EMF and lower | EMF and R |
| | R | R | |

### 2.4.1.8 PCB Stator Stack

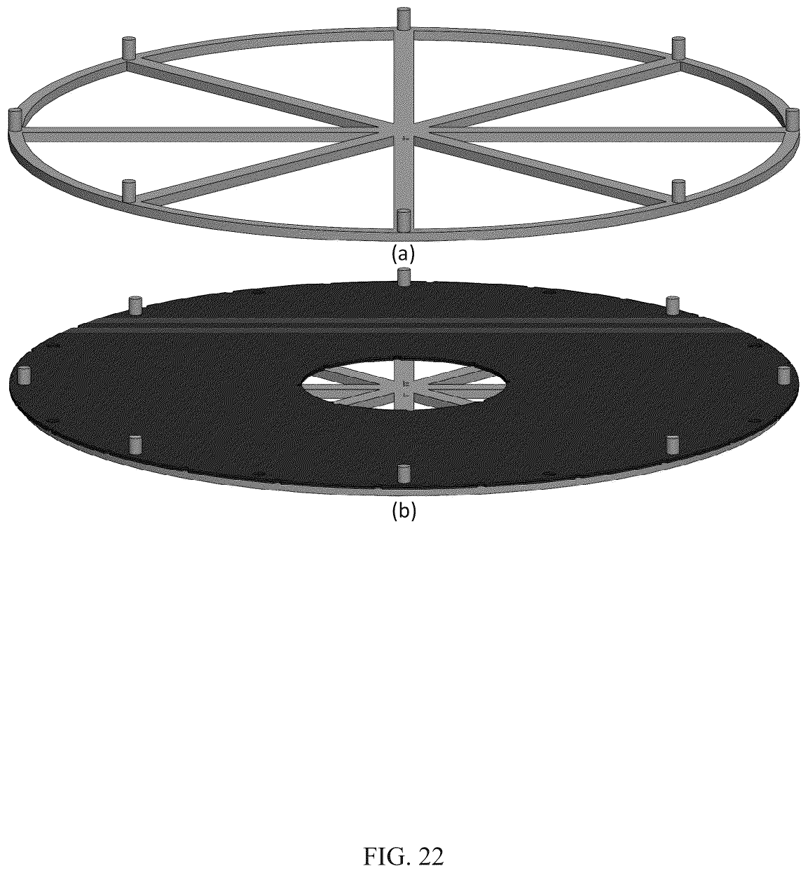

Once the PCB stator (13) is designed and fabricated, they can be stacked together to form the selected connection scheme. The first step is to ensure that the PCB stators (13) are aligned vertically such that there is no angular offset between them. Any offset would result in the “closing” of the mounting hole (19) when looking through the stack of mounting holes (19) in the axial direction. This offset would prevent the mounting screw from fitting through the stack of mounting holes (19). An apparatus may be required in assisting with the alignment. An example is shown FIG. 22.

As can be seen, the alignment apparatus has several pegs that are placed at the exact position of the mounting holes (19). There is no need to have a peg for each mounting hole (19). In the example above, there is a peg for every other mounting hole (19). This allows the PCB stators (13) to be inserted into the apparatus during the bonding process. Any rotation required to place the PCB stators (13) into a series-connected scheme (see section 2.4.1.7.1) would take place in this process.

The PCB stators (13) can be bonded together in one of two ways. 1) Once all the PCB stators (13) are placed in the stack using the alignment apparatus, the inner and outer castellations (20) are to be soldered together. Some modest level of pressure is to be applied to the PCB stack during the soldering process to eliminate any gaps between adjacent PCBs that can add to the overall height of the stack. Once soldered, the stack can be removed from the alignment apparatus. 2) When the first PCB stator (13) is placed into the alignment apparatus, a thermally conductive adhesive is applied to the top surface of the first PCB stator (13). Then, the second PCB stator (13) is added to the top of the first PCB stator (13) and the thermally conductive adhesive applied to the top surface of the second PCB stator (13). This process continues until the last PCB stator (13) has been added. At this point, the inner (21) and outer castellations (20) are to be soldered together as before, by applying some pressure to eliminate any gaps between adjacent PCBs and to ensure the adhesive spreads out. After soldering, the PCB stator stack can be removed from the alignment apparatus and may be required to be placed under some uniform pressure application to ensure the adhesives cures in such a way that does not cause any warping of the PCB stator stack.

Bonding process #1 is faster but does not offer as good of a thermal performance as bonding process #2. This may or may not be a factor, depending on the expected worse-case power dissipation. Bonding process #2 takes longer and it may result in a slightly thicker stack compared to bonding process #1 due to the addition of the thermally conductive adhesive. However, it performs much better thermally, and the PCB stator stack has much greater rigidity.

### 2.4.1.9 Integrated PCB Stator Design

The PCB stator design discussed in the previous section uses a 2-layer board and requires bonding several of them depending on the application. This bonding is an additional step in the overall assembly of the system that incurs a cost. To eliminate this bonding step, an alternative way in designing the stator (13) is to fabricate all phase windings onto a single PCB. This requires determining the connection scheme ahead of time, then designing a multi-layer PCB to accommodate all the windings.

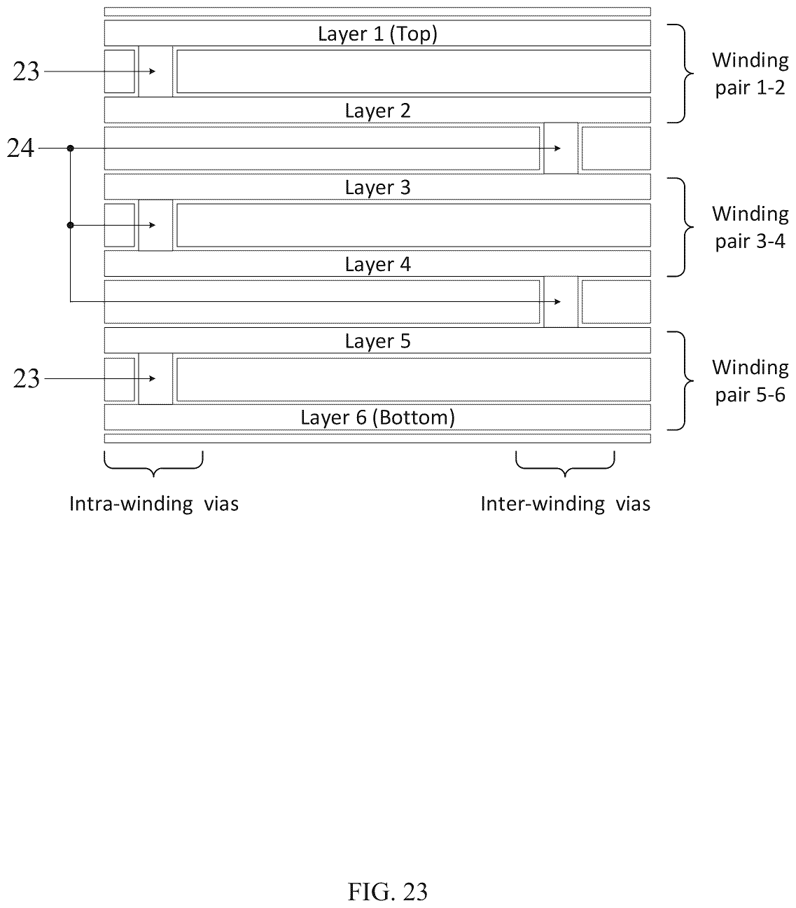

For example, suppose three series-connected stators (13) are to be integrated onto a single board. Since each stator (13) comprises two layers, this will require the board to have 6 copper layers. An example stackup for such a multi-layer board is shown in FIG. 23.

The phase winding of the series-connected stator has its “start” point (see FIG. 13) on layer 1 as it alternates between layers 1 and 2 (using intra-winding blind vias (23)) exactly as discussed in section 2.4.1.3. When the phase winding is fully routed, the “end” point on layer 2 transitions to layer 3 using an inter-winding buried via (24). This is the “start” point on layer 3 as the winding alternates between layers 3 and 4. This process continues in the same fashion for layers 5 and 6. The “start” point of this multi-layer series-connected winding is on layer 1 and the “end” point is on layer 6. The vias are the key for this multi-layer stator.

The 2-layer stator (13) discussed in the previous sections uses through-hole vias (22), which are drilled all the way through the board, connecting the top and bottom layers. The multi-layer series-connected design cannot use through-hole vias (22) to transition between layers as shown by the dashed circles of FIG. 8, because the multilayer stator (13) requires the use of buried vias (24) and blind vias (23) that are vertically stacked, like shown in FIG. 23. Blind vias (23) are those that connect an outer layer (e.g., top) to one or more inner layers. Buried vias (24) connect one or more inner layers together.

For a multi-layer design, looking down into the dashed circles of FIG. 8, one would find several blind vias (23) and buried vias (24) stacked over each other. For example, one would first see a blind via (23) connecting Layer 1 and Layer 2, then below that, there would be a buried via (24) connecting Layer 3 and Layer 4, and below that, there would be another blind via (23) connecting Layer 5 and Layer 6.

In order to transition the winding from the “end” point of Layer 2 to the “start” point of Layer 3 (see FIG. 13), a blind via (23) is used between Layer 2 and Layer 3 somewhere just outside the outer end-turns (15). These vias are designated as “inter-winding vias” in FIG. 23. This allows the phase winding to continue from the start point of Layer 3, meandering around the PCB over Layer 3 and Layer 4 and ending on the “end” point of Layer 4. Here, the winding transition in a similar fashion to Layer 5 using a blind via (23) between Layer 4 and Layer 5 to end up at the start point on Layer 5. From there, the winding continues between Layer 5 and Layer 6, finally ending at the end point on Layer 6.

This approach allows the winding to start on Layer 1 and finish on Layer 6. The end of the winding on Layer 6 may make one final transition up to Layer 1, where pads may be added to the start and end of the winding to allow soldering of phase wires. Alternatively, one or more connectors may be added to allow phase wires to plug into the multi-layer stator (13).

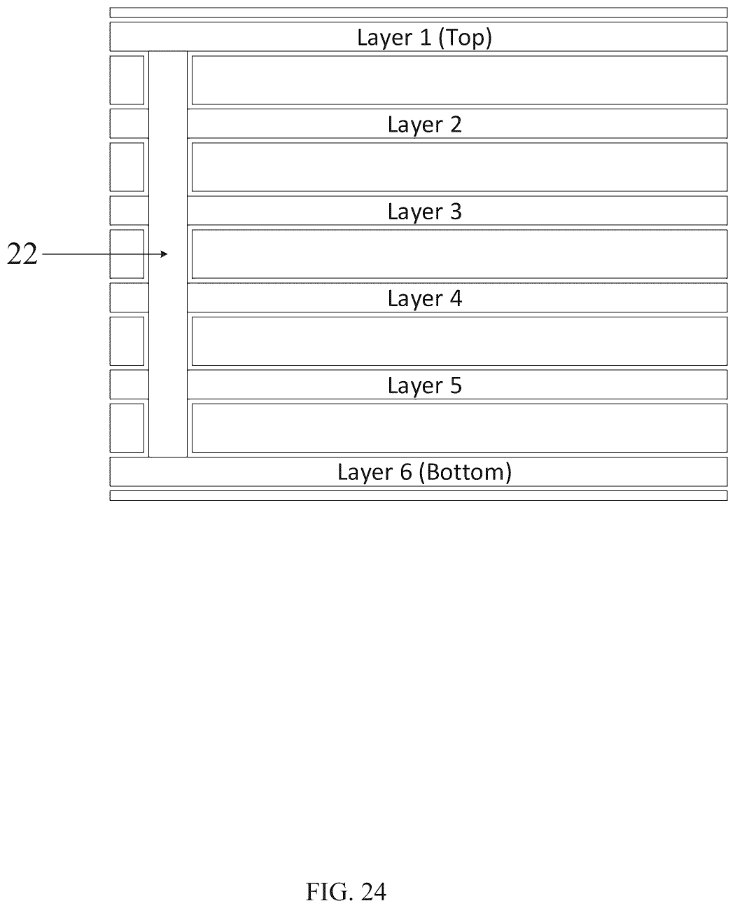

Just like the multi-layer series-connected stator (13), a multi-layer parallel-connected stator (13) may also be designed, except there would not be a need for blind vias (23) and buried vias (24). Since all the individual groups of windings within a phase are in parallel, a through-hole via (22) can now be used where dashed circles are shown in FIG. 8. An example stackup is shown in FIG. 24.

For the parallel-connected stator, the phase winding is exactly the same as that for the 2-layer design, except the phase winding would repeat on layer pairs 1/2, 3/4, and 5/6. And the vias (shown in FIG. 8) would be through-hole vias (22) connecting to every layer of the board.

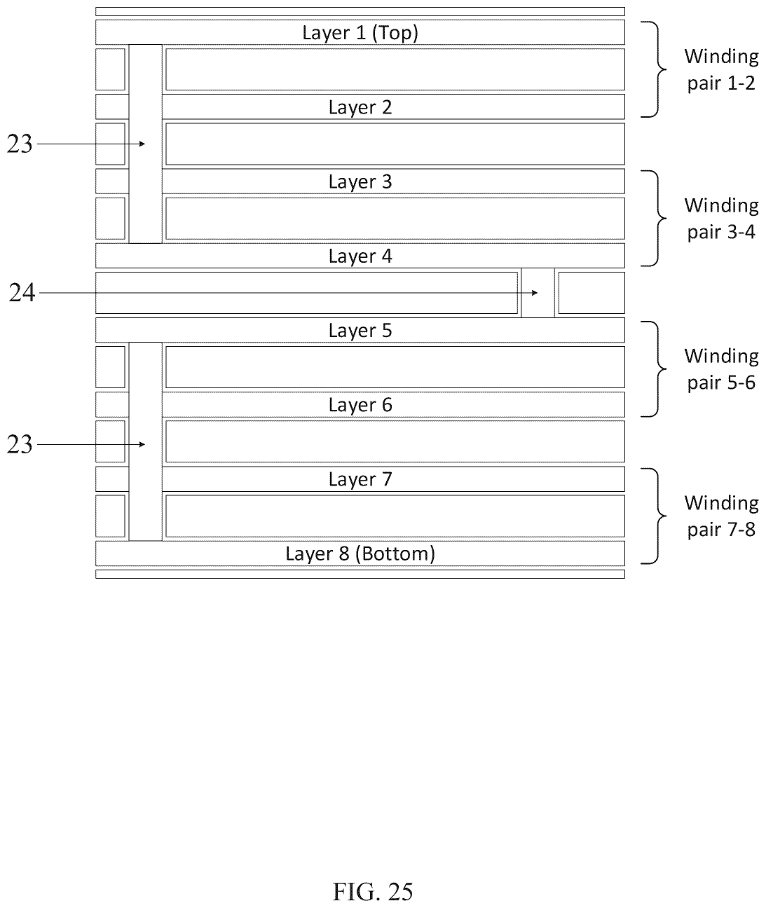

Finally, for the combo-connected stator, there would be several groups of parallel-connected layers, which are connected in series. This sort of PCB design would once again use blind vias (23) and buried vias (24), an example of which is shown FIG. 25. The parallel-connected groups would be on Layers 1/2/3/4 and 5/6/7/8, but they would be connected in series using the blind-via (23) transition from Layer 4 to Layer 5.

The advantages and disadvantages of the multi-layer stator compared to the 2-layer stator (13) is provided in the table below.

TABLE 2
Pros and cons of the multi-layer PCB stator.

| Multi-layer | | |
|---|---|---|
| PCB Property | Advantage | Disadvantage |
| Rigidity | The multi-layer PCB | |
| | would be much more | |
| | rigid than several stacked | |
| | 2-layer stators soldered | |
| | together. | |
| Thickness | | The multi-layer PCB would be thicker than its |
| | | equivalent 2-layer stator stack. For example, the 8- |
| | | layer stackup shown in FIG. 23 contains dielectric |
| | | layers between layers 2/3, 4/5, and 6/7, whereas, if |
| | | four 2-layer boards were stacked, there would not be |
| | | such dielectric material between the boards, but only |
| | | a couple of thin layers of soldermask. See FIG. 18 |
| | | (b). |
| Cost | Less system-integration | Much higher PCB fabrication cost, especially when |
| | cost since it eliminates | blind vias (23) and buried vias (24) must be used. |
| | the additional step of | |
| | soldering stacks together | |
| Connection | | Not stackable, therefore scheme must be determined |
| scheme | | prior to PCB fabrication. |

### 2.4.2 Rotor Design

The ECORD Motor makes use of the dual-rotor design, shown in FIG. 20. Each half of the rotor (26) uses N_{MAG} magnets (6), which in the case of the ECORD prototype, N_{MAG}=16. The rotor backiron (11 and 12) must be constructed using ferromagnetic materials, such as iron, mild steel, or similar magnetic-grade steel to present a low reluctance path for the magnetic field flowing across the air gaps and the PCB stator stack. Note that the air gaps and the PCB stator stack present a high reluctance path, so if t_{PCB_STACK} (see FIG. 20) increases due to additional PCB stators (13), the reluctance grows, weakening the magnetic field. Recall from section 2.4.1.7 that there is diminishing returns in growing the stator stack due to the weakening of the air gap magnetic field.

The thickness of the backiron (11 and 12), t_{BACKIRON} (see FIG. 20) is important. If it is too thin, it can easily become saturated by the magnetic field of the magnets (6), causing some portions of the magnetic field to find an additional path to complete the loop. This path will flow outside of the backiron (11 and 12), through the air, which presents a high reluctance path. This saturation will inevitably lead to a weaker magnetic field in the air gap, where it matters most. In other words, B in Eq. 1 will decrease, as will the torque production.

Because of the dual-rotor design, there is a tremendous force of attraction between the two half rotors, due to the proximity of the magnets (6) to one another. The magnets (6) are adhered to the backirons (11 and 12) through the use of epoxy or similar strong adhesives; therefore, this force is transferred to the backirons (11 and 12). Thin backirons (11 and 12) can deform in the presence of such a force. If the air gap is sufficiently small and the backirons (11 and 12) sufficiently thin, it is possible for the backirons (11 and 12) to deform enough such that the outer edge of the magnets (6) come in contact with the PCB stator stack, scraping against it as the rotor spins.

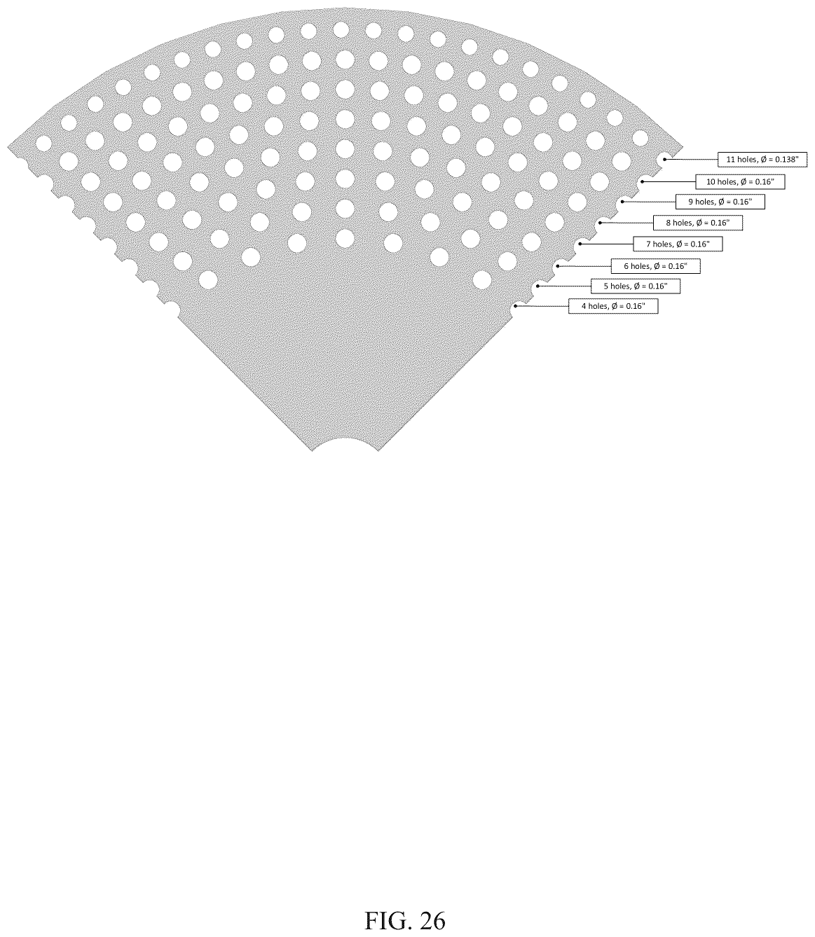

Thicker backirons (11 and 12) resolves these issues but add weight. Therefore, t_{BACKIRON} should be made as thick as necessary to eliminate the saturation and deformation, but no thicker. One alternative is to make the backirons (11 and 12) thick but remove small sections throughout the volume, for example, small diameter holes can be drilled throughout the material to make it lighter. Computer simulations can be performed to optimize the weight and performance in terms of magnetic-field saturation to strike a balance between the two. A partial view of a backiron with example cutouts is shown in FIG. 26, the design of which was used in a computer simulation. The simulation results show a magnetic field reduction of 6.4% and a weight reduction of about 20% compared to a backiron (11 or 12) with the same thickness but without the holes.

### 2.4.2.1 Rotor Assembly Example

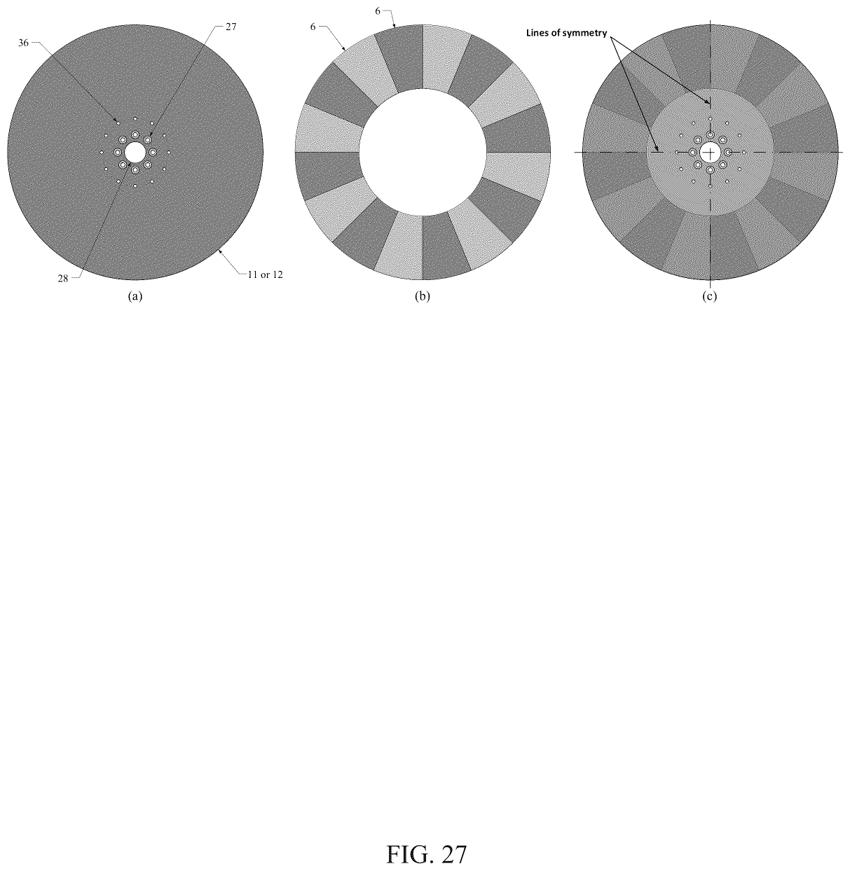

The illustration shown in FIG. 27 (a) is the backiron (11 or 12) design used in the ECORD prototype. It is an 8″ circular disc made from 1018 mild-steel material with a thickness of 3/16″. It contains an opening (28) for the shaft (4) to pass through with 8 M3-type countersink screw holes (27) for mounting to the rotor-support-structure of the shaft (4). The countersunk holes allow the use of flathead screws (39) that sit flush against the surface to keep an overall low profile for the motor. An additional 12 threaded M3 screw holes (36) are used for motor assembly. No additional cutouts are used for weight reduction (see section 2.4.2).

The ring of magnets (6) shown in (b) are arranged in an alternating polarity, indicated by two shades of gray. They are individually adhered to the opposite side of the backiron (11 or 12) (using a strong adhesive) forming half of the rotor (26)(c). In (c), the backiron is made transparent to indicate the magnets (6) are on the bottom side, opposite to the countersink holes. It is important to note that the rotor (26) is designed to be symmetrical along the lines of symmetry, as shown in FIG. 27 (c). This means that if one half of the rotor (26) is rotated by 180 degrees along either of these lines, then 1) the orientation of the magnetic field does not change, and 2) the hole arrangement stays the same. These are important factors because they allow both rotors used in the motor to be identically constructed, which saves fabrication costs compared to having to design two dissimilar rotors. All that is required during motor assembly is to simply rotate one of the half rotors by 180 degrees.

It is important to note that the example shown in FIG. 27 (a) is one embodiment of how the backiron can be designed. The actual hole size of the shaft (4), the size and number of screw holes (27 and 36) may be different in another embodiment. In addition, there may not necessarily be a need for any assembly-specific screw holes (36) (like the 12 M3 holes shown in the figure). There may not necessarily be a need for the shaft mounting-holes (27) either, since it is possible to adhere the rotors to the rotor-support-structure surfaces (37) of the shaft (4) using a strong adhesive. The method in which the rotors are assembled onto the shaft (4) ultimately depends on the assembly process used during high-volume production.

### 2.4.3 Motor Assembly

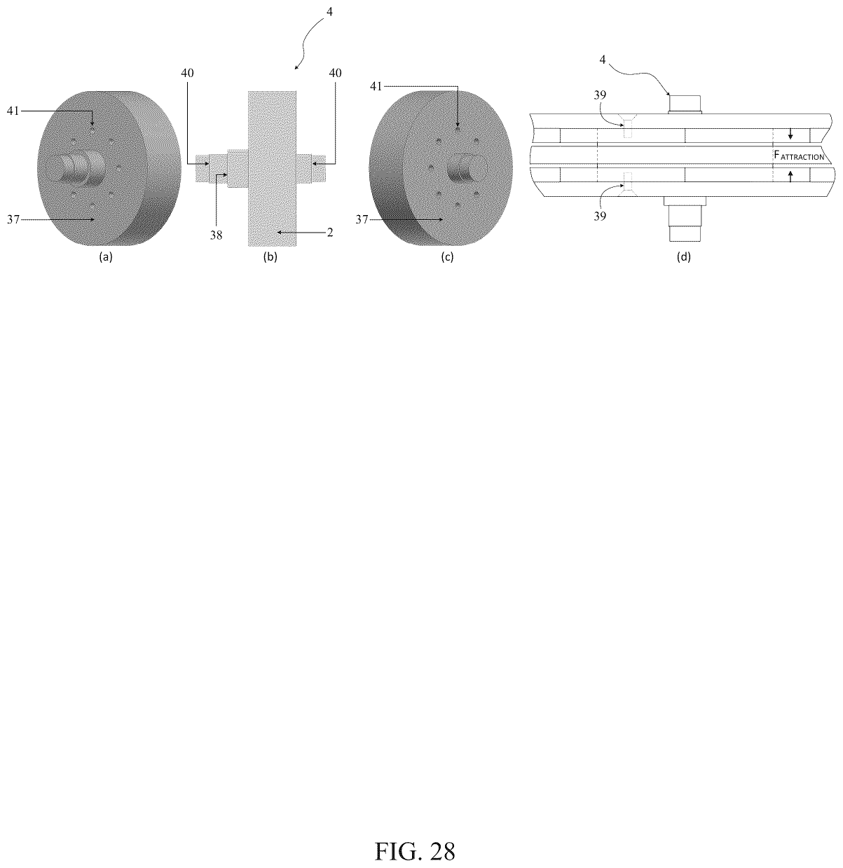

Once both rotor halves (26) are assembled and the PCB stator stack soldered in the desired configuration, they can all be assembled onto the shaft (4), as shown in FIG. 28. One half of the rotor (26) is placed over the shaft (4) and screwed onto the rotor support structure (2) via flathead screws (39) that pass through rotor screw holes (27) and threaded into the rotor mounting holes (41), coupling it to the shaft (4). Next, the PCB stator stack is placed onto the shaft (4). Finally, the second half of rotor (26) is rotated by 180 degrees along the line of symmetry and then placed over the shaft (4) and screwed in. This ensures that the magnetic fields line up properly, as per FIG. 3. In the assembly shown in FIG. 28 (d), the PCB stator stack is floating freely between the two half rotors. It must be mounted onto spacers within the larger enclosure of the motor, which is discussed in section 3.1.

The force between the two half rotors is shown as F_{ATTRACTION}. Although the arrows are to one side of the diagram, the force is uniformly distributed across the top and bottom rotors, such that the rotor support structure (2) experiences a uniform compression force.

In a typical motor, the shaft (4) has a cutout for a key, however, in the ECORD design this is eliminated, per the discussion in section 2.5.2. Finally, the ends of the shaft (4) are designed to be inserted into bearings as discussed in section 3.

### 2.4.4 Encoder

To operate a brushless motor, the three phases must be commutated properly. This requires knowledge of where the rotor angle or position is with respect to the stationary stator (13). Rotor position can be obtained with the aid of Hall Effect sensors, which are positioned with respect to the stator (13). Hall Effect sensors sense the presence of the magnetic field of the rotor magnets (6) and provide a logic-level signal that represents the sensed polarity of the magnetic field. They are positioned 120 °E apart from each other. This translates to 15 °M in the case of the ECORD motor design (see section 2.4.1.7.1). Hall Effect sensors provide a rotor position resolution of 60 °E. In the case of the ECORD motor design, this translates to 7.5 °M. For trapezoidal commutation—where the waveform of the phase currents resembles the shape of a trapezoid—Hall Effect sensors are sufficient for motor commutation. There are also sensorless control methods that do not require any Hall sensors at all, only the zero-crossing of the back EMF of the floating phase is required to be sensed to commutate the motor.

In sinusoidal commutation—where the waveform of the phase currents is modulated in a sinusoidal fashion—an encoder is required to provide a high-resolution position of the rotor. Sinusoidal commutation produces a much lower torque ripple at the cost of somewhat lower maximum output torque compared to trapezoidal commutation. Encoders produce at least two quadrature signals, called A and B, where A and B are square-wave signals that are out of phase by 90°. Quadrature encoder signals can provide a very high-resolution angular position—on the order of an arcminute or less—to the motor controller. A subset of commercial encoders also provides an index signal, called Z, which triggers a pulse once per mechanical revolution. A much smaller subset yet, provides the commutation signals, eliminating the need for the Hall sensors. Encoders that provide the commutation signals are programmable, to allow the factory to set the number of poles (number of motor magnets) and alignment of the commutation signals with the back EMF signal of the motor. The number of poles is limited by the encoder and there is an even smaller subset that allow for high poles counts. The 16 poles used in the ECORD motor is considered a high number.

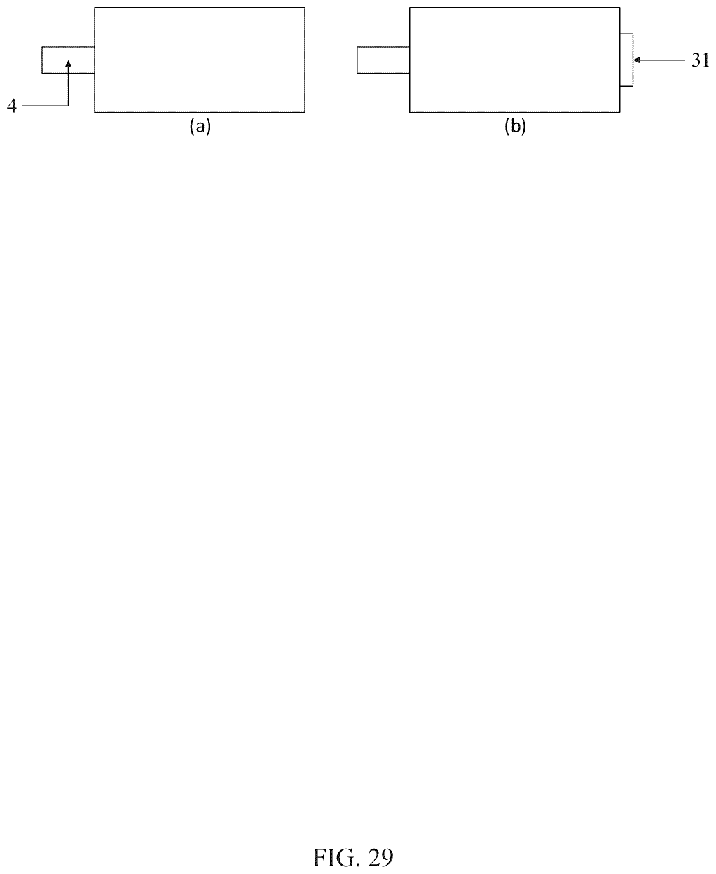

The vast majority of the available encoders in the market today are mounted on the opposite end of the shaft (4), as illustrated in the FIG. 29. As can be seen, the encoder (31) adds to the general length of the motor along the shaft (4) (axially). Since one of the primary objectives of the ECORD is to design a very low-profile device, an encoder (31) was designed that takes up a minimal amount of height from the available real-estate.

### 2.4.4.1 ECORD Encoder

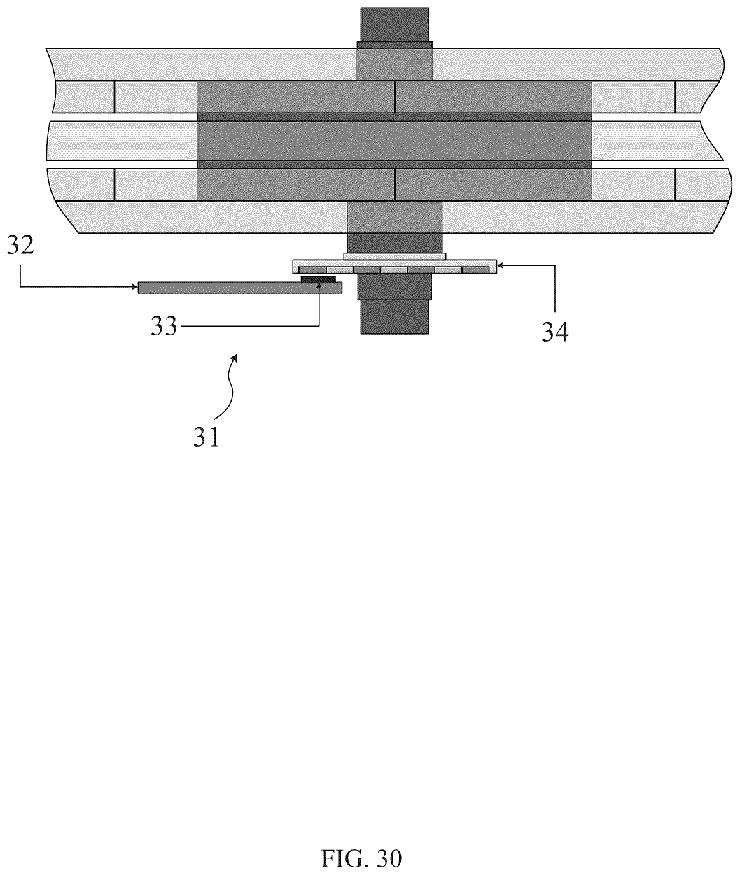

The encoder (31) shown in FIG. 30 used in the ECORD comprises a commercial integrated circuit (IC) (33), a custom-designed PCB (32) and a commercial encoder wheel (34). The selected encoder IC provides all the necessary signals: the quadrature signals, index signal, and the commutation signals. As such, no Hall sensors are used in the ECORD. The encoder IC senses the magnetic field of the encoder wheel. The encoder wheel comprises a circular arrangement of small alternating-polarity magnets. The IC senses these fields and produces the necessary output signals. A custom circuit board (32) is designed to host the encoder IC, convert its single-ended output signals into differential pairs, and output those signals through connectors. This circuit board is positioned just underneath the magnetic wheel (34). The magnetic wheel is pressed onto the shaft (4) so that it is positioned flush against the encoder wheel contact surface (38) (see FIG. 28 (b)).

An alternative method of generating the encoder signals is to use a commercial optical encoder IC and replace the magnetic encoder wheel with an optical encoder wheel. The optical encoder wheel is comprised of a reflective surface with small, equally spaces cutouts. The optical encoder IC shines a light onto the surface of the optical encoder wheel and detects a signal where the light reflects off the surface and no signal when it doesn't. As the motor spins, these alternating signals are processed and converted into the quadrature signals by the IC. The optical encoder wheel may additionally possess cutouts for the index and commutation signals assuming the encoder IC supports detecting them.

### 2.5 Spooler:

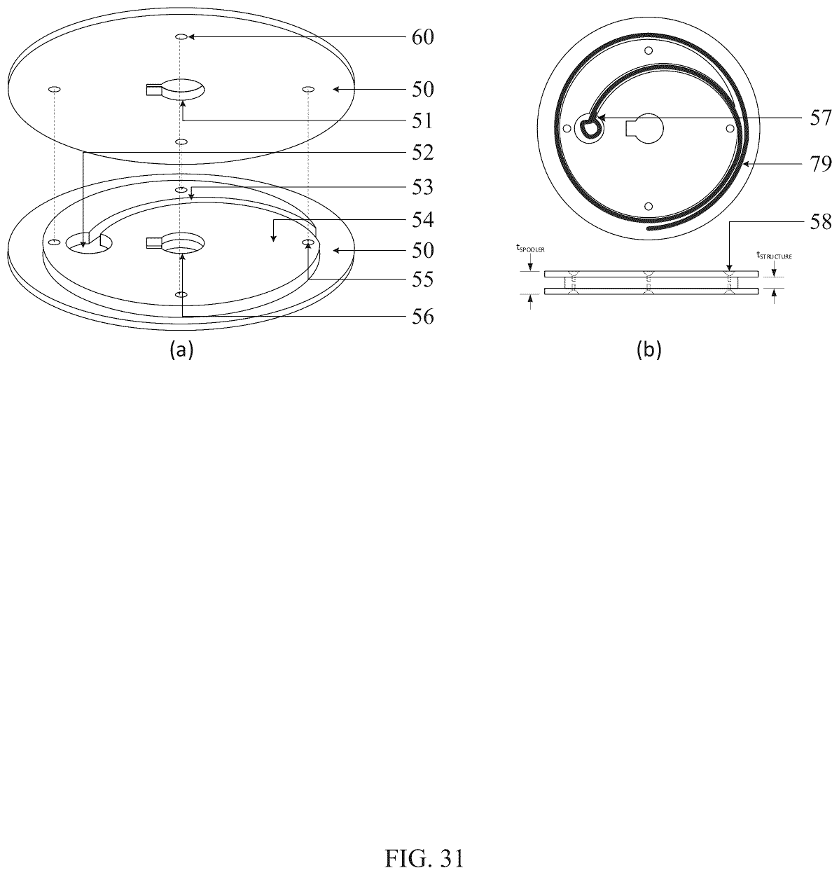

The rope that provides the tension during an exercise is spooled onto the spooler. When the rope is retracted by the motor, the rope is spooled in. When the user pulls on the rope, it is spooled out. The spooler is designed to have a very low height to meet the ECORD's low-profile objective. An embodiment of the spooler is shown in FIG. 31.

The spooler (59) is made from three parts, two of which are identical: the top rope retainer (50) and bottom rope retainer (50). Sandwiched between them is the spooling structure (54). The spooler assembly begins by first mounting the bottom retainer to the spooling structure via screws (58). This requires the spooling structure (54) to have threaded screw holes (55) but the top- and bottom-retainers (50) to have unthreaded screw-clearance holes. Next, the rope is anchored by first routing it through the anchor path (53) then making a knot (57) at the end such that once the knot is placed within the rope anchor point (52) it will be too large to slide out of the path. The rope may be further reinforced by potting the anchor point (52) and/or anchor path (53). Once the rope is secured (and possibly potted), the top retainer (50) is mounted via screws (58), completing the assembly. For the lowest profile, flathead screws (58) can be used, requiring countersink mounting holes (60) to be drilled into the top- and bottom-retainers. Although only four screws (58) are shown in the figure, more may be added as necessary for greater support.

The top illustration of FIG. 31 (b) shows how the rope (shown as a spiraling line) is routed and spooled around the spooling structure (54). A side view of the spooler is shown on the bottom figure of FIG. 31 (b), with the total thickness of the spooler indicated as t_{SPOOLER}. This dimension is mostly driven by the thickness of the rope, which drives the thickness of the spooling structure, t_{STRUCTURE}. As an example, the ECORD uses a commercial, high strength, 2 mm thick rope.

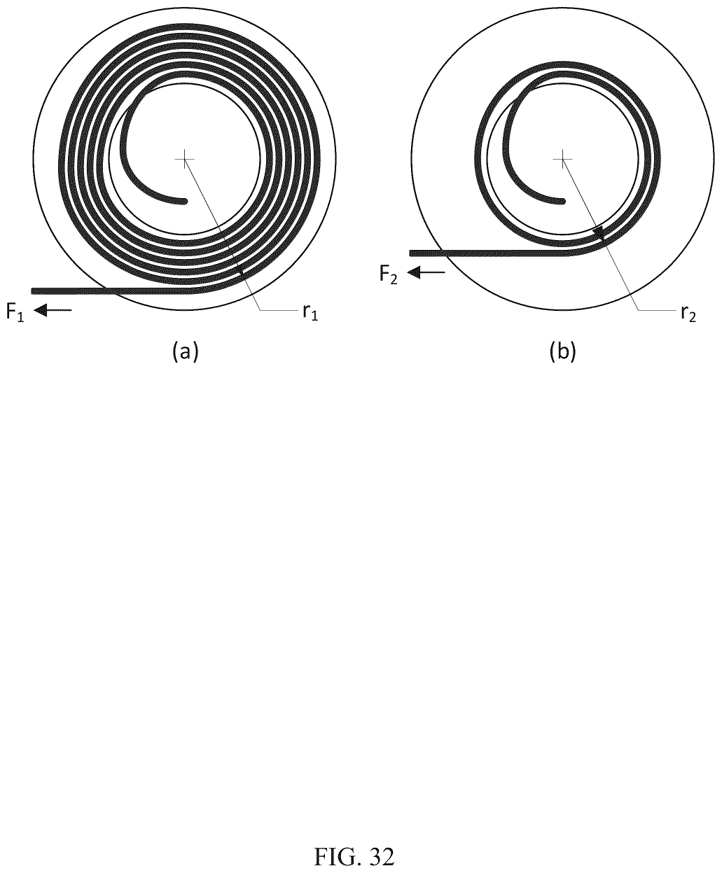

All three pieces of the spooler have an identical cutout (51) for the shaft hole, including the key (rectangular shape in the cutout). The three-piece approach helps reduce the overall manufacturing cost due to 1) all pieces are essentially two-dimensional structures (not including the countersink holes). This means a flat piece of aluminum (or other metal) of the required thickness is simply cut and drilled. It does not undergo any three-dimensional manipulation during fabrication. 2) the top (50) and bottom retainers (50) are identical, which reduces cost due to economy of scale. It is possible to make the bottom retainer and the spooling structure out of a single piece of metal. This will increase the cost but there will be less assembly work to put the spooler pieces together. A consequence of using a low-profile spooler is that the rope must spool over itself, which means that the radius of the spooled rope changes depending on how much of the rope is paid out. This is illustrated in FIG. 32.

As can be seen, the more rope that is spooled in, the greater the radius, such that r₁>r₂. The force, Fᵢ (where i=1 or 2), is what the user feels when performing an exercise. For a given motor torque, this force is Fᵢ=τ/rᵢ, where τ is the motor torque. For a fixed torque, F₁<F₂, which means the user will feel the least force at the beginning of a rep than at the end. This essentially mimics a resistance band. This may or may not be desirable. If this is undesired, user may set the system to “constant force” in the App. In this case, the motor torque will vary in such a way to maintain a constant force. In other words, more torque will be applied when rᵢ is large and proportionally less torque will be applied as rᵢ decreases. This variation in the torque is taken care of via the feedback system of the ECORD, which will be discussed in section 3.2.

### 2.5.1 Motor and Spooler Assembly

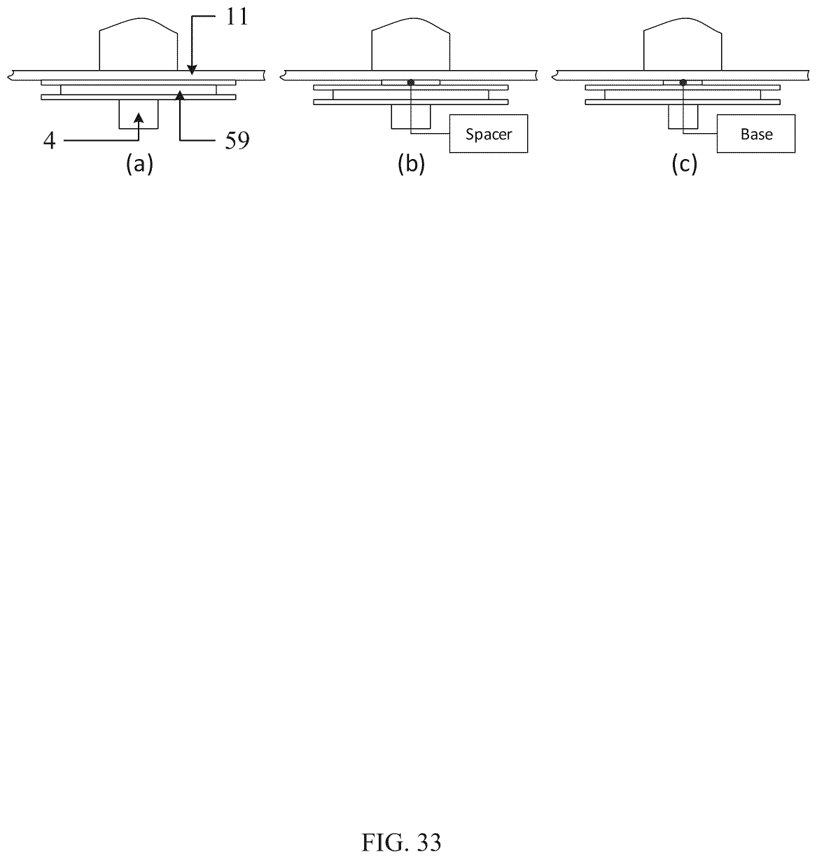

The spooler fits over the shaft (4) and positioned such that its key-notch slides over the key of the shaft (4). There may or may not be a gap between the spooler and the bottom backiron (12). Various mounting schemes are illustrated in FIG. 33.

FIG. 33 (a) shows that the spooler is simply sitting flush under the bottom backiron (12). In FIG. 33 (b), a spacer is added between the spooler and the bottom backiron (12) to provide some elevation. Finally, in FIG. 33 (c), the shaft (4) itself has a base that the spooler sits under. This base is slightly wider than the diameter of the hole required to fit the shaft (4) through the spooler. These are ways to position the spooler under the bottom backiron (12) given the needed spacing requirements.

### 2.5.2 Simplified Motor and Spooler Assembly

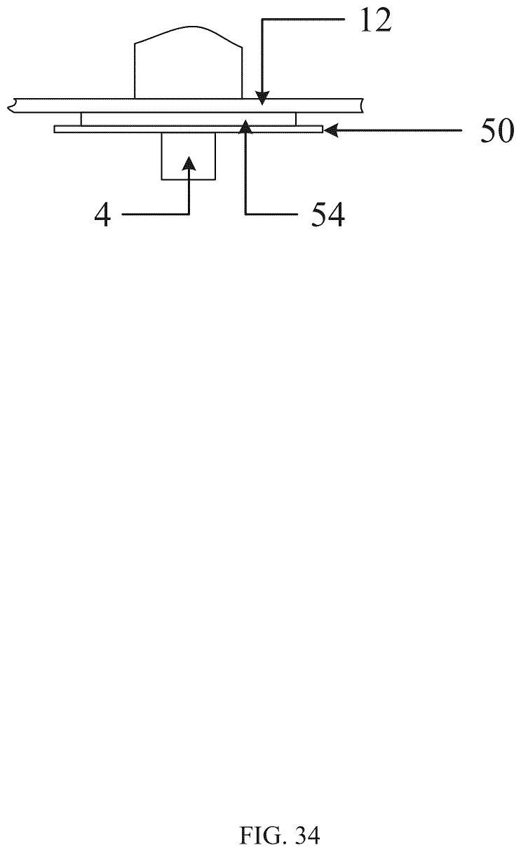

As discussed in the previous section, the spooler may sit flush against the bottom backiron (12) (FIG. 33 (a)). In this case, the top rope retainer (50) of the spooler (see FIG. 31 (a)) is superfluous because the bottom backiron (12) itself can take over that role. This concept is shown in FIG. 34.

As can be seen, the bottom backiron (12) now has two roles: bottom backiron (12) and bottom rope-retainer (50). The spooler has also been reduced to only two parts: the bottom rope retainer (50) and the spooling structure (54). The bottom backiron (12) will require matching threaded screw holes as those found on the spooler parts (see FIG. 31 (a)).

This approach has several advantages: 1) Reduced number of parts due to the spooler requiring only two parts rather than three, saving on cost. 2) No key required on the shaft (4). This is due to the spooling structure being mounted to the bottom backiron (12) via screws (58) to hold it in place, eliminating the need for a key on the shaft (4). This saves cost on shaft (4) manufacturing by not needing to call out a key cutout as well as not needing a tight tolerance for that cutout. There are also some minor cost savings for not needing a key. 3) No twisting force on the narrower parts of the shaft (4). Since the rope spooling structure is mounted to the bottom backiron (12) and the bottom backiron (12) is mounted to the rotor support structure (2) (see FIG. 28), the twisting force during an exercise routine is transferred to the fatter, stronger part of the shaft (4). 4) Lowest profile achievable.

### 2.5.3 ECORD Spooler

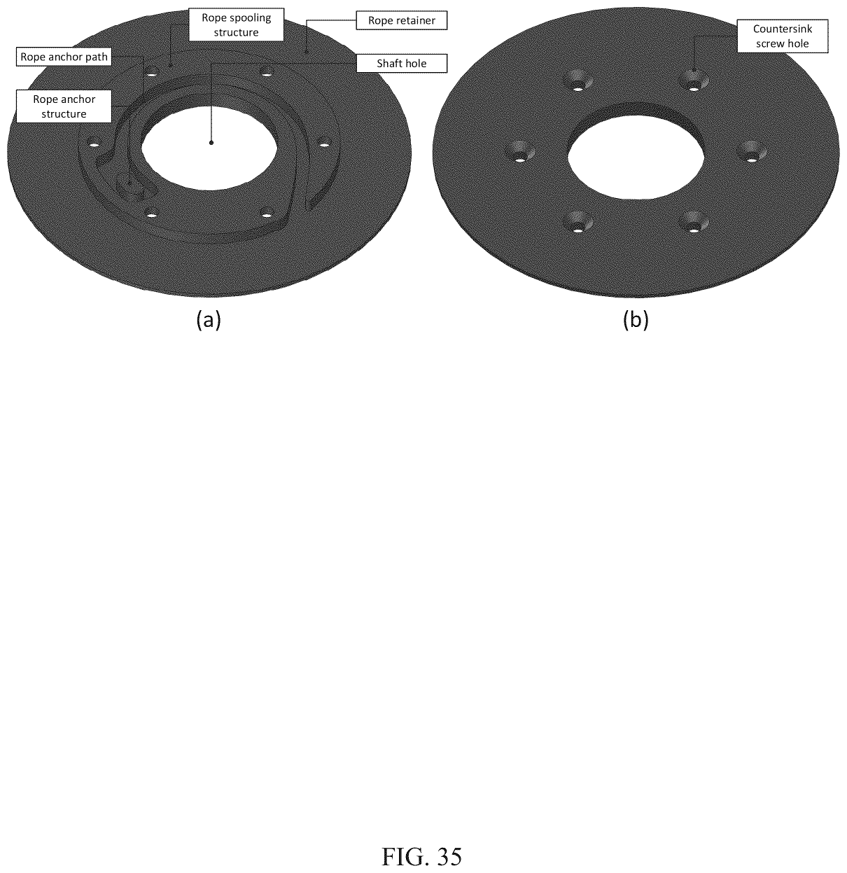

In the ECORD prototype, the spooler used follows the simplified spooler assembly discussed in section 2.5.2 and is made from a single piece of aluminum. In addition, the shaft (4) used in the ECORD prototype does not use a shaft key, therefore the spooler does not require a key cutout. FIG. 35 shows the prototype spooler.

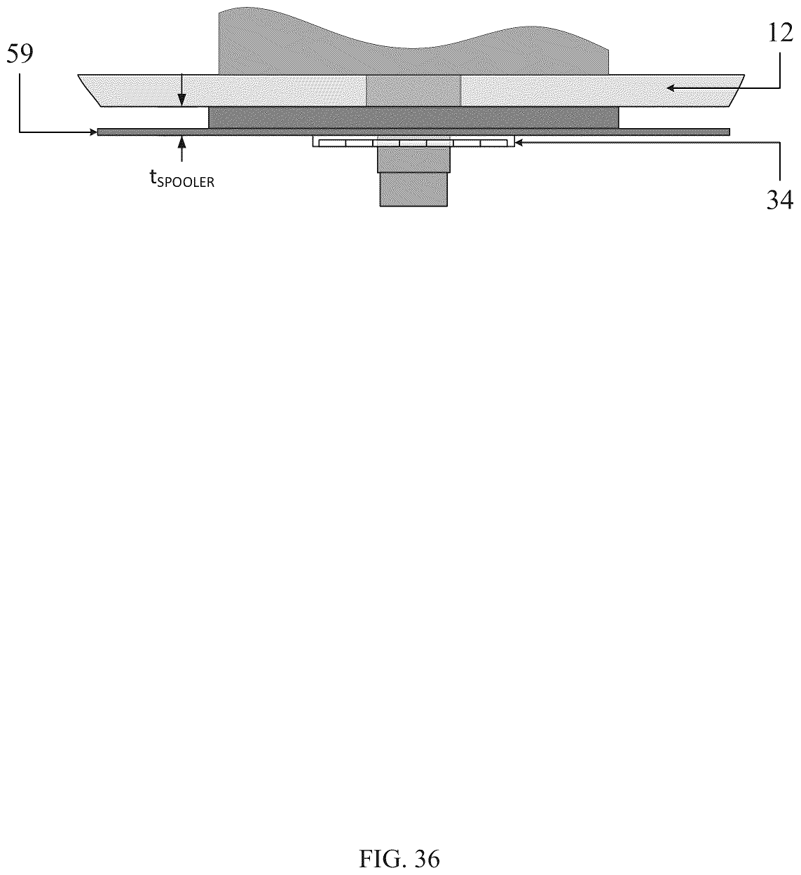

FIG. 36 is an illustration of where the spooler is mounted in relation to the bottom backiron (12) and the magnetic encoder wheel (34). As indicated, the magnetic encoder wheel (34) partially protrudes from the shaft hole of the spooler. The total thickness, t_{SPOOLER}, of the ECORD spooler is 4.25 mm. This includes the screws (58), which are flush with the surface since the screw holes (60) are countersinked.

### 3 STRUCTURE

The general structure of the ECORD is relatively simple. The ECORD motor, associated electronics, UI, and feedback system are all sandwiched between two plates: Top Plate (61) and Bottom Plate (62). This section provides details of this structure.

### 3.1 Motor Assembly

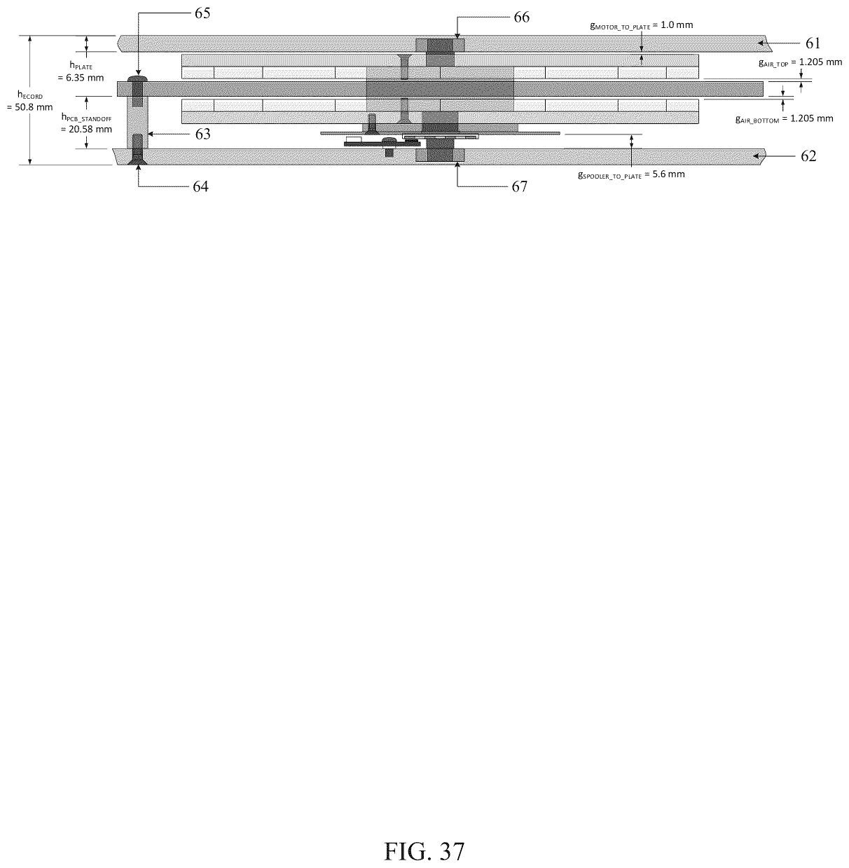

The Top Plate (61) and Bottom Plate (62) are part of the ECORD enclosure, and the motor is fitted internally between the two. The ECORD motor assembly comprises the motor (see section 2.4.3), the spooler (59) mounted to the bottom backiron (12) (see section 2.5) and encoder magnetic wheel (34) (see section 2.4.4.1). The Top Plate (61) and Bottom Plate (62) each support a bearing hole that a bearing fits through. The motor shaft (4), in turn, fits inside these bearings, supported by the bearing support surfaces (40) on the shaft (4). The PCB stator (13) stack has several mounting holes (19) located around the perimeter of the PCB (see FIG. 14). These mounting holes (19) are used to mount the PCB stator stack to threaded standoffs (63) that are themselves mounted to the Bottom Plate (62). This structure is shown in FIG. 37.

The assembly is straightforward. First the top bearing (66) and bottom bearing (67) are fitted onto their respective plates using transition or interference fitting. (“Transition,” “interference,” and “clearance” are industry standard terminology with specific definitions based on the bearing size, the housing size that supports the bearing and the requirements for the specific application.) Next, the threaded standoffs (63) are mounted to the Bottom Plate (62) via flat-head screws (64). The Bottom Plate (62) has countersink holes so that these screws (64), when mounted, are flush with the surface. This is necessary to keep the total height, h_{ECORD}, to a minimum. Next, the ECORD motor assembly is placed such that the shaft (4) fits through the bottom bearing (67) using clearance fitting. Clearance fitting does not require pressing the bearing onto the shaft (4), but the tolerance can still be tight to ensure the motor does not wobble during operation. Once in place, the PCB stator stack is mounted to the threaded standoffs (63) using the top screws (65). Finally, the Top Plate (61) is placed such that the top of the shaft (4) fits through the top bearing (66) using a clearance fit.

The various gaps and heights are called out in FIG. 37. The threaded standoff (63) is selected such that the air gaps g_{AIR_TOP} and g_{AIR_BOTTOM} is equal. All gaps are designed to minimize h_{ECORD}, which is 50.8 mm or 2″ for the ECORD prototype.

Notice that the bearings are thinner than the thickness of their respective plates, which have a thickness of h_{PLATE}=6.35 mm or ¼.″ Although the bearings could have been selected to have the same thickness as the plates, this would have required a complete through-hole to be drilled for the bearing. This would have exposed the bearings to dirt and dust from the environment and would require a bearing to be shielded or sealed, which cost more than open bearings. The bearing would also have been visible from the outside, which would not be esthetically pleasing. As a result, a bearing slightly thinner than the thickness of the plate was selected so that the bearing hole can be cut “blind” and not visible from the outside. Also, the bearing sits flush with respect to the inner surface of its respective plate. Notice that the gap between the motor and the Top Plate (g_{MOTOR_TOP_PLATE}) is only 1 mm. If the bearing does not sit flush and protrudes a bit (say, if a thicker bearing was used), it runs the risk of scraping against the top backiron (11) due to the small gap, g_{MOTOR_TOP_PLATE}.

Also notice the small gap available for the encoder (34), g_{SPOOLER_TO_PLATE}, is only 5.6 mm. There are no commercial encoders available that can fit within this small a gap and provide all of the quadrature, index, and commutations signals, and support a high number of poles, necessitating the design of a custom encoder board using the methods discussed in section 2.4.4.

### 3.2 Rope Management System

This section provides details of the ECORD Rope Management System, which comprises several rollers, internal rope tensioning, and the feedback system that continuously measures the rope tension and provides this data to the main controller.

### 3.2.1 Overview

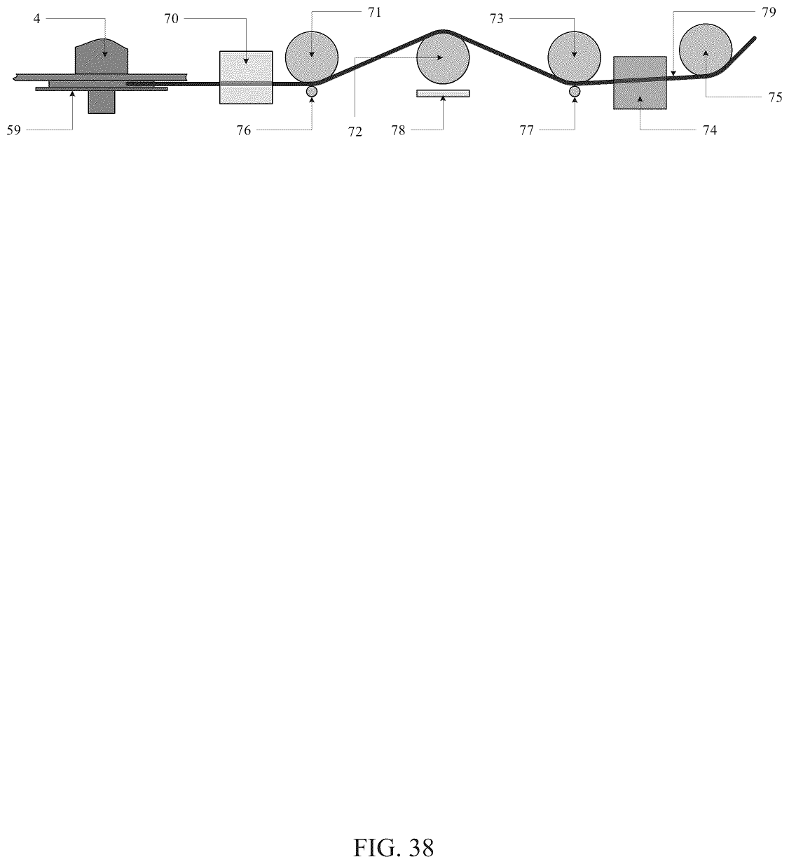

The Rope Management System has two main functions: 1) It ensures that during normal operation the rope spools in-and-out properly from the spooler and that the rope does not mis-spool due to too much rope slack, and 2) the tension of the rope is continuously measured as part of the main feedback system. This is illustrated in the FIG. 38. During an exercise routine the rope (79) is spooled in/out by the Spooler (59), which is coupled to the motor shaft (4). The rope (79) is fed through several rollers before it exits the ECORD. There are three rollers (Inner (71), Center (72), and Outer (73), a cantilevered beam (78), and electronics that function to measure the rope tension. The Inner Parallel roller (70) guides the rope between the Spooler (59) and the Inner roller (71), while the Outer Parallel roller (74) and Egress roller (75) act as a fairlead to help keep the rope (79) centered as it is being spooled in and out. The rope (79) is internally tensioned in case there is no external tension applied to the rope. This can happen, for example, if the user drops the handle during an exercise routine. The internal tensioning can take place in a couple of ways, as will be discussed later.

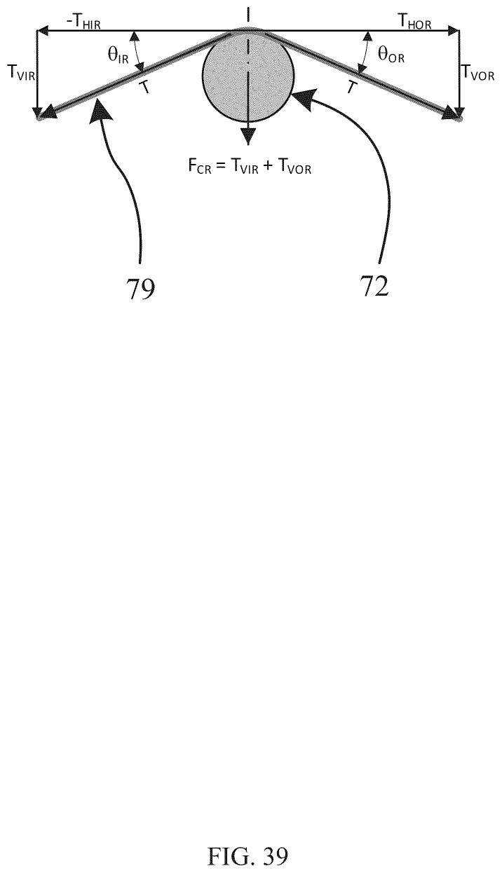

As indicated, the rope (79) is fed between the Inner (71) and Outer (73) rollers, going over the Center (72) roller. The Center roller (72) is mechanically coupled to a cantilevered Beam (78). Any tension on the rope (79) causes a downward force on the Center roller (72), which in turn causes the Beam (78) to deflect. An electronics board continuously monitors this deflection, which is mapped to the amount of tension on the rope (79). As a result, the ECORD directly measures the tension of the rope (79). The forces acting upon the Center roller (72) (CR) are illustrated in FIG. 39.

As the rope (79) is fed between the Inner roller (71) (IR) and Outer roller (73) (OR), it generates angles with respect to the horizontal, specified as θ_{IR} and θ_{OR}, respectively. These angles, together with the rope, under tension T, produce horizontal and vertical force components, T_{Hx} and T_{Vx}, respectively, where x is IR or OR. These forces all act upon the Center roller (72). For simplicity, assume the Inner and Outer rollers are horizontally centered and of equal distance from the Center roller. As a result, the horizontal components, T_{HIR}, and T_{HOR} will be of equal magnitude but opposite in direction. Therefore, they will cancel out. The vertical components, T_{VIR} and T_{VOR}, however, are in the same direction, therefore they will add up to a total vertical force of F_{CR}=T_{VIR}+T_{VOR} that is proportional to T.

### 3.2.2 Rollers

The rollers are designed to be straight forward and simple. They comprise bearing retainers (supports roller bearings), bearings, and rollers. Two categories of rollers are used in the ECORD: single and parallel. Within the single roller category, there are two sub types; the Egress Roller and those used as part of the feedback mechanism called Feedback Rollers. These are the rollers indicated as Inner (71), Center (72), and Outer (73) in FIG. 38.

### 3.2.2.1 Feedback Rollers

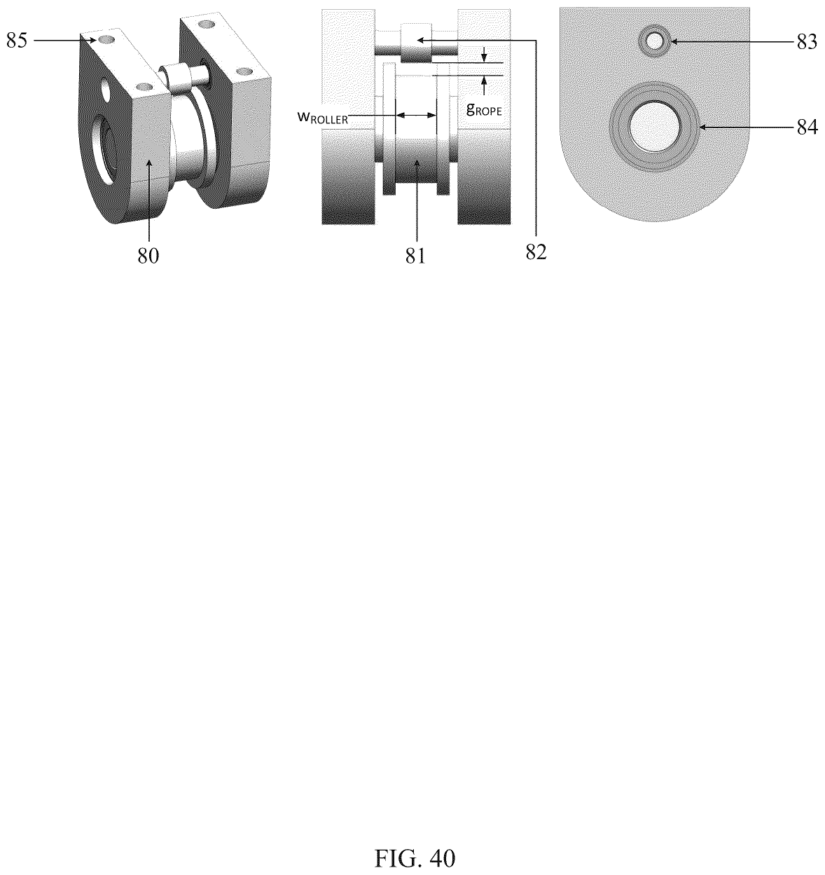

Detailed views of the Feedback Roller are shown in FIG. 40. The Feedback Roller assembly requires two bearing retainers (80), each supporting two bearings (large (84) and small (83)) that can be inserted via clearance, transition or interference fit. Assembly costs can be reduced by inserting the bearing using a clearance fit. There are two types of rollers, large (81) and small (82), that in turn are inserted into the bearings via a clearance fit. The clearances can be of a relatively tight tolerance, like ±1 mil without negligible play or negative impact on the overall performance of the ECORD. The bearing retainer (80) also supports two threaded holes (85), which are used to mount the Feedback Roller assembly onto the Bottom Plate (62) and to the Beam (78) (see section 3.2.3) using flathead screws (64) to minimize h_{ECORD}.

Notice that in FIG. 38 the rope (79) passes between the small (82) and large (81) rollers of the Inner (71) and Outer (73) Feedback Rollers. The large roller (81) has a width indicated as w_{ROLLER} in FIG. 40 that is between two side walls, which help to keep the rope from sliding out over the side during operation. The gap between the small (82) and large (81) rollers is indicated as g_{ROPE} in FIG. 40. This gap is made just wide enough to pass the rope through while pinching the rope (79) to apply some slight amount of pressure to it. This pressure keeps the rope (79) from slacking within the ECORD under the condition that the user has dropped the handle during an exercise routine. If the handle is dropped then there is no external force on the rope (79), therefore no tension on the rope (79). Within the ECORD, however, some amount of tension is still required to apply some slight amount of downward force on the Center roller (72), where the rope-tension measurements are taken. In addition, by keeping the rope (79) taut by way of this pressure, and with the aid of the Rope Retainer of the Spooler (see FIG. 35 (a)), any mis-spooling during normal operation is prevented. To take advantage of the economy of scale, the Inner (71), Center (72), and Outer (73) rollers all use the same Feedback Roller, however, it is not necessary to install the small bearing (83) and the small roller (82) for the Inner (71) Feedback Roller. The small bearing (83) and the small roller (82) of the Outer (73) Feedback Roller may be sufficient in keeping the rope (79) taut. It is best to maintain the pressure on the rope (79) using the Outer (73) Feedback Roller rather than the Inner (71) Feedback Roller. If the pressure is applied at the Inner (71) Feedback Roller, this will prevent mis-spooling, however, this would not result in any downward force applied to the Center (72) roller, because the tension on the rope (79) would only be between the Spooler (59) and the Inner (71) Feedback Roller.

### 3.2.2.2 Parallel Rollers

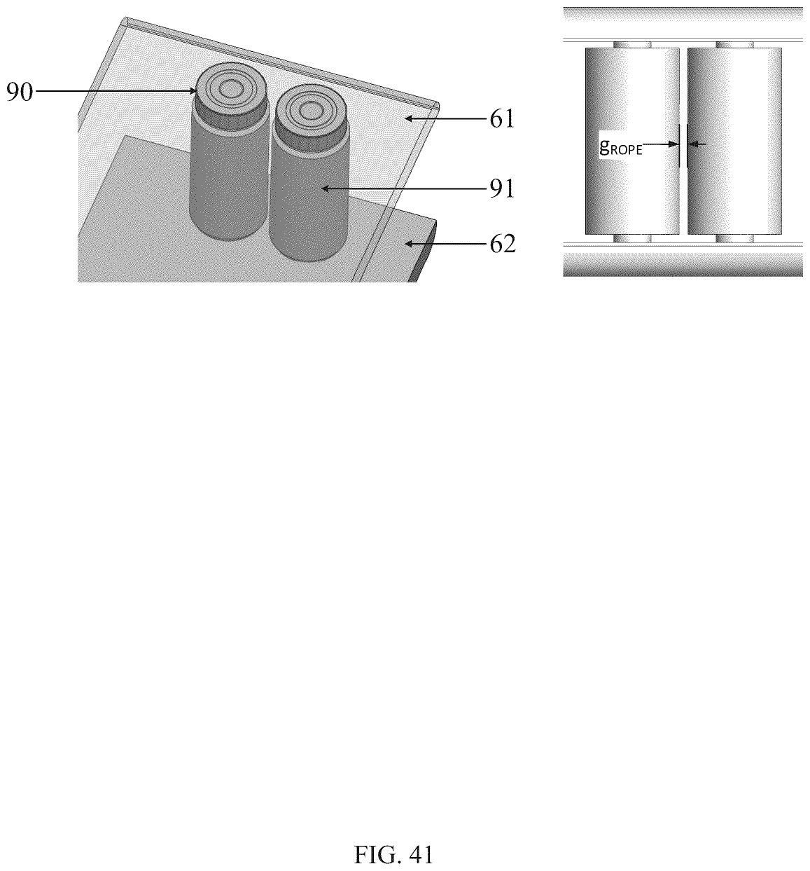

The Parallel Roller assembly is shown in FIG. 41. It comprises two rollers (91) and four bearings (90) that are inserted into the Top Plate (61) and Bottom Plate (62) via clearance, transition, or interference fit. To save assembly cost, the bearings (90) may be inserted via clearance fit using a relatively tight tolerance of 1 mil without negligible play or negative impact on the overall performance of the ECORD. In the figure, the Top Plate (61) is shown as transparent to facilitate viewing of the parallel roller parts.

The Parallel Rollers are yet one other way to keep some amount of pressure on the rope by setting a specific gap for g_{ROPE} shown in FIG. 41. Referring to FIG. 38, the pressure must be applied on the Outer Parallel Rollers (74) to keep the rope (79) taut within the ECORD and to allow a downward force on the Center (72) roller. If the pressure is applied there, then there is no need to install the small bearing (83) and small roller (82) for the Outer (73) Feedback Roller, as that would produce a superfluous function.

### 3.2.2.3 Egress Roller

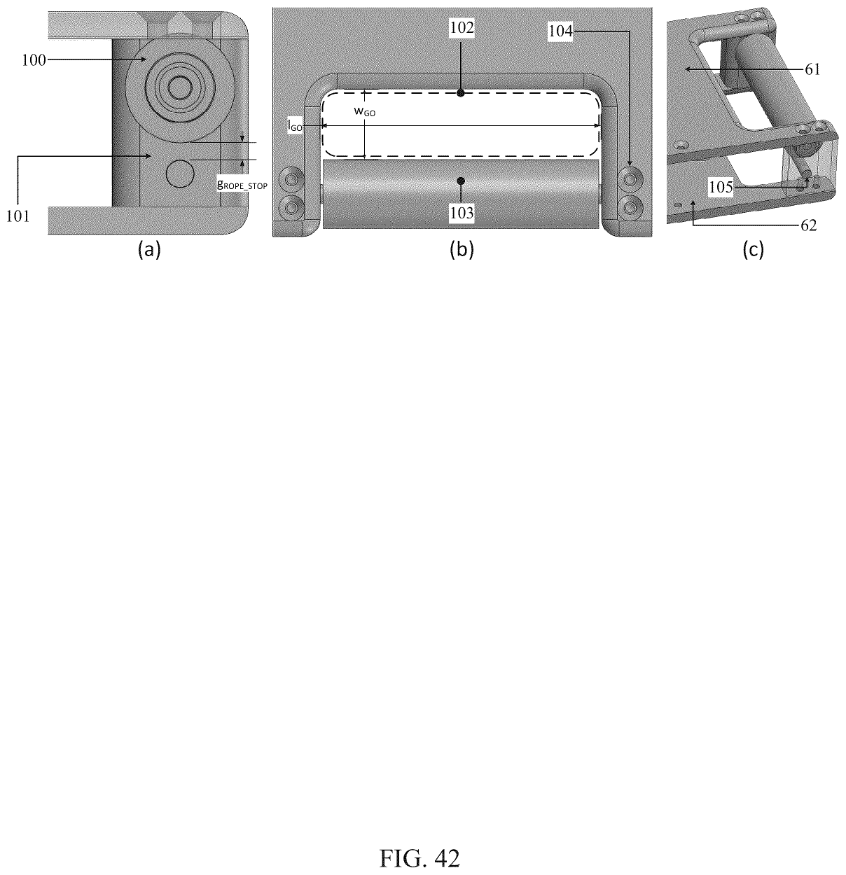

The Egress Roller (75) is shown in FIG. 42. It comprises two bearing retainers (101), one bearing (100) for each retainer, the roller (103) and the Rope Stop pin (105). The retainers are mounted between the Top Plate (61) and Bottom plate (62) using flathead screws (64) to keep h_{ECORD} to a minimum. The roller is also positioned such that its highest point is slightly lower than the top surface of the Top Plate (61) to ensure h_{ECORD} is at a minimum. The gap between the roller (103) and the Rope Stop pin (105), g_{ROPE}_STOP, is specified such that the rope (79) can freely move between the two without any pinching, but the rope clamp that is attached to the end of the rope (79) is too wide to pass through when the rope (79) is spooled all the way back into the motor.

The area marked with a dashed line (102) is completely open when viewing the ECORD from the top. This opening allows the user to pass their fingers through and grip the roller (103)—as if gripping the handle of a suitcase—to facilitate moving the ECORD. This opening has a width w_{GO} of 25.4 mm (1″) and length l_{GO} of 101.6 mm (4″). The wide 25 mm diameter of the Egress Roller (103) along with the large opening (102) make gripping and moving the ECORD around comfortable.

### 3.2.2.4 Rope Span

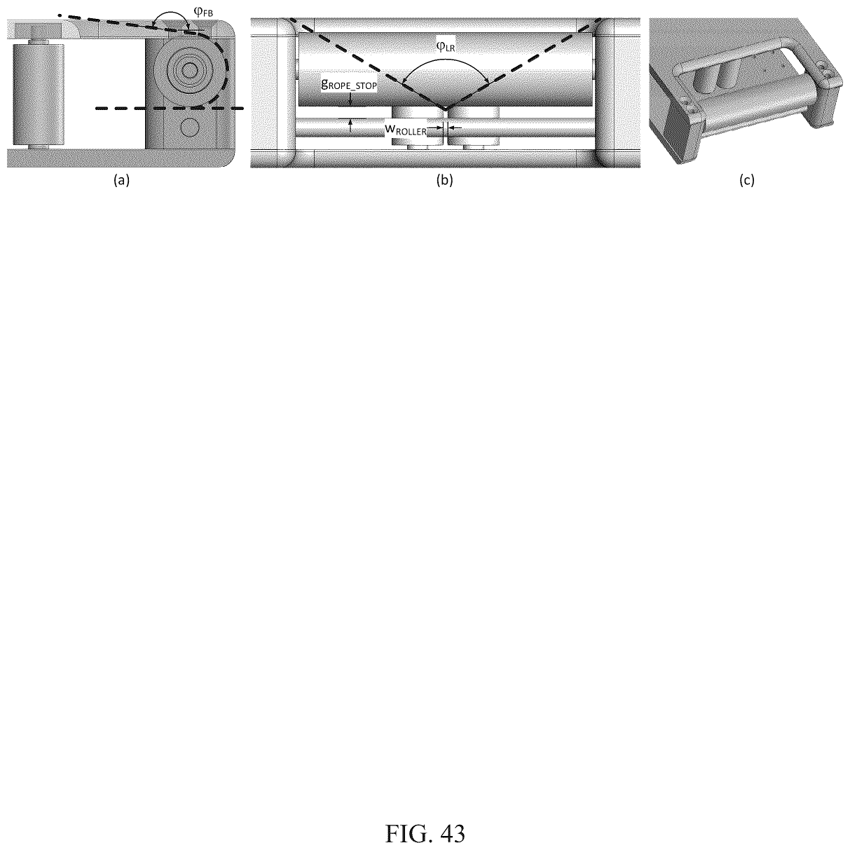

When the rope (79) exits the ECORD, it can span wide angles to allow the user the most amount of versatility in the types of exercises that can be performed. Consider the perspective views shown in FIG. 43.

In figure (a), the rope (79) is shown as a dashed line, indicating that it can exit horizontally and be pulled out by the user towards the front of the ECORD or wrap around the Egress Roller (75) as the user pulls the rope in the direction towards the back of the ECORD, spanning a total front-to-back angle of φ_{FB} of approximately 180°. In figure (b), the rope (79) is once again shown as a dashed line exiting the ECORD between the Outer Parallel Rollers (74) and through the gap g_{ROPE_STOP} and able to span left-to-right at an angle of φ_{LR} of approximately 120°. Figure (c) simply shows a perspective view of the various rollers. Note that the combination of the Egress Roller (75) and the Outer Parallel Rollers (74) act as a sort of fairlead.

### 3.2.3 Feedback System

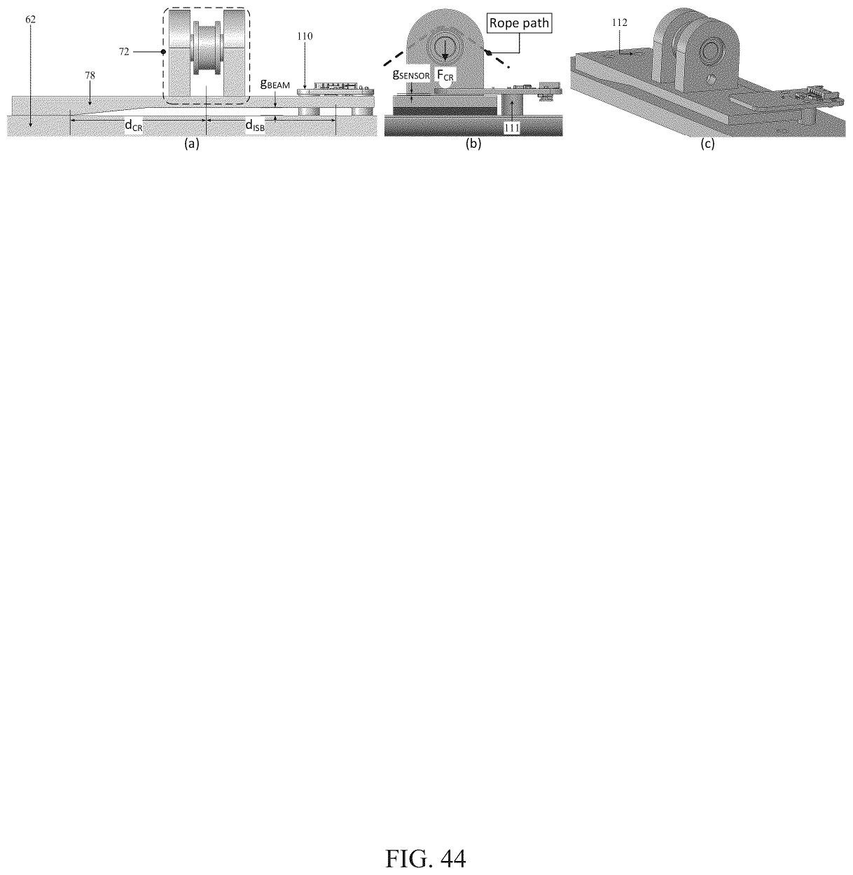

As discussed previously, the tension of the rope (79) generates a force F_{CR} acting on the Center Feedback Roller (72), which is mounted to a cantilevered Beam (78) (made from aluminum or other metal) that flexes as a function of F_{CR}. This is shown in FIG. 44. The thicker end of the Beam (78) is mounted to the Bottom Plate (62), but it tapers into a thinner section that remains cantilevered with a gap g_{BEAM} between the bottom surface of the Beam (78) and the top surface of the Bottom Plate (62). The Center Feedback Roller (72) is d_{CR} distance away from the mounted end, sitting approximately in the middle of the Beam (78). On the opposite end of the Beam (78), a distance of d_{ISB} away from the Center Feedback Roller (72), is the Inductance Sensor Board (110) (ISB), mounted just above the Beam (78), such that there is a gap g_{SENSOR} between the bottom surface of the ISB (110) and the top surface of the Beam (78). The ISB (110) contains a commercial inductance-to-digital converter (LDC) integrated-circuit (IC) coupled to a spiral-routed multi-layer inductor that is designed right into the printed circuit board using copper tracks. The proximity of a metal object changes the properties of this inductor, such as its inductance and impedance, which the IC is able to measure. These properties are a function of several parameters, including the geometric properties of the inductor, the metal composition of the object, distance to this object, and the value of the capacitor that is placed in parallel to the inductor, forming a resonant tank.

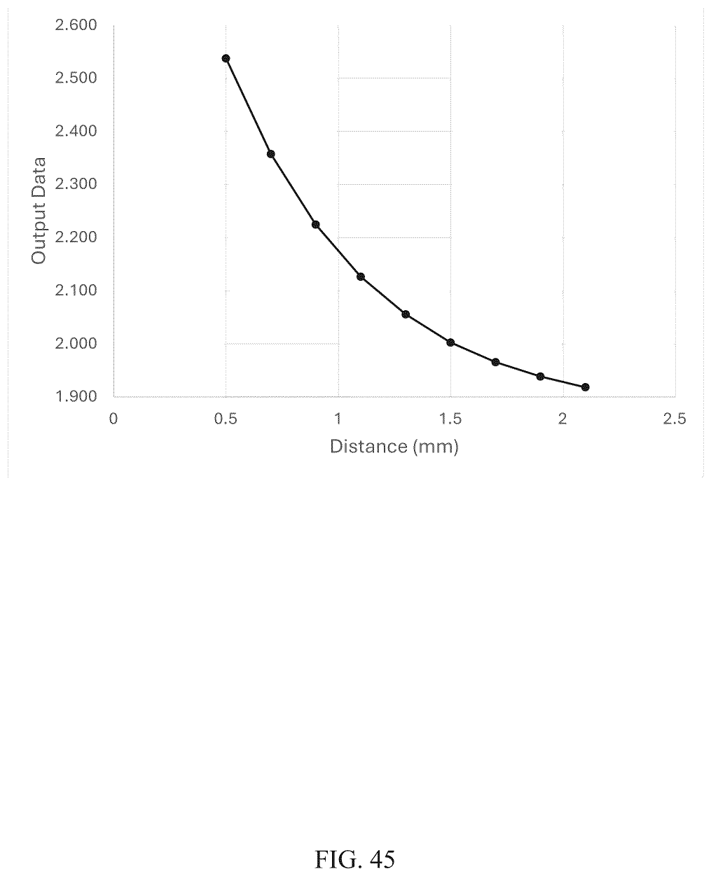

The constant spooling in/out of the rope (79) causes variations in the force F_{CR} and hence, the flexing of the Beam (78). If the Beam (78) is not designed carefully, over time its performance can degrade due to reaching the Beam material's fatigue strength, which can result in plastic deformation, significantly worsening the performance of the ECORD feedback system. The geometric dimensions and metal material used for the ECORD Beam (78) (Aluminum 7075-T6) were selected based on results obtained from computer stress-simulations. Even though g_{SENSOR} is a linear function of T, the measured data of the LDC IC is not. It relates to g_{SENSOR} in a polynomial fashion. An example is shown in FIG. 45.

As can be seen, the output data is not a straight line and changes like a polynomial. The best curve-fit equation shows this data to be a polynomial of 4th power. Turns out the LDC IC is most sensitive to metal objects at close distances, as can be seen by the steeper slope at smaller distances. This works to the advantage of the ECORD. The larger output data values correspond to smaller distances, producing more sensitivity at lower tensions where it is needed the most. The ECORD is not a 100% efficient system and possesses some level of mechanical losses due to friction. This friction is a greater source of error when the rope tension is low due to being a larger fraction of that tension, which the ECORD is to maintain throughout an exercise routine. The polynomial nature of the output data in conjunction with the higher SNR of the high-resolution output data produces a greater level of sensitivity that will help improve the performance of the ECORD at low tension settings. As the tension is increased the output data sensitivity is somewhat decreased, however, at greater tensions the frictional forces become a much smaller fraction of that tension, hence a much smaller source of error that the feedback system is to overcome to maintain the desired tension.

There are several advantages to this method of approach in measuring the rope tension. 1) This is an extremely low-cost solution. Usually, load cells are used to measure force, but they can be expensive and require the design of a low-noise analog circuit to amplify the signal. Additional circuitry is required to convert this signal to a digital form for processing. With the approach used here, the analog front-end and digital conversion is done on the IC. The beam itself can be as simple as an aluminum rectangle with two threaded holes for mounting to a spacer that is mounted to the Bottom Plate (62). The ISB is also a low-cost board since it requires very few components and does not need to be more than 4 layers. It may be possible to design a 2-layer version for additional cost reduction. All other fastening components are readily available and very low cost. 2) The rope tension is measured without the need for the user to stand on the ECORD. In other words, there is no requirement to apply a downward force to the ECORD in order to measure the tension as some other inventions require.

In order to map the measured displacement to the physical tension or weight, this mapping needs to be generated. This can be done experimentally with the aid of discrete known weights that span the weight range of the ECORD. For example, weights in 5 lb. increments, can be attached and hung from the ECORD one at a time while the displacement is measured. The results are then plotted and curve-fitted to generate an equation for the curve. This “calibration” equation is used by the Controller Board to determine the weight based on the measured displacement. If the ECORD is mass-produced, each device will require its own calibration equation. If the same equation is used across all ECORDs, there will be some amount of error due to variations in manufacturing and assembly. However, this error may still be acceptable. One way to reduce this error is by specifying tighter manufacturing and assembly tolerances. Although this slightly adds to the overall cost, there will be savings in not having to generate the calibration equation for each individual ECORD.

### 3.2.4 Feedback Control Algorithm

The main Controller Board uses the measured data and the user-specified weight to command the motor torque required to maintain the specified tension on the rope. This is done through a simple Proportional-Integral-Derivative or PID algorithm. The PID algorithm takes the error signal, which is the difference between the measured tension and the user-specified tension (or weight) and applies a correction to the commanded motor current based on the PID gains. The current of a motor is proportional to the torque, therefore controlling the current allows the torque to be controlled.

This feedback system is necessary in order to compensate for various system dynamics during operation. One of them is the variation in the rope exit radius from the spooler (see section 2.5). Another would be the various sources of friction in the system. Another dynamic would be during operation as the user is pulling on the rope, say during a concentric phase of an exercise like a bicep curl then letting it down during the eccentric phase. During the eccentric phase, the user is allowing the motor to spool the rope (79) back, therefore there will be less tension on the rope. The PID algorithm compensates to allow the tension to be maintained during both phases of the exercise.

### 3.3 Assembly

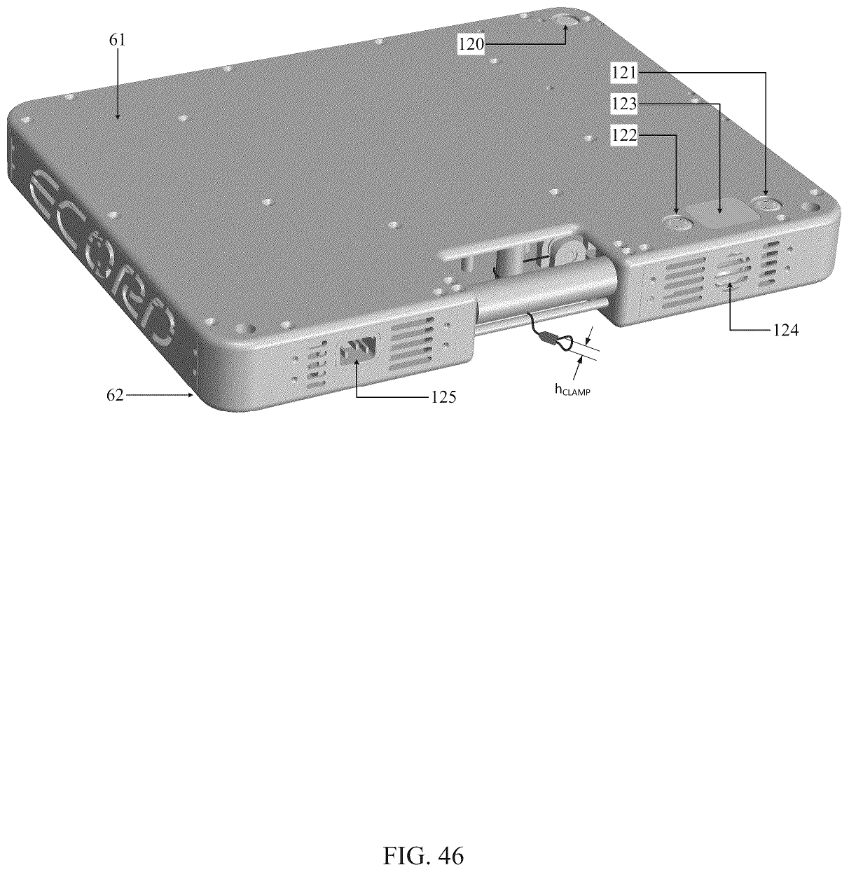

The external assembly of the ECORD is shown in FIG. 46. The device is powered using a standard wall outlet plugged into the Power Plug (125) and activated using the Power Button (120). The user interfaces with the device using the Display (123) and the Left (121) and Right (122) Buttons. A Speaker (124) is also included for audio feedback. For example, button presses can be followed up immediately with some sort of audio sound for press-confirmation. Also, any remote commands sent via the app (see section 5.2) or remote (see section 6.2) can be followed by some sort of audio feedback. All of the electronics and motor are mounted between the Top (61) and Bottom (62) Plates.

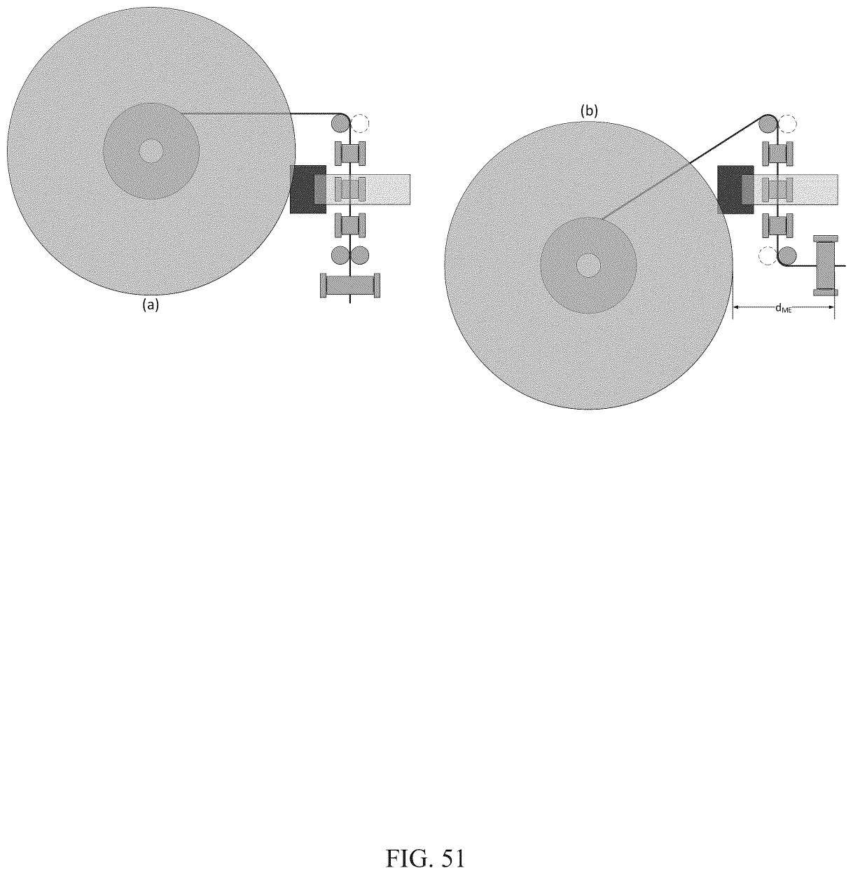

A representation of the rope and the rope clamp are also shown. In this particular case the Outer Parallel Rollers (74) are not fully installed since only one roller is needed (see FIG. 51). The rope (79) is fed through the Egress Roller (75) and the Rope Stop pin (105), while the thickness of the clamp, h_{CLAMP} is too wide to pass through that gap. A loop is provided on the other end of the clamp to allow the user to attach a variety of commercial handles, bars, straps, etc. to perform an exercise.

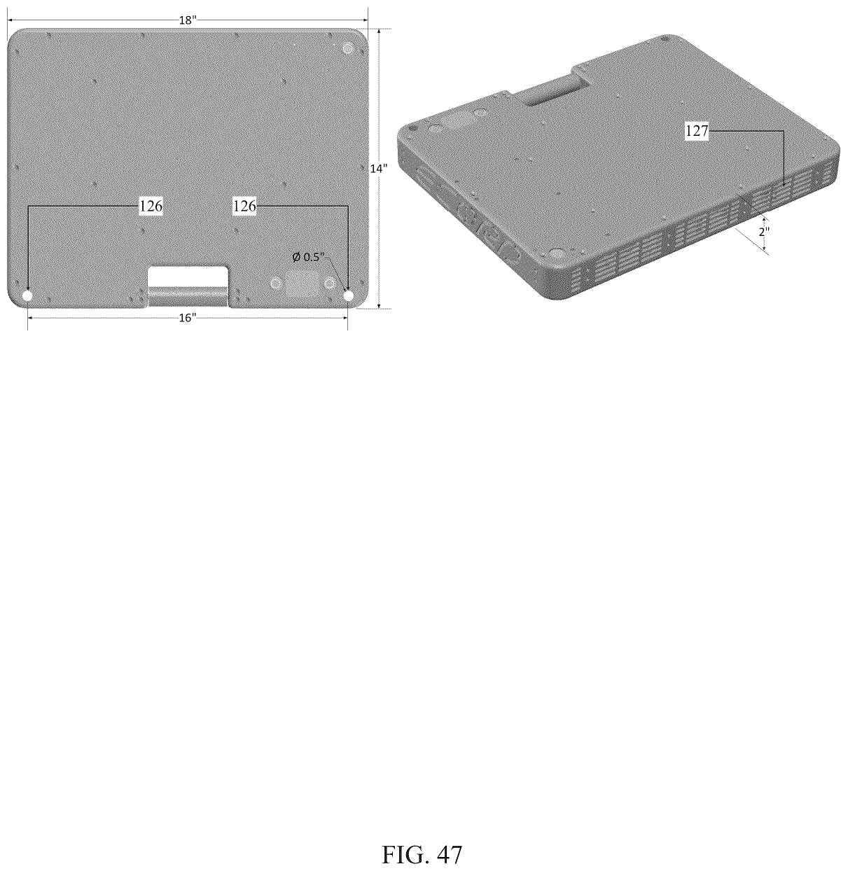

The outer dimensions of the ECORD are 18″×14″×2″, as shown in FIG. 47. The compact height of the ECORD allows it to be easily stored out of sight when not used. Referring to FIG. 46 and FIG. 47, a number of slits or cutouts (127) are visible along the walls in front of the device as well as in the back. There are also cutouts (127) along both sides that form the name of the device “ECORD.” The function of these slits is to allow air flow within the device during operation. Internally there are three fans that circulate the air to cool the motor and electronics. These cutouts (127) facilitate the cooling function.

As shown, there are two 0.5″ diameter through holes (126), 16″ apart, that allow the ECORD to be mounted to a wall. See section 6.1 for the various anchoring schemes. Note that the back wall of the ECORD is flat, allowing it to be stood up vertically without tipping over. This allows it to be easily stored away in the vertical position when not in use. A second function is to stand it up against a wall for certain types of exercises (see section 7) without the need to install it on that wall using the anchor bolts. For the vast majority of the exercises, however, the user must stand or apply a downward pressure on the Top Plate (61) of the ECORD. To prevent accidental pressing of any of the buttons or applying pressure to the display glass, all buttons and the display glass are recessed from the top surface of the Top Plate (61).

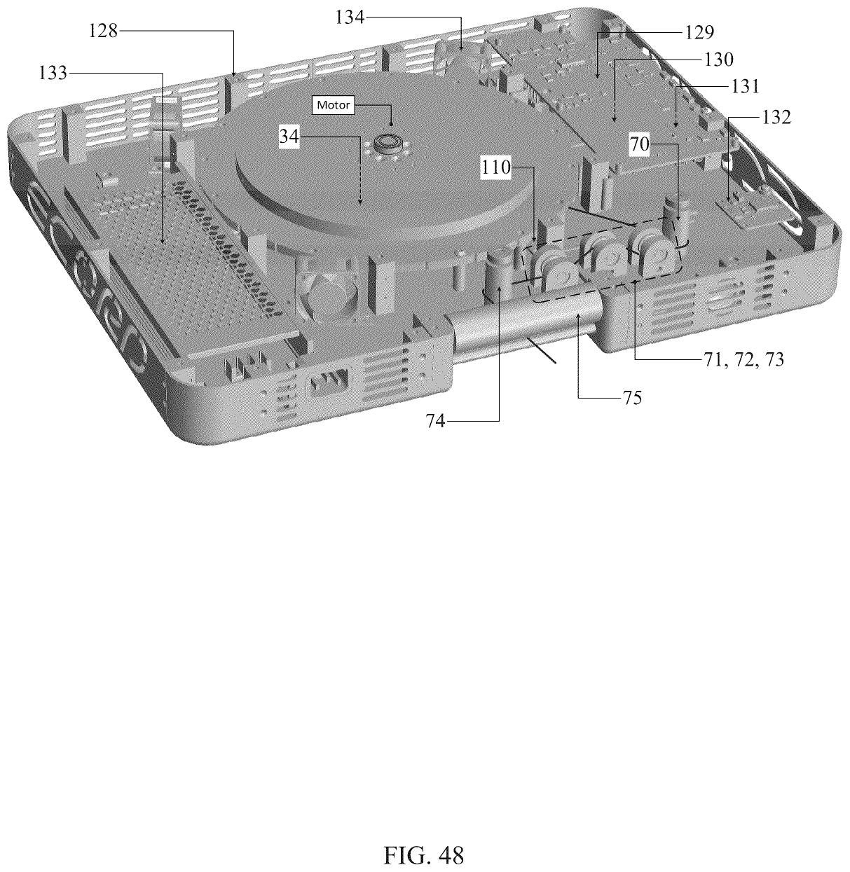

The internal layout of the ECORD is shown in FIG. 48 with the Top Plate (61) removed. The Top Plate (61) and Bottom Plate (62) are 0.25″ thick each, therefore leaving 1.5″ of space between the two to fit all of the components. With the exception of the Display (123), the Power Button (120), and the Left (121) and Right (122) Buttons, all other components are mounted to the Bottom Plate (62), facilitating the assembly of the ECORD. There are 20 square threaded standoffs (128) between the two plates (61 and 62), with 8 all around the motor, for compressive support. Computer stress-simulations show a deflection of 0.25 mm if a 300 lb. person stood on one foot on the center of the Top Plate (61) while pulling on the rope (79) with the maximum tension of 100 lb. as provided by the ECORD.

Note that the walls do not bear any load and are simply screwed onto the square standoffs (128). They can be fabricated using sheet metal or 3D printed for a low-cost, albeit not as aesthetically pleasing solution. Alternatively, the walls and the standoffs (128) can be combined with the Bottom Plate (62) and fabricated out of a single aluminum block. This would eliminate many screws and simplify the assembly process, but the fabrication cost would be significant.

In a typical application where bearings are used, they are sized to withstand a certain amount of static and dynamic radial load. This is usually the case with motors. Any load applied to a bearing in the axial direction must be significantly less than its radial limit, otherwise the bearing will be damaged. There are “thrust” type bearings that can withstand a strong force in the axial direction, however, these types of bearings are more expensive and not as prevalent. For this reason, the ECORD does not use thrust bearings. As described in the previous paragraph, a large amount of load applied to the Top Plate (61) will transfer a significant amount of axial force to the motor bearings as the Top Plate (61) deforms. Two steps are taken in the ECORD design to alleviate this axial load from the bearings: 1) A certain amount of headroom is made available to the top bearing (66) of the motor, and 2) the motor is fixed to the Bottom Plate (62). The latter is achieved by pressing the bottom bearing (67) into the Bottom Plate (62) via an interference fit and the shaft (4) inserted into that bearing (67) with a clearance fit but adhered to it via a strong adhesive (or the opposite, that is, the bearing (67) is inserted into the shaft (4) via an interference fit and then fitted into the Bottom Plate (62) via a clearance fit but adhered to it).

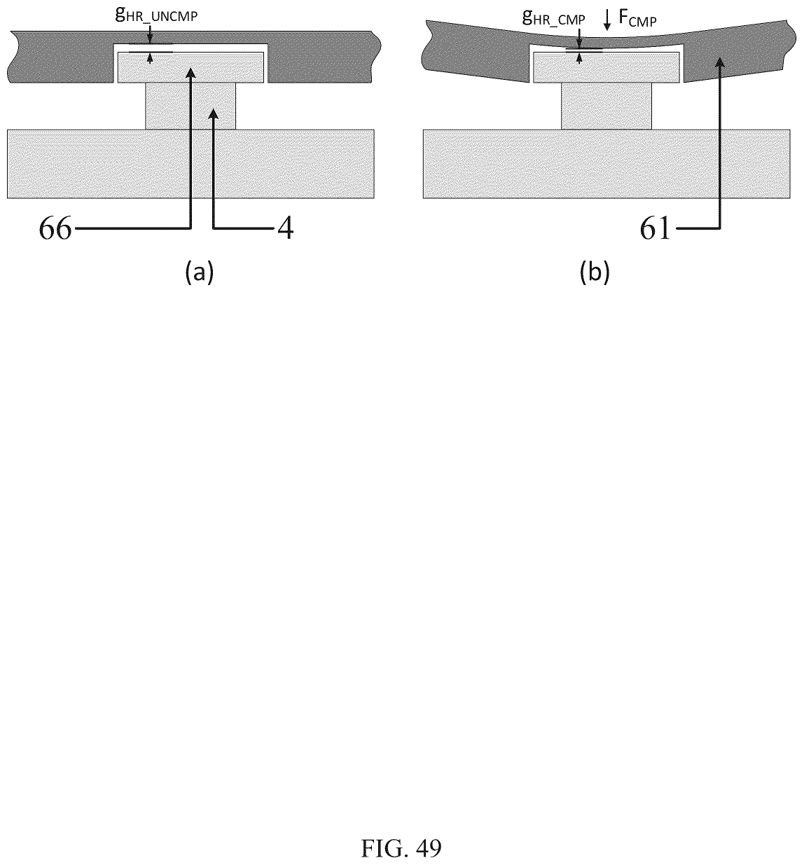

These steps perform two functions. If the ECORD is placed onto the floor and a large compressive force is applied to the Top Plate (61), the headroom made available to the top bearing (66) of the motor will decrease as the Top Plate (61) deforms, but it will not make contact with the top bearing (66), therefore it will not transfer any axial force to it. This is shown in FIG. 49. The figure is not to scale and exaggerated for clarity, but it shows that the amount of headroom available, g_{HR_UNCMP}, decreases to g_{HR_CMP} when there is a compressive force applied to the Top Plate (61), F_{CMP}, but does not make contact with the Top Bearing (66) to transfer any axial force to it.

The interference fit and the adhesive used, fix the motor to the Bottom Plate (61) to prevent any axial play given that there is a bit of headroom made available to the top bearing (66). This is important because any amount of axial play may cause the motor to come into contact with the PCB stator stack, which is fixed to the Bottom Plate (62).

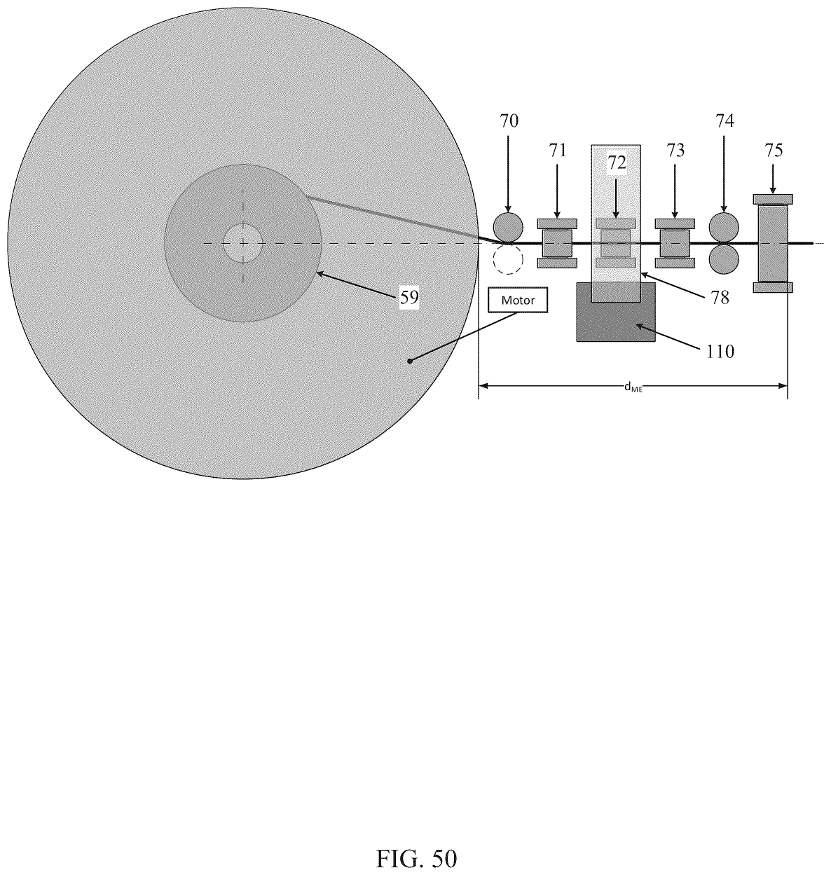

One example of the internal assembly of the ECORD, comprising the motor and the Rope Management System is shown in the FIG. 50 as viewed from the top, through the Top Plate (61).

As discussed, the Inner (70) and Outer (74) Parallel Rollers help to set the rope (79) centered along the Inner-(71), Center-(72), and Outer-(73) Feedback Rollers regardless of the angle of the rope (79) coming off the Spooler (59) and leaving the Egress Roller (75) (see FIG. 43). Notice that as the rope (79) exits the Egress Roller (75) it is perfectly lined up with the indicated centerline. Under this circumstance there is no need to install one of the rollers of the Inner Parallel Roller (70), which is shown as the dashed white circle. This is because as the rope (79) exists the Spooler (59), it is only ever contacting the installed roller of the Inner Parallel Rollers (70). Both rollers of the Outer Parallel Roller (74) are needed, however, to ensure the rope (79) stays centered. The distance from the motor to the Egress Roller (75) is indicated as d_{ME}. Two alternative examples that produce a more compact layout are shown in the FIG. 51.

In example (a) the entire Rope Management System has been rotate by 90 degrees, reducing d_{ME} and eliminating one of the rollers of the Inner Parallel Rollers (70) but positioning the Egress roller (75) down. In example (b), the same orientation as (a) is used, except, the assembly has been shifted up and the Egress Roller (75) rotated by 90 degrees so that it is facing in the same direction as in FIG. 50. Figure (b) also achieves a reduced d_{ME} but also requires only one roller from both the Inner (70) and Outer (74) Parallel Rollers. Notice that the ISB (110) is partially under the Bottom backiron (12) of the motor to achieve a more compact arrangement. The disadvantage of the arrangement shown in (b) is that more rope (79) is used internally.

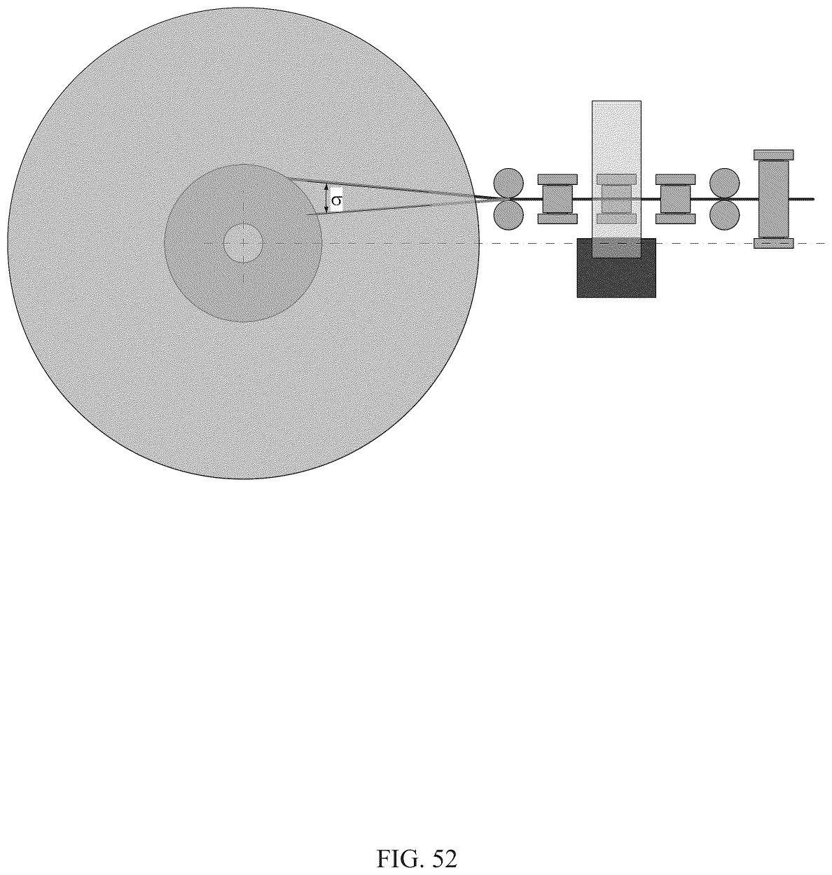

If the Rope Management System is off-center from the motor, as illustrated in FIG. 52, then both rollers of the Inner Parallel Roller (70) will be needed due to the changing radius of the rope (79) as it comes off the spooler (59) (see FIG. 32). The angle σ indicates the range the rope (79) will span as it is being spooled in and out. As shown, both rollers will be needed to keep the rope centered along the Feedback Rollers.

The ECORD is designed to provide up to 100 lb. of tension. As such, the bearings and the roller support structures are designed to support forces greater than 3× this maximum amount. The rope itself is rated just north of 1000 lb.

### 4 ELECTRONICS

The ECORD is an electromechanical device, therefore it requires electronics to power and drive it. There are several electronic components within the ECORD: The power supply (133), the Controller Board (129), the ISB (110), a couple of wireless modules (RF transceiver (131) and Bluetooth Module (132)) and several fans (134). These will be discussed in this section.

### 4.1 Power Supply

The ECORD uses an internal AC/DC power supply (133) to provide the main power to the system. The AC/DC module accepts AC as the input power, as supplied through a standard wall plug (125), and converts it to DC power for distribution to the various electronics. The AC/DC module is appropriately sized to deliver the maximum amount of power required by the ECORD, which occurs at the highest weight setting that the ECORD can support. The AC/DC power supply may be framed or frameless. The frame primarily protects the user from accidental shocks but can also be water resistant in case of accidental spillage. If a frameless AC/DC power supply is to be used, it will be placed within a custom water-resistant frame between the Top (61) and Bottom (62) Plates. A standard 3-contact power cord is used to attach the ECORD to the wall socket.

There are several similar inventions that use batteries as the main power source. Exercise machines, such as the ECORD, demand a lot of current from the power source, which is highly dependent upon the resistance setting. The higher the resistance setting, the greater the power demand. An exercise device would size its batteries as large as needed and no larger because batteries are expensive and heavy. This means that when the device is used throughout an exercise session, there is a very good chance that the battery would be almost completely depleted, therefore requiring a full charge. If the device is used several times a week, then the battery will have undergone several deep charge/discharge cycles, which is exactly the kind of charging cycle that diminishes the battery capacity more rapidly over time. In addition, as the user maintains a consistent exercise regiment, then he/she should get stronger over time, therefore demanding greater resistance from the device. So, as the battery capacity is diminishing over time, the resistance setting from the user is increasing over time, demanding greater power from a diminishing battery capacity. These are conflicting properties, resulting in the device not being able to last the required amount of time for a given session, cutting the workout very short. The remedy is to change the battery, which may or may not be possible depending on the design of the device. If the battery can be replaced, each time it is, there would be an associated cost to the user.

This is not an issue for the ECORD since it is powered from the grid. There is no diminishing power source, and the power supply can be sized well over what is needed without much additional weight or size.

### 4.2 Controller Board

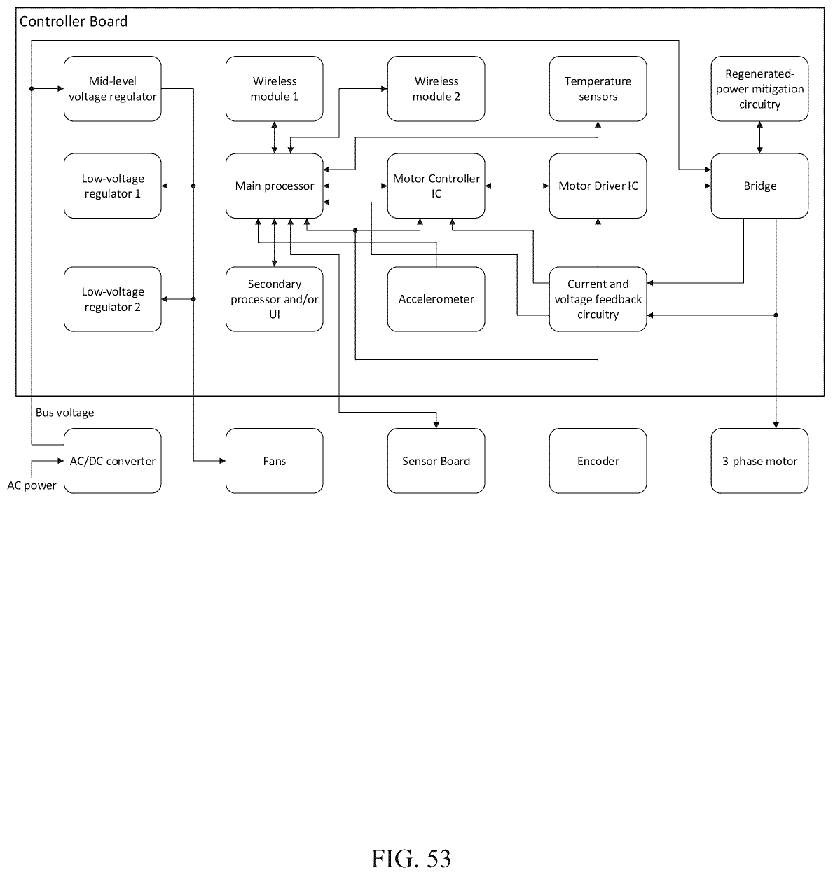

The general electronics system of the ECORD is illustrated in the FIG. 53. The heart of the electronics system is the Controller Board (129). There are a number of external modules that all interface to the Controller Board.

### 4.2.1 Power Regulation

As mentioned in section 4.1, the ECORD is powered via an AC/DC converter (133), which supplies DC power to the mid-level voltage regulator as well as the bridge. The output voltage of the AC/DC converter, which can be in the range of 30V-100V, is the motor voltage, indicated as bus voltage in FIG. 53.

The mid-level voltage regulator supplies power to downstream low-voltage regulators as well as the fans (134). Depending on the fan, however, it may instead be powered via one of the low-voltage regulators. All other electronics are powered by one of the two low-voltage regulators. Typically, these regulators supply 5V and 3.3V to the system, but they can be configured to supply other voltage levels as well, depending on the requirements.

### 4.2.2 Bridge

The bridge is the interface between the Controller Board (129) and the 3-phase ECORD motor. The term bridge is used as a general description. Typically, they are called 3-phase bridge inverters since they transform DC (from AC/DC supply) into three-phase trapezoidal or three-phase AC power used by a three-phase motor. The Bridge is constructed from 6 transistors, using either MOSFETs, IGBTs, SiCs or GaN technology. The selection depends on voltage, efficiency, and switching speed requirements. It is possible for the transistors to get very hot, which is why they are heatsinked to the Top Plate (61) by using a standard thermal compound.

The Bridge is driven by the Motor Driver IC, which drives the gate of the 6 transistors via pulse-width modulated (PWM) signaling. The Motor Driver IC may receive some feedback signals from the Current and Voltage feedback circuitry so that it can act very quickly in case of catastrophic failures.

### 4.2.3 Feedback Circuitry

The Current and Voltage feedback circuitry senses the Bridge voltage and the currents in two or all three of the phases. This is typically done in the analog domain and the analog signals are fed back to the Motor Controller IC. These signals are optionally provided to the Motor Driver IC and the Main processor.

The Motor Controller IC supplies the PWM signals that drive the Motor Driver IC. These PWM signals are generated based on the feedback signals (discussed above), the selected control scheme (e.g., velocity or torque control), and the commanded velocity or torque as supplied by the Main Processor. The Motor Controller IC contains the actual motor-controller algorithm and provides a configuration interface that allows it to be configured based upon the application needs. The ECORD uses torque (current) control with sinusoidal motor commutation for the smoothest operation.

### 4.2.4 Main Processor

The Main Processor (MP) executes the general code of the system. This will be discussed in detail in 5.1. It is in charge of communicating with all of the peripheral modules, like the two wireless modules (131 and 132), ISB (110), Accelerometer, Motor Controller IC, and to the Secondary Processor if it exists.

### 4.2.5 Secondary Processor/UI

The Secondary Processor (SP) can be used to interface and manage the UI in order to offload that code from the MP. Depending on the type of UI used, this code may be simple or complex. In either case, the MP and the SP communicate with each other over a simple interface, like logic-level serial. The MP, for example, can communicate the user-selected weight to the SP, which displays this information over the UI.

If the MP has sufficient processing capabilities after all main functions are considered, then it can handle the UI without a requirement for an SP.

The UI is designed to provide basic level information to the user, indicating:
It is busy initializing after power-on
Spooling the rope to get the system ready.
The selected weight
Any system failure

The display (123) can be as simple as three 7-segment LED units, arranged to indicate the user-selected weight in xx.y format, where xx is between 0 to 99 and γ is between 0 to 9. Together, the weight can be displayed in pounds, with a resolution of 0.1 pound. Two or more pushbuttons are required to allow the user to increase and decrease weight. Alternatively, a toggle switch can be used to increase the weight if pressed one way and decrease the weight if pressed the other. A third pushbutton can be used to change the increment/decrement resolution, say from 0.1 pound to 1 pound to help speed up the incrementing and decrementing of the weight. Additional LEDs may be added to the UI to indicate information such as what increment/decrement resolution is currently in use. For example, if the LED is on, then the resolution is 1 pound, and if off, it is 0.1 pound.

The 7-segment displays can be used to display a specific pattern of lights that convey a message to the user. For example, the individual LEDs can be lit in a circular pattern to indicate the system is busy.

On the other end of the spectrum of possibilities for the UI lies a high-resolution touchscreen display. Such a display can convey rich information to the user and would eliminate the requirement for discrete pushbuttons or switches but adds to the complexity of the code required to interface to the UI. It is also more expensive as compared to the 7-segment displays and pushbuttons.

### 4.2.6 Accelerometer

A 3-axis accelerometer is integrated onto the Controller Board (129) and its primary role is for the safety of the ECORD operation. The ECORD is required to be anchored in order for the user to be able to pull out the rope. The various anchoring schemes are discussed in 6.1. If during operation the anchoring is compromised (e.g., the user steps off the ECORD by accident) while the user is actively pulling on the rope and depending on the selected weight, it can cause the ECORD to fly off towards the user. This can potentially lead to injury. Under this condition, the ECORD will undergo a sudden acceleration. The MP obtains the accelerometer data at the loop rate (discussed in 5.1) and if the acceleration is above a normal acceptable limit, the MP will immediately set the resistance to zero. It will also turn off the Motor Controller and Motor Driver, thereby preventing the ECORD from accelerating towards the user.

The secondary role of the accelerometer is to invert the UI display if necessary. The ECORD can be placed on the floor or mounted to the wall. Depending on how it is oriented, the information on the display will need to be displayed right-side up. The orientation of the ECORD is sensed and the information of the display inverted, if necessary, in order to show it right-side up to the user.

### 4.2.7 Temperature Sensors

The ECORD monitors the temperature of various sections of the circuitry, in particular, the Bridge transistors. These transistors increase in temperature with greater power demand from the user. If they reach a critically high temperature level an overtemperature condition will be triggered. This is discussed in detail in section 5.1.

### 4.2.8 Regenerated Power-Mitigation Circuitry

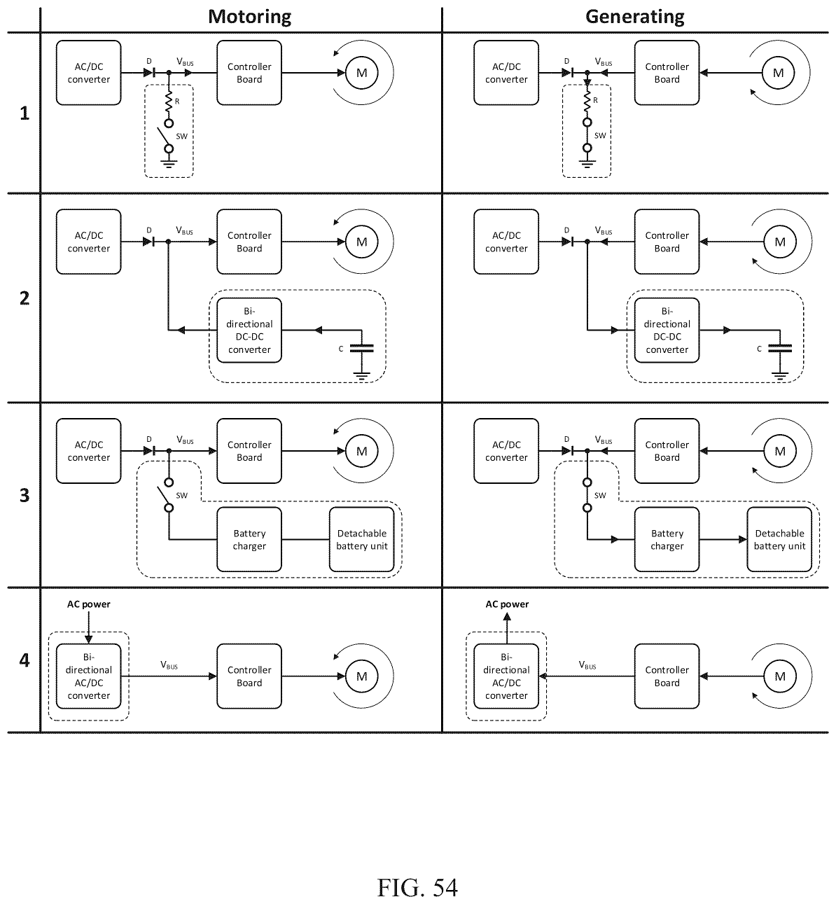

It is well known that motors can also operate as generators when external mechanical input is provided to the motor. In the ECORD this occurs when the user's movement results in the rope being spooled out, for example, during the concentric phase of a bicep curl. During this phase, the motor is attempting to spool the rope in, but the user is forcing the motor to spin in the opposite direction, thereby providing mechanical input energy to the ECORD. This mechanical energy is converted into electrical energy by the motor, which must be used or stored. If no provisions are made to store it or use it, then it will be stored into the output capacitor of the AC/DC converter, which typically is not very large. Given this minimal amount of capacitance, the energy will cause its voltage to increase. If this voltage is left unchecked, it can continue to rise, ultimately resulting in catastrophic failure of the electronics system. The purpose of the Regenerated-Power Mitigation circuitry is to ensure the generated energy is utilized in order to keep the bus voltage at a safe level. Several mitigation methods may be used, each of which are illustrated in FIG. 54.

During an exercise routine, the motor is in one of three states: motoring (spools rope in when user force is less than motor force), generating (when user force is greater than motor force), or stalling (user force is equal to motor force). When stalling, the motor winding resistance consumes all the energy, generating heat and no motion. Stalling does not result in an increase in bus voltage but can be damaging to the motor depending on the amount of heat generated. When motoring, energy flows from the AC/DC converter to the Controller Board and to the motor, which is consuming electrical energy, part of which turns into heat due to the winding resistance and the remainder producing motion. When generating, electrical energy flows from the motor back to the electronics but part of that energy turns into heat due to the motor winding resistance. Electrical current flow is indicated by arrows in FIG. 54. The various mitigation approaches are outlined in dashed lines.

Method 1 is the simplest mitigation approach and the method used in the ECORD prototype, indicated as the Power Dissipation Board (130) in FIG. 48. A simple, high-power resistor R is connected to V_{BUS} and to a solid-state switch (SW), which is connected to ground. During the motoring phase, the resistor is disconnected from ground. However, during the generating phase, the switch closes, allowing a path to ground for the current through the resistor. The voltage on V_{BUS} is sensed continuously in order to determine when the switch should close and open. When motoring, V_{BUS} is relatively constant, but when generating, it increases. This increase is sensed and triggers the closing of the switch. Hysteresis is added to mitigate noise on V_{BUS}. Without it the switch may rapidly close and open. When the switch closes, the resistor connects to ground and presents a load to the increasing V_{BUS}, which begins to decrease as a result of dissipating energy into the resistor. When V_{BUS} drops below the lower threshold level of the hysteresis, the switch opens. At this point, the motor may still be in the generating phase, resulting in an increase in V_{BUS}. When V_{BUS} increases above the upper hysteresis threshold, the switch closes once again, allowing the power generated by the motor to dissipate into the resistor and causing V_{BUS} to decrease. This cycle continues until the generating phase ends.

Note that R may be composed of several power resistors in parallel. Furthermore, when the switch must be in the closed position, it may be rapidly opening and closing based on a PWM signal. PWMing the switch allows modulating the amount of current the resistor is to dissipate.

It is important to ensure that no power flows into the AC/DC converter during the generating phase. This is accomplished with the aid of a diode, D. The diode is reverse biased during the generating phase, preventing any current from flowing into the AC/DC converter. An alternative to using a diode, which is not very efficient, is to use a transistor, like a MOSFET. A MOSFET can be used as a very efficient sold-state switch. It opens during the generating phase to prevent current from flowing into the AC/DC converter and closes during the motoring phase to allow the AC/DC converter to supply power.

Although method 1 is simple, all the generated energy turns into heat. There are other, more efficient ways to make use of the generated energy, as in Method 2. In this method, a bi-directional DC-DC converter is used to charge a bank of capacitors or a large supercapacitor, C. A bi-directional DC-DC converter allows power to flow in either direction. For example, power from a high-voltage source can be stepped down into a low-voltage source. If something on the low-voltage side can produce power, then power can be made to flow in the opposite direction. A bi-directional DC-DC converter may also provide regulated current as opposed to regulated voltage. This is what is used in method 2. When V_{BUS} increases due to generated power, the DC-DC converter turns on and supplies regulated, constant current to C. Charging a capacitor with a constant-current results in a linear increase in the capacitor voltage. Consequently, during the charging phase of the capacitor a load is presented to V_{BUS}, causing its voltage to drop. When it drops below the lower hysteresis threshold, charging ceases. Charging may begin again if the motor is still generating. This cycle will continue until the generating phase ends.

A minimum capacitor voltage is required in order for the bi-directional DC-DC converter to be able to transfer power from the capacitor to V_{BUS}. When this condition is met and the system is in the motoring phase, the capacitor is discharged, and its power transferred to V_{BUS}. This will allow the system to be fully or partially powered by the power transferred from C. The AC/DC will supply any residual power required in order to keep the system running. When C is fully depleted, the AC/DC will take over and fully supply the required power. Just as in method 1, no current may flow into the AC/DC converter, necessitating the use of a current-blocking diode or MOSFET.

In method 3, the energy produced during the generating phase is transferred to a removable battery pack. This is accomplished by sensing V_{BUS} as in methods 1 and 2 and closing the switch SW to allow power to flow into the battery charger, which in turn will charge the battery pack. When the battery is being charged, it presents a load to V_{BUS}, dropping its voltage similar to that described for methods 1 and 2. The charging ceases when V_{BUS} drops below the lower hysteresis threshold level. During the motoring phase the switch is open to prevent the AC/DC converter from charging the battery pack. As before, a current-blocking diode or MOSFET is required.

Instead of a battery pack, a USB port may be made available to allow a smartphone or tablet to be plugged into the ECORD to be charged in this manner. One disadvantage of this system is that when the battery pack or device is fully charged, it can no longer be presented as a load for the generated power. As a result, V_{BUS} can rise to dangerous levels. To mitigate this, method 3 can be combined with method 1 so that when a battery is fully charged, the system will switch to using method 1 to mitigate the generated energy.

The fourth and the most elegant method is to use a bi-directional AC/DC converter, which supplies power to the motor during motoring and sources power to the grid during generation. The bi-directional AC/DC block of FIG. 53 may contain a bi-directional DC/DC converter if necessary. The advantage of this approach is the generated power is directly fed back into the grid and that the total efficiency is likely higher than, say method 2. The disadvantage is that the design of the bi-direction AC/DC converter is not trivial.

### 4.3 Inductive Sensor Board

The ISB (110) has already been discussed in section 3.2.3. It contains an inductance-to-digital converter IC that communicates with the MP. The IC used in the ECORD prototype makes use of the popular SPI interface. Other sensors may use a different interface. The MP supports a wide-variety of interfaces, like logic-level serial, I2C, CAN bus, and of course SPI.

### 4.4 Wireless Connectivity

The ECORD supports two wireless modules. One is a Bluetooth module (132) used to communicate with a smartphone or tablet, which supports the ECORD app (see section 5.2). The other RF transceiver (131) communicates with a small Remote Control (140) (see section 6.2) that the user can attach to a handle, bar, or similar, that in turn hooks onto the loop on the rope. The Remote Control (140) can be used to command an increase in resistance, decrease in resistance, an emergency stop, or resistance activation during an exercise routine. Both of these modules are low-cost commercial products that meet the FCC requirements and are certified for use.

### 4.5 Fans

Like all motors, the ECORD motor generates heat during operation. This heat is actively removed with the aid of fans (134). As discussed in section 3.3, there are many slits and cutouts (127) along the perimeter walls to facilitate good airflow.

### 5 SOFTWARE

The main code of the ECORD is executed on the MP. The code of the UI system may be executed on the SP or the MP, as discussed previously. There is also an ECORD app that is executed on a smartphone or tablet. These are discussed in this section.

### 5.1 Operation Code

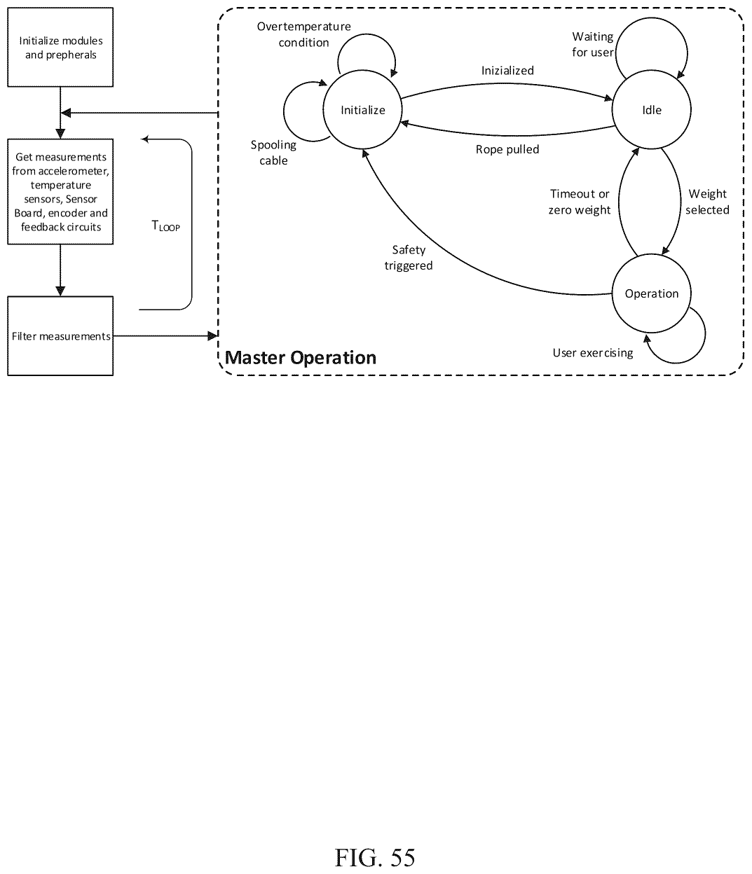

The Operation Code is the main firmware running on the MP. It is responsible for controlling the motor, including any safety features, as well as communicating with the various modules and peripherals (shown in FIG. 53). The code runs in a fixed loop-period, T_{LOOP}, set to 2 ms, although it can be changed to suit the application. The basic flowchart of the Operation Code is illustrated in FIG. 55.

When the system is powered on, the MP steps through an initialization routine, where it configures the various wireless modules for proper wireless communication, checks the functionality of the accelerometer, checks the functionality of the temperature sensor(s), configures the Motor Controller IC with the various parameters required to operate the motor, and configures the inductance-to-digital converter on the ISB (110). Once completed, the code enters the main loop. The first step is to obtain the measurements from the various sensors, which include:
Accelerometer data
Temperature data
ISB data
Motor velocity and position from encoder data
Bridge voltage/current and motor phase currents

Once the data is obtained, it is filtered to smooth out any noise. This filtering is in the form of a moving average, where the last N_{SAMPLES} is used to calculate the average of the data. N_{SAMPLES} can be adjusted to suit the needs of the application. For ECORD, it is set somewhere between 5-10, depending on the data type, need for smoothing, and amount of acceptable filter delay (the larger N_{SAMPLES} is the greater the filter delay). Additionally, the data is filtered using a median filter to get rid of noise. This is also performed over N_{SAMPLES}, with the same tradeoffs.

After filtering, the code enters the Master Operation block. Here, the code is organized as a state machine. On initial power-up, the system does not know what the state of the rope is. It may have been pulled out to some extent when the ECORD was off. Therefore, it will initially spool the rope in until it detects that the motor has stopped moving, indicating that the rope has been fully spooled and it has reached the stop point (see section 3.3). At this point, the system marks the zero position of the rope and moves onto the Idle state assuming there are no overtemperature conditions.

In the Idle state, the system is ready and waiting for the user to select a weight, either via the UI, the app, or the Remote Control on the handle. Once the weight is selected, the resistance is applied, and the system consumes power proportional to the selected weight. There is no reason to continue wasting power and heating up the motor and electronics while waiting indefinitely for the user to begin exercising. Therefore, if the user does not begin the exercise within a predetermined timeout period (set within the app), the weight is set back to zero and the system enters the Idle state.

There are two ways to apply the resistance after weight-selection has been made. It may be applied at once or it can ramp linearly over time up to the selected weight. This choice can be made within the app. Applying the weight linearly may be beneficial depending on how the user is situated for the specific exercise to be performed.

Once the user begins the exercise the system enters the operation state where the following safety features are checked:
Over-velocity condition—This can occur if the user suddenly drops the handle, causing the motor to rapidly accelerate since it is no longer being resisted by the user. This may also occur in the unlikely situation where the rope is cut or disconnects from the handle. Under this condition the weight is set to zero to ensure the rope does not get spooled all the way in or come crashing into the stop position, possibly leading to some form of device damage.
Over-acceleration condition—This is discussed in section 4.2.6.
Overtemperature condition—Various electronic components, such as the Bridge components, are monitored for an overtemperature condition. If their temperature increases above safe limits, the resistance is gradually decreased to zero. The reason for this gradual decrease is to avoid surprising the user, say during a concentric contraction, by suddenly cutting the weight to zero, which under certain conditions may lead to injury.
Overcurrent condition—The Bridge current, hence the motor current, is continuously monitored. If it exceeds a predetermined level, the ECORD will override the user-specified weight and begin reducing it in an attempt to reduce the current level to an acceptable limit. During the eccentric phase of a routine, where the motor is allowed to spool the rope in, the level of current drawn from the AC/DC power supply increases with increasing spooling velocity. That is, if the user lets down the weight slowly, less current will be drawn from the power supply as compared to letting the weight down more quickly. If the user lets the weight down too quickly, over-velocity will be triggered, and the weight will be set to zero rapidly. However, if the weight is let down not as fast, but fast enough to exceed the current limit, then the ECORD will accordingly reduce the weight. The level of current drawn from the AC/DC converter depends on the selected weight as well. Given the same eccentric velocity, the ECORD will draw more current for a higher weight selection. Once the user reaches the bottom of the eccentric phase and/or reduces the eccentric velocity before that point, the system can ramp the weight back up to the original selection. The ultimate goal of the overcurrent condition is to ensure the user operates the ECORD within its limits. The positive side-effect is that the overcurrent condition encourages the user to slow down on the eccentric phase, which is beneficial for hypertrophy.

Three of the four safety features (over-velocity, over-acceleration, and overtemperature) will trigger the entry into the Initialize state. The overtemperature condition will keep the system in the Initialize state until the temperature level(s) return to acceptable limits. Hysteresis is added to ensure the downward trending temperature is well below the upward safety-triggering level.

The MP uses a main timer that triggers an interruption every T_{LOOP} period. Usually, the MP executes all the required code well within this period. Before T_{LOOP} is reached, the MP checks for additional information received asynchronously from the wireless modules, the SP, or any touchscreen and handles them in such a way that does not interfere with the main operating loop. Since T_{LOOP} is on the order of a few milliseconds, the code polls the UI button presses instead of using interrupts. This makes the code easier to handle, however, interrupts may also be used to determine the state of the pushbuttons.

### 5.2 App

Although the ECORD may be operated as a standalone device, allowing the user to select the desired weight and perform exercises, it may also be paired with a smartphone or a tablet via the Bluetooth wireless module (132) in order to provide the user with additional capabilities and information. These are:
Configure how the resistance is applied when weight is selected: all at once or ramp up to the selected value over time.
Configure resistance to constant or mimicking a resistance band.
Configure when the resistance is applied: as soon as weight is incremented or wait for the Remote Control to initiate the weight application.
Set the Idle-state timeout period within provided range.
Select exercise weight (similar function to the UI pushbuttons and Remote Control).
Display number of sets and reps executed by user per exercise.
Plan a workout session ahead of time by selecting the type of exercises to be performed. Plan the session for a given day, several days, or several weeks.
Select the exercise to be performed on-the-fly.
Provide the user with a history of exercise sessions, including the number of sets and reps performed at the selected weight. If weight-changes occurred during workout, these changes will also be reflected in the history.

In a gym setting, where several ECORD stations may be in close proximity to one another, a user can pair to a specific ECORD without interfering with another. This is taken care of by the pairing mechanism provided via Bluetooth.

### 6 OPERATION

Operating the ECORD is straightforward. It is simply plugged into an outlet and the power-on button pressed. After initialization has taken place (see section 5.1), the user selects a desired weight with the onboard UI and performs an exercise. When the set is complete, the user lowers the handle back down until it is spooled back by the motor into the stop position. At this point, the user may change the weight if desired or set it to zero if rest is required. The process repeats until the exercise session is over, at which point the ECORD can be turned off (using the power switch), unplugged, and put away.

The above scenario describes the standalone operation of the ECORD, where it is not paired with a smartphone or tablet. When the ECORD is turned on, it broadcasts its availability over Bluetooth. There is no requirement to connect with a smartphone or tablet and the unit can be operated as described above. If pairing is required, it is done so using the smartphone or tablet. Once paired, the user may control the ECORD either from the onboard UI or via the smartphone or tablet. When connected, the ECORD will provide exercise related information to the connected device during a set. This information includes the reps, the weight (even if the weight changes during the set), velocity, and any status or failure messages. The app then integrates this information with the user-specified exercise that is currently underway. The user-specified exercise may have been selected ahead of time or on the fly. This integrated information then resides in the exercise history in order to help the user track his/her performance over time. This history is especially helpful to fitness trainers that may choose to have their clients train with an ECORD.

### 6.1 Anchoring Schemes

The ECORD is designed to be versatile to accommodate as many different types of exercises as possible. Although its main application is to simply be placed on the floor and have the user anchor it with their own weight, there are other ways to anchor the ECORD that facilitate additional types of exercises.

During operation, the user anchors the ECORD in one of four ways (examples are shown in section 7):
1. Stands on the Top Plate (61) with one or both feet (the UI is recessed from the top surface of the Top Plate (61) so that the user does not accidentally press any buttons while standing on it).
2. Places it against a wall with both feet positioned on the Top Plate (61).
3. Mounts it to the wall via mounting holes (126) provided on the ECORD.

The ECORD offers two mounting holes (126) spaced 16″ apart, which is the most popular separation between two studs in a wall. It is important to mount the ECORD to the studs for maximum support. (The ECORD should never be mounted to drywall only.) The user can install two threaded anchor bolts to the wall at the appropriate height, insert the ECORD through those bolts, and fasten it with butterfly nuts. This allows the ECORD to easily and quickly be mounted to a wall for certain types of exercises (see section 7). Note that there is no need for any additional mounting holes (126) elsewhere on the device since the rope (79) coming off the Egress Roller (75) is nearly in line with the bolts, just slightly above them. The force of that rope (79) produces a very small amount of torque moment on the bolts, and the little that is produced works to further push the opposite end of the ECORD (near the rear) into the wall, not away from it.

### 6.2 Remote Control

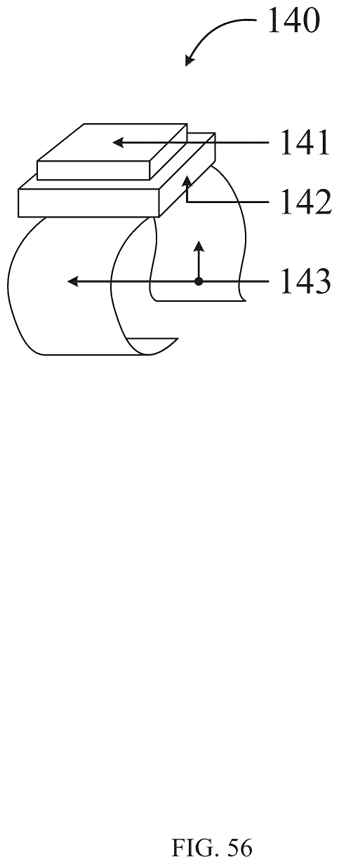

The Remote Control (140) discussed in section 4.4 is a small form-factor device that can be attached to a handle or bar or held by the user's other hand during an exercise routine in order to wirelessly command weight increase, weight decrease, emergency stop, or resistance activation. The ECORD does not require the design of a custom handle, bar, or similar since there are countless commercial products available to choose from. The user may also have their own preference for a specific type of handle. Therefore, the mounting mechanism of the Remote Control (140) is such that it can be mounted to just about any type of handle or bar. This concept is illustrated in FIG. 56.

The Remote Control (140) comprises a pushbutton (141) for initiating commands, an enclosure (142) for the electronics and battery, and an adjustable strap (143). In order to keep the size of the Remote Control (140) small and its operation simple, only a single button (141) is made available, with the commands as follows:
Single, rapid click—decrement weight based on weight resolution.
Double click—increment weight based on weight resolution.
Press and hold for at least 0.5 seconds—emergency stop if resistance already applied.
Press and hold for at least 0.5 seconds—apply resistance of selected weight when no resistance is currently applied (resistance will be applied all at once or smoothly based on ECORD configuration via the app)

The most likely command used during an exercise routine would be to decrease the weight, which is why it is assigned as the simplest action; single-click. Decrementing the weight is useful in performing drop-sets, where the user begins with one weight, then after maxing out the number of reps performed at that weight, the weight is lowered, and the exercise continues. Additional drop-sets may follow as desired. Decrementing the weight can also be used to help the user finish a set, very similar to what a spotter does. In a sense, the Remote Control (140) offers a form of self-spotting.

There may be conditions where the user will need to turn off the weight rapidly, say to avoid injury. This is easily accomplished by pressing and holding the button for at least 0.5 seconds. When the weight has already been applied, this action would turn it off immediately. However, if the weight has not yet been applied, the same action will apply the weight depending on how its application is configured in the app; all at once or smoothly over time. This is beneficial if the user needs to get situated first before any weight is applied. This requires the ECORD to be configured via the app, since the default condition is to apply the weight at once as soon as it is selected. As an example, when the ECORD is initially powered and operating without a connection to a smartphone or tablet, as soon as the increment button is pressed on the onboard UI, the weight is applied. With additional weight increments, the tension of the rope increases. The ECORD will start a timeout period as soon as a new weight is selected, waiting for the user to begin exercising. See section 5.1.

The enclosure (142) of the Remote Control (140) contains an FCC certified wireless module, a microcontroller, power regulation circuitry, and a battery (e.g., coin type). The unit is designed to draw minimal power during transmission and goes into sleep when there is no action from the button. In sleep mode it draws very little power, allowing the battery to last well over a year. Whenever the button (141) is pressed, an LED indicator shows that the command has been transmitted. This provides the user with a visual indicator that the unit is operating.

In a gym setting, where there may be several ECORD stations in near proximity, each Remote Control (140) will be paired with its associated ECORD so that commands sent from one Remote Control do not affect another. The pairing is made possible via the messaging protocol used by the wireless module within the Remote Control.

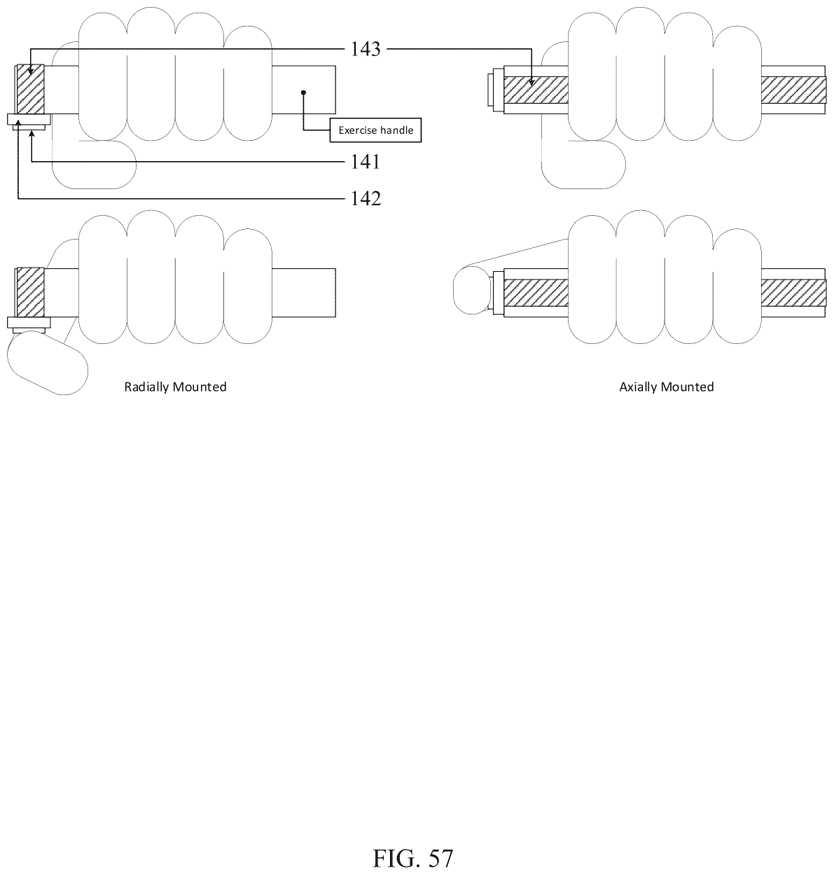

The strap (143) of the Remote Control is adjustable, like a watch strap or stretch Velcro material, to accommodate varying handle thicknesses. It can be mounted onto a handle as shown in FIG. 57. There are two ways to mount the Remote Control; radially or axially, with respect to a round handle. The top figures indicate the normal grip of a handle, while the bottom figures illustrate how the user can press the button of the Remote Control. The radially mounted method can be used on any sort of handle or bar, while the axially mounted method is only practical for handles, specifically the type where the strap from the handle does not protrude from the side.

### 7 SAMPLE EXERCISES

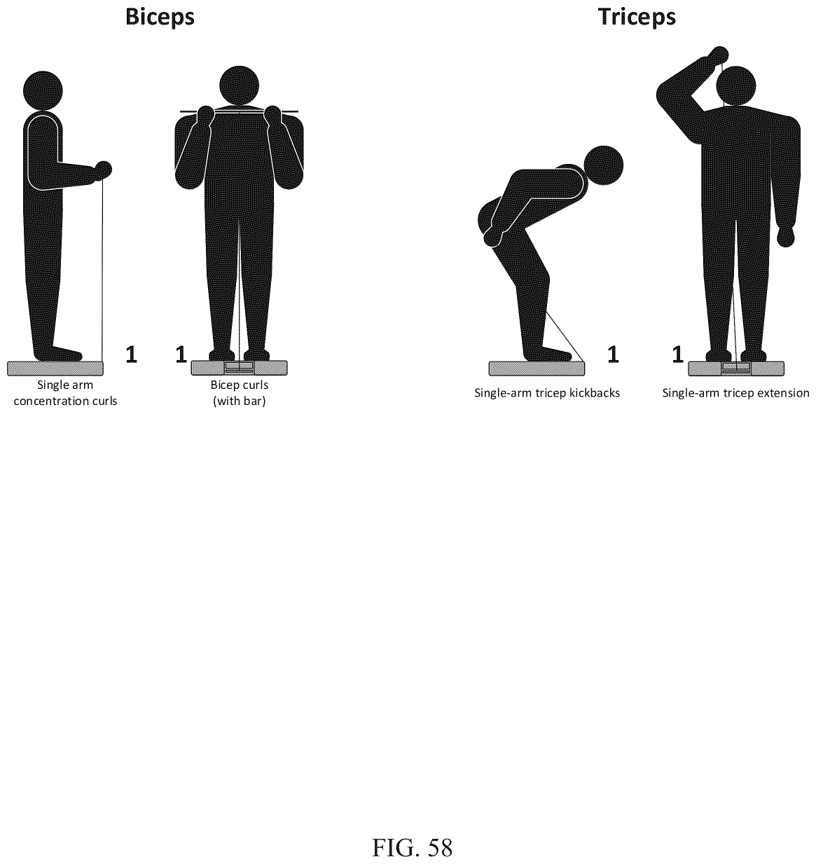

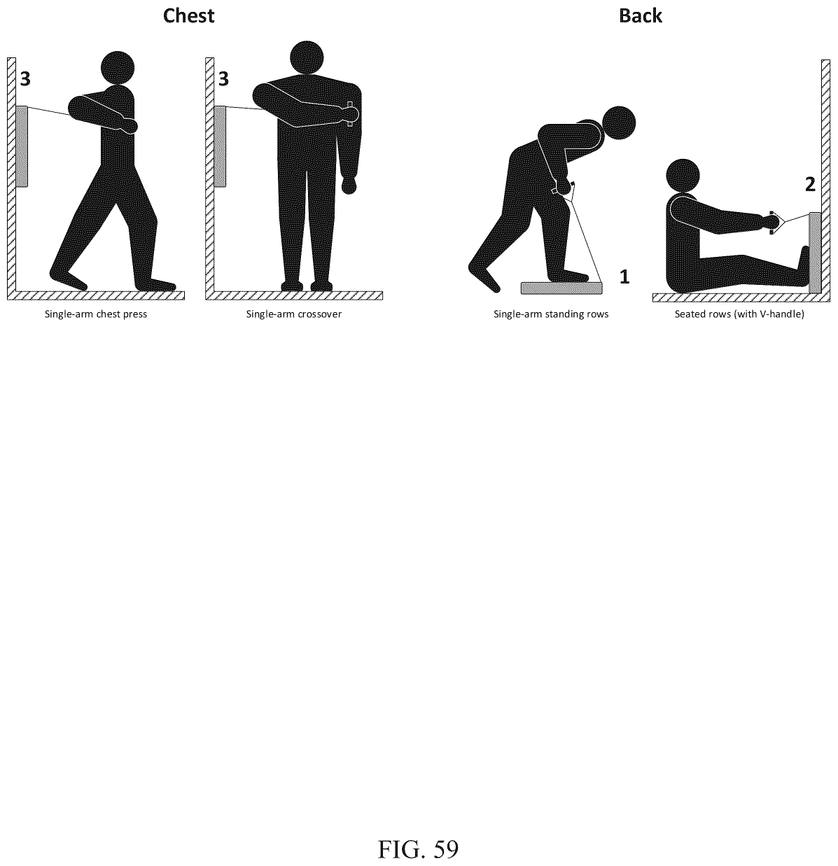

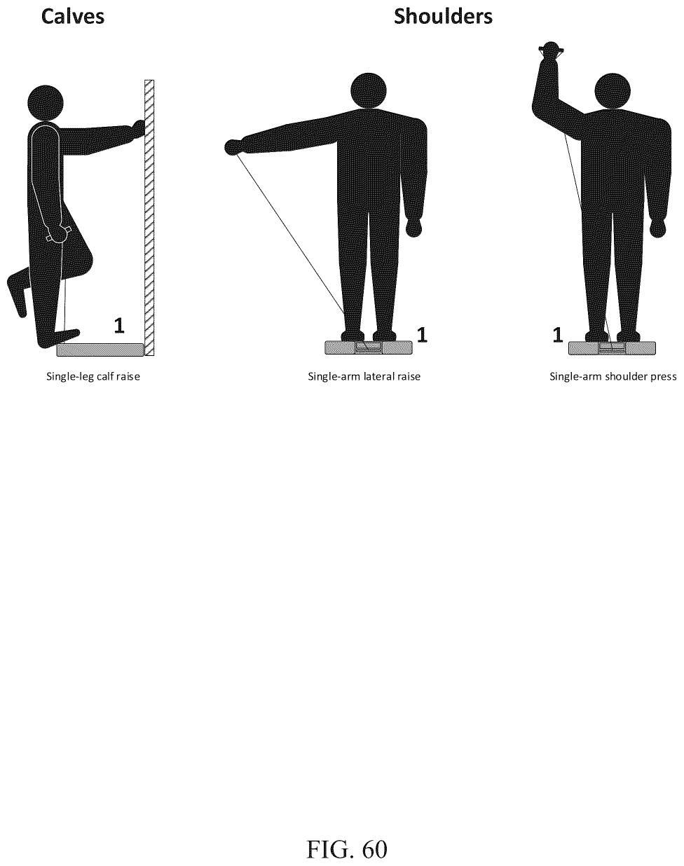

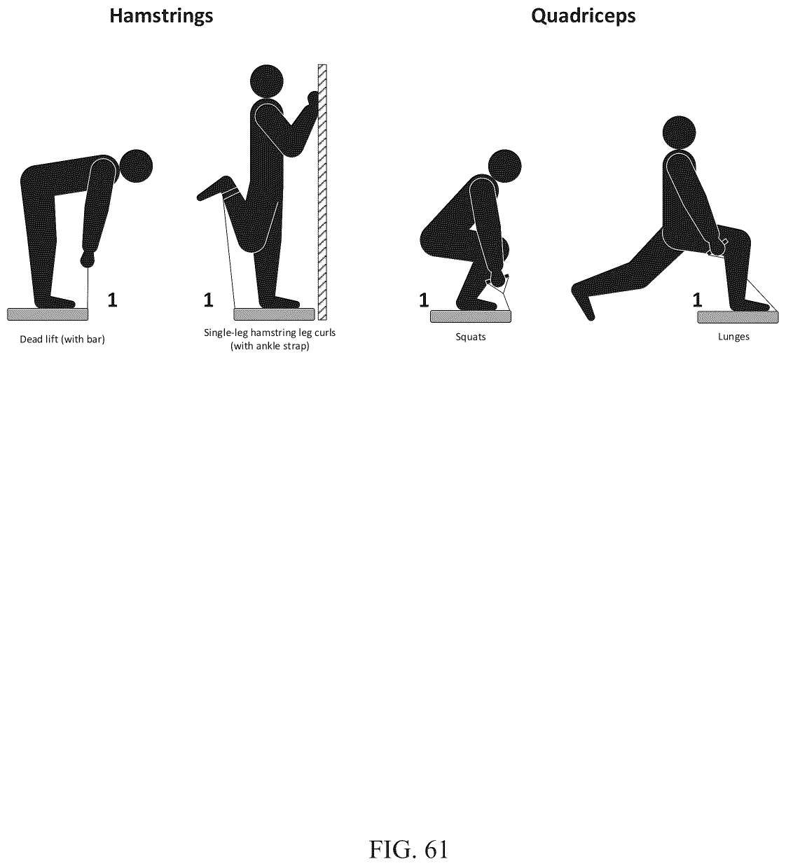

This section illustrates a small selection of exercises shown in FIG. 58, FIG. 59, FIG. 60, and FIG. 61 that can be performed with the ECORD and is by no means a full list of possibilities. The various mounting schemes are indicated with a number that matches the method outlined in section 6.1.

### 7.1 Additional Mounting Methods

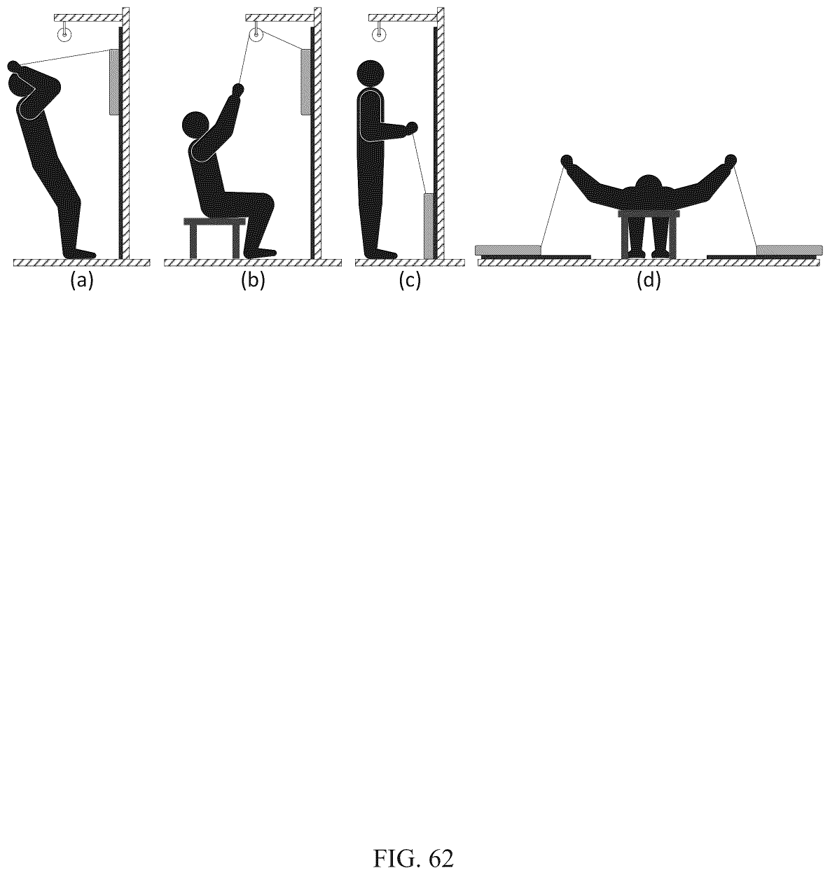

The versatility of the ECORD design allows it to be mounted to additional equipment for even more exercise possibilities. For instance, the ECORD can be mounted to a rack that allows its position to be adjusted depending on the exercise to be performed. Some examples are shown in FIG. 62.

In (a) the user is performing a face-pull exercise, where the ECORD must be mounted head high. For bicep curls (c), the ECORD must be lowered. For lat pulls (b), the ECORD may be positioned high or low. In example (d), the user is performing flys. This requires the use of two ECORDs, both of which are mounted to adjustable racks that are oriented horizontally. A bench is placed in the middle. In this case the user must get situated before turning on the weight, which can be done with the Remote Controls (140), one for each ECORD. For a bench-press exercise, the ECORDs would be moved closer to the bench.

For some of the exercises shown, the starting position of the handle is far from the Egress roller (75). For example, the single-arm bicep curl requires the user to start with the handle right by their thigh, leaving less rope within the ECORD to perform the full range of motion. In such cases, a simple extension rope (e.g., 2 feet long) may be added to offset the starting position, leaving more rope within the ECORD to perform the full range of motion. The extension rope can have carabiners on both ends, one to hook onto the handle and the other to connect to the rope-loop of the ECORD.

Although the invention has been explained in relation to its preferred embodiment, it is to be understood that many other possible modifications and variations can be made without departing from the spirit and scope of the invention.

What is claimed is:

1. An apparatus for exercise and a platform that provides controlled and adjustable resistance comprising,
a motor;
a cabled connection to the motor;
a spooled rope, said rope spools in and out as the user exercises through a range of motion;
a rope management system comprising a plurality of rollers;
a user interface, said user interface allowing the user to adjust the rope tension based on an equivalent weight;
a wireless remote allowing the user to control the interface;
an app that wirelessly connects to the apparatus allowing the user to control the interface; and
an onboard AC/DC converter plugged into a wall socket.

2. The motor of claim 1, further comprising,
a stator, said stator being fixed relative to the device in which the motor is embedded, stator further comprising a printed circuit board;
a rotor, said rotor being the part that rotates,
said rotor having a dual-rotor design and constructed using ferromagnetic materials and magnets;
stator winding fabricated such that they are supported by a non-metallic material; and
top and bottom plates placed on the top and bottom of the motor, spooler, and encoder.

3. The motor of claim 1, said motor being brushless, comprising,
Slotless stators without stator teeth, configured for smoother motion and no cogging torque;
magnets fixed to the rotor, arranged in a way that allows the magnetic field produced by said magnets to flow in an axial direction;

4. The motor of claim 1, wherein the phases of the motor are connected in a star or delta formation, said phases comprising printed circuit board stators connected in series, in parallel, or a combination of the two.

5. The motor of claim 1, further comprising,
a dual-rotor assembly, where one rotor is placed over and coupled to the shaft and the other rotor rotated 180 degrees along the line of symmetry and coupled to the other end of the shaft;
a plurality of printed circuit board stators bonded in the desired configuration and placed between the two halves of the rotor, said configuration connected in series, in parallel, or a combination of the two,
shaft ends designed to be inserted into bearings; and
an encoder which uses a commercial integrated circuit to provide the necessary signals to the motor.

6. The spooler of claim 1, comprising,
a rope providing tension to the user, said rope being spooled in when retracted by the motor and spooled out when the user pulls on the rope;
top and bottom rope retainers, said retainers mounted to a spooling structure via screws; and
a spooling structure comprising threaded screw holes, an anchor path, and a rope anchor point.

7. The apparatus of claim 1, further comprising a controller board,
controller board using the measured data and user-specified weight to maintain the specified tension on the rope using a proportional-integral-derivative algorithm,
algorithm using data provided by the inductance-to-digital converter to measure the tension of the rope, said data being mapped to the actual weight on the rope during calibration, allowing the measured tension during operation to be related to the actual weight.

8. The apparatus of claim 1, powered using a standard wall outlet plugged into a power plug and activated using a power button, said apparatus further comprising,
a user interface;
an electronic display;
an AC/DC power supply; and
a speaker for audio feedback.

9. The apparatus of claim 1, further comprising,
a main processor which executes the general code of the system;
a secondary processor used to interface and manage the UI;
an accelerometer to detect any compromise in the anchoring and prevent injury;
temperature sensors;
regenerated power-mitigation circuitry, said circuitry being capable of storing energy for reuse during operation, charging an external removeable battery pack, charging an external portable USB device, or redirecting energy back to the power grid.
an inductive sensor board;
wireless connectivity including but not limited to Bluetooth or remote control; and
fans which cool the system down in case of excess heat.

10. A printed circuit board stator, comprising,
coils fabricated using copper etchings, said coils being distributed across the printed circuit board in meandering patterns, allowing all three phases of the motor to reside on each layer of the printed circuit board;
castellated edges, said edges allowing several stators to be bonded to each other by rotating said stators relative to each other to place them in the desired series-connected, parallel-connected or combo-connected phase winding configuration; and
soldering pads allowing the phases to be connected to each other using wires in a star or delta configuration,
stator further being capable of being configured in a stack, said stator stack having phase windings connected either in series, in parallel, or a combination of both.

11. A spooler, said spooler having a low-profile design allowing the rope to spool over itself in the radial direction, comprising,
top and bottom rope retainers; and
a spooling structure,
wherein the bottom retainer is mounted to the spooling structure via screws, the rope is routed through the anchor path and tied in a knot, such that once the knot is placed within the rope anchor point it cannot slide out of the path, and the rope is secured by mounting the top retainer to the spooling structure via screws,
said spooler further being capable of having a gap between the spooler and the bottom backiron, or having the bottom backiron flush against the spooler, wherein the bottom backiron acts as the top rope retainer.

12. The spooler of claim 11, said spooler having the capability to act as a resistance band due to the changing radius of the rope, and a control algorithm compensating for the changing radius to provide a constant force if the resistance band functionality of the spooler is not needed.

13. The rope management system of claim 1, further comprising,
a plurality of rollers through which the rope is fed, comprising an inner, center, and outer roller, said rollers further comprising bearing retainers and bearings;
internal rope tensioning; and
a feedback system that continuously measures the rope tension and provides data to the main controller;
said rollers allowing the inner parallel roller to guide the rope between the spooler and the inner roller, the outer parallel roller and egress roller acting as a fairlead to keep the rope centered as it is spooled in and out,
said center roller mechanically coupled to a cantilevered beam, said beam being deflected when tension in the rope causes a downward force on the center roller, said deflection being linearly proportional to the force produced on the center roller by the tension on the rope, the linear relationship being used by an electronics board which monitors the deflection to calculate the tension on the rope.

14. The rope management system of claim 1, further comprising,
a feedback roller, said feedback roller comprising two bearing retainers and applying pressure via pinching the rope in order to keep the rope from slacking within the apparatus;
parallel rollers which keep the rope taut within the apparatus and allow a downward force on the center roller;
an egress roller allowing the rope to freely move between the roller and rope stop pin without any pinching, and the rope clamp attached to the rope being too wide to pass through when the rope is completely spooled back into the motor, said egress roller also functioning as a handle with which the user can carry the apparatus.

15. The apparatus of claim 1, further comprising,
a top bearing of the motor, said top bearing being given a certain amount of headroom, preventing the top plate from contacting the top bearing of the motor when force is applied to the top plate.

16. The apparatus of claim 1, further comprising a wireless remote, said remote capable of attaching to a handle, bar, or similar, that in turn hooks onto the loop of the rope, the remote control further comprising a button for initiating commands, an enclosure for the electronics and battery, and an adjustable strap, allowing the user to wirelessly command, increase, decrease, activate, or emergency stop the resistance.
